(19) United States
(12) Patent Application Publication
(10) Pub. No.: US 2011/0144967 A1
(43) Pub. Date: Jun. 16, 2011

(54) SYSTEM AND METHOD FOR DYNAMIC CARDIAC ANALYSIS, DETECTION, PREDICTION, AND RESPONSE USING CARDIO-PHYSIOLOGICAL MATHEMATICAL MODELING

(76) Inventor: Lev Adirovich, Ashdod (IL)

(21) Appl. No.: 13/058,925

(22) PCT Filed: Aug. 11, 2009
(86) PCT No.: PCT/IB09/53538

§ 371 Date: Feb. 14, 2011

Related U.S. Application Data
(60) Provisional application No. 61/136,100, filed on Aug. 12, 2008.

(51) Int. Cl. G06G 7/60

(52) U.S. Cl. 703/11

(57) ABSTRACT

A system and a method for evaluating the cardiac status of a heart by evaluating a plurality of cardio-physiological parameters, and in particular, to such a system and method in which a plurality of cardio-physiological mathematical models are evaluated to produce a user specific cardiac model.

### FIELD OF THE INVENTION

The present invention relates to a system and a method for evaluating the cardiac status of a heart by evaluating a plurality of cardio-physiological parameters, and in particular, to such a system and method in which a plurality of cardio-physiological mathematical modules are evaluated to produce a user specific cardiac model.

### BACKGROUND OF THE INVENTION

Mathematical models that model biological systems and/or processes are well known in the art. A wide variety of models are known including those that use ordinary differential equations, partial differential equations and the like. More specifically, these mathematical models simulate a variety biological processes at varying levels for example, cellular, tissue, circulatory and organ. However, the mathematical models generally govern a particular aspect of a disease or otherwise healthy biological process. For example, mathematical modeling for cardiac output, blood pressure, ejection function and the like cardio-physiological processes are known in the art. However, the ability to combine and correlate these seemingly individualistic models into a comprehensive model able to analyze, predict or explain a biological phenomena at a specific biological level such as organ has been sought after however remains outstanding. This is particularly important when considering the disease state of some of the organ such as the pancreas and diabetes where a large number of biological processes interleave to bring about the disease state.

Moreover, conventionally, mathematical models have been used for prediction of treatment results rather than to determine the treatment required or for predicting the outcome of a biological process or event.

Mathematical modeling of the cardiovascular system and in particular the heart is well known in the art as much research has been undertaken to better understand the heart. However, an integrative and dynamic model of the heart and cardio-physiological system at large has proved to be elusive.

Compounding this problem, the specific effects of Heart Failure (HF) on the body depend upon the type of heart failure and whether it occurs on the left or right side. Over time, however, in either form of heart failure, the organs do not receive enough oxygen and nutrients, and the body's wastes are removed slowly. Eventually, vital systems including the heart itself break down, sometimes leading to further spiraling events.

Physicians treat patients with HF in accordance to the presented clinical manifestations, such as complaints and physical symptoms of the disease. However, such treatments are based solely on point and time specific problems that do not provide a complete view of the overall and potentially systemic problem at hand. Similarly, asymptomatic patients receive medical therapy intended to slow the disease progression. However such preventative measures usually do not taking into account the dynamic nature of the disease and its progression prior to its initial manifestation.

The management of patients with heart failure is therefore a challenging task for physicians. Specifically, the difficulties are related to the dynamic nature of the heart and in turn heart disease; primarily due the plurality of factors interacting to bring about the manifestation termed heart failure. For example, internal factors such as heart rate, blood pressure, coronary circulation, as well as external factor such as fluids consumption, physical exercise, interleave in an unequal and sometimes individualistic manner to bring about heart failure. Therefore, understanding and modeling each of the internal and external events and parameters leads to better understanding of the individual events, however, to gain a true dynamic perspective of the system it requires that they be combined.

### SUMMARY OF THE INVENTION

There is an unmet need for, and it would be highly useful to have, a system and method for the dynamic analysis, prediction and respond to cardio-physiological events.

### DEFINITIONS

The term “cardiac chambers” within the context of this application refers to any of the 4 chambers of the heart and pericardium; for example, the right atrium, right ventricle, left atrium, left ventricle and pericardium.

The term “large vessels” within the context of this application refers to the vessels directly associated with the heart, for example including but not limited to, aorta, pulmonary artery, pulmonary vein and vena cava.

The term “estimated pulmonary circulation vessel (EPCV)” within the context of this application refers to the vessels directly associated with the pulmonary circulation, for example including but not limited to, pulmonary circle arteries, pulmonary circle capillaries, and pulmonary circle veins.

The term “estimated systemic circulation vessel (ESCV)” within the context of this application refers to the vessels directly associated with the systemic circulation, for example including but not limited to, systemic arteries, systemic capillaries, and systemic veins.

The following abbreviations may optionally be used:

1. B1—systemic arteries;

2. B2—systemic capillaries;

3. B3—systemic veins;

4. L1—pulmonary arteries;

5. L2—pulmonary capillaries;

6. L3—pulmonary veins;

7. Pa—pulmonary artery;

8. Ao—aorta.

9. Pv—pulmonary vein

10. Vc—vena cava

11. RA—right atrium

12. LA—left atrium

13. RV—right ventricle

14. LV—left ventricle

15. P—pericardium

### Analysis

According to a preferred embodiment, the present invention overcomes the deficiencies of the background art by providing a system, device, apparatus and method for the dynamic analysis of cardio-physiological activity in light of at least one parameter from the entire cardiac system, optionally and more preferably from a selected plurality of the cardiac chambers and the large vessels. Dynamic analysis preferably comprises the evaluation of at least one and more preferably a plurality of mathematical models related to a plurality of cardio-physiological processes. A preferred method according to the present invention provides a method for integrating at least one and more preferably plurality of cardio-physiological mathematical models to analyze and evaluate the cardiac state of a user. Preferably, a plurality of cardio-physiological parameters are obtained, optionally via an implanted device for example including but not limited to a pacemaker, monitoring system and/or standalone sensor. Optionally, cardio-physiological parameters may be obtained by a non-implanted device for example including but not limited to imaging devices, blood works, ultrasound, echo, CT (computerized tomography), MRI (magnetic resonance imaging), PET (positron emission tomography) scan or the like.

Most preferably, a plurality of cardio-physiological mathematical models modeling a plurality of cardiac events, are solved in order to monitor, predict and potentially avert heart failure. Most preferably, the cardiac events of the present invention provide a holistic and integrative perspective of the various cardio-physiological events, preferably combining hemodynamic, physiological and anatomical aspects of the heart. Optionally, at least one and more preferably a plurality of mathematical modules are generated to produce an overall cardiac model, for example including but not limited to one or more of the following: the elasticity equation for the set {blood flow in artery, arterial walls} only; the elasticity equation for the set {blood flow in vein, venous walls} only; The elasticity equations for the set {blood flow in ventricle, ventricle walls} only; the elasticity equations for the set {blood flow in atrium, atrial walls} only; equations (hydrodynamic equation of continuity (the conservation of mass), conservation of the axial component of momentum) for the set {blood flow in artery arterial walls}; equations (hydrodynamic equation of continuity (the conservation of mass), conservation of the axial component of momentum) for the set {blood flow in vein+venous walls}; the equations binding the ventricular and arterial flows and wall elasticity on systole (Conservation of mass, Conservation of momentum, Moens-type equation, Conservation of energy); the equations binding the arterial flow and wall elasticity on diastole (hydrodynamic equation of continuity (the conservation of mass), conservation of the axial component of momentum, Conservation of energy); the equations binding the venous-atrial and ventricular flows and wall elasticity on rapid and reduced ventricular filling and atrial systole (Conservation of mass, Conservation of momentum, Moens-type equation, Conservation of energy); the equations binding the venous-atrial flow and wall elasticity when the (mitral or tricuspid, respectively) valve is closed (hydrodynamic equation of continuity (the conservation of mass), conservation of the axial component of momentum, Conservation of energy, Moens-type equation); the equations binding the blood flows in pulmonary artery, lung blood vessel and pulmonary vein and wall elasticity; the empirical equations binding relation between the physiological parameters and describing the regulatory and compensatory mechanisms of heart functionality; or the like.

In some cases the above equations are abbreviations; for example, the term “{blood flow in artery arterial walls}” refers to all necessary equations describing the calculations of all blood flow dynamic parameters in artery and artery wall dynamic characteristics. Examples of specific equations for all general descriptions of equations herein are given below with regard to the more detailed example of a non-limiting, illustrative embodiment of a heart dynamic model according to the present invention.

The above equations are one embodiment of the present invention which represents a general set of equations, which in combination describes the general functions of the heart. For implementation of the dynamic model, for example for a specific subject or patient, the differential equations are transformed to a system of sequential algebraic equations.

Preferably, the dynamic mathematical cardio-physiological models are calculated based at least one and more preferably a plurality of cardiac parameters. Optionally and preferably, for those parameters which may be monitored, at least one or more parameters are monitored for inputting the changes in the values over time. For example, cardiac parameters may optionally include but not limited to arterial shape; the left ventricle blood pressure; the effective Young modulus of the left ventricle wall; the deformation-related increments of internal left ventricle radius; the deformation-related increments of external left ventricle radius; the stress of the external left ventricle wall; the right ventricle blood pressure; the effective Young modulus of the right ventricle wall; the deformation-related increments of internal right ventricle radius; the deformation-related increments of external 1 right ventricle radius; the stress of the external right ventricle wall; the left atrium blood pressure; the effective Young modulus of the left atrium wall; the deformation-related increments of internal left atrium radius; the deformation-related increments of external left atrium radius; the stress of the external left atrium wall; the right atrium blood pressure; the effective Young modulus of the right atrium wall; the deformation-related increments of internal right atrium radius; the deformation-related increments of external right atrium radius; the stress of the external right atrium wall; the aortic blood pressure; the density of blood fluid in aorta; the axial blood flow velocity in aorta; the axial blood flow velocity just before the entrance to aorta; the aortic pressure wave propagation velocity relative to the flow; the effective Young modulus of the aortic wall; the deformation-related increments of the aortic radius; the vena cava blood pressure; the density of blood fluid in vena cava; the axial blood flow velocity in vena cava; the axial blood flow velocity just after the exit from vena cava; the deformation-related increments of the vena cava radius; the pulmonary artery blood pressure; the density of blood fluid in pulmonary artery; the axial blood flow velocity in pulmonary artery; the axial blood flow velocity just before the entrance to pulmonary artery; the pulmonary artery pressure wave propagation velocity relative to the flow; the effective Young modulus of the pulmonary artery wall; the deformation-related increments of the pulmonary artery radius; the pulmonary vein blood pressure; the density of blood fluid in pulmonary vein; the axial blood flow velocity in pulmonary vein; the axial blood flow velocity just after the exit from pulmonary vein; the pulmonary vein pressure wave propagation velocity relative to the flow; the deformation-related increments of the pulmonary vein radius; the internal radius of the nondeformed (empty) left ventricle; the external radius of the nondeformed (empty) left ventricle; the internal radius of the nondeformed (empty) right ventricle; the external radius of the nondeformed (empty) right ventricle; the internal radius of the nondeformed (empty) left atrium; the external radius of the nondeformed (empty) left atrium; the internal radius of the nondeformed (empty) right atrium; the external radius of the nondeformed (empty) right atrium; the (internal) radius of the nondeformed (empty) aorta; the thickness of the nondeformed (empty) aorta; the effective Young modulus of the vena cava wall; the pulmonary resistance; the lung blood pressure; the density of blood fluid in a lung vessel; the axial blood flow velocity in a lung blood vessel; the lung blood vessel absolute pressure wave propagation velocity; the effective Young modulus of the lung blood vessel wall; the absolute deformation-related increment of the lung vessel radius; the (internal) radius of the nondeformed (empty) lung blood vessel; the thickness of the nondeformed (empty) lung blood vessel; the (internal) radius of the nondeformed (empty) vena cava; the thickness of the nondeformed (empty) vena cava; the (internal) radius of the nondeformed (empty) pulmonary artery; the thickness of the nondeformed (empty) pulmonary artery; the effective Young modulus of the pulmonary vein wall; the (internal) radius of the nondeformed (empty) pulmonary vein; the thickness of the nondeformed (empty) pulmonary vein; the Poisson isentropic exponent of the blood fluid; the (internal) radius of the nondeformed (empty) L1; the (internal) radius of the nondeformed (empty) L2; the (internal) radius of the nondeformed (empty) L3; the length of L1; the length of L2; the length of L3; the density of blood in L1; the density of blood in L2; the density of blood in L3; the viscosity-related resistance coefficient of the blood flow in L1; the viscosity-related resistance coefficient of the blood flow in L2; the viscosity-related resistance coefficient of the blood flow in L3; the blood pressure in L1; the blood pressure in L2; the blood pressure in L3; the average effective Young modulus of L1 walls; the average effective Young modulus of L2 walls; the average effective Young modulus of L3 walls; the absolute deformation-related increment of the L1 radius; the absolute deformation-related increment of the L2 radius; the absolute deformation-related increment of the L3 radius; the L1 resistance; the L2 resistance; the L3 resistance; the average radius of the nondeformed (empty) system arteries; the average thickness of the nondeformed (empty) system arteries; the average length of system arteries; the density of blood in system arteries; the viscosity-related resistance coefficient of the blood flow in system arteries; the average radius of the nondeformed (empty) system capillaries; the average thickness of the nondeformed (empty) system capillaries; the average length of system capillaries; the density of blood in system capillaries; the viscosity-related resistance coefficient of the blood flow in system capillaries; the average radius of the nondeformed (empty) system veins; the average thickness of the nondeformed (empty) system veins; the average length of system veins; the density of blood in system veins; the viscosity-related resistance coefficient of the blood flow in system veins; the blood pressure in system arteries; the blood pressure in capillaries; the blood pressure in veins; the average effective Young modulus of system arterial walls; the average effective Young modulus of capillaries walls; the average effective Young modulus of veins walls; the absolute deformation-related increment of the system arterial radius; the absolute deformation-related increment of the capillary radius; the absolute deformation-related increment of the vein radius; the system arterial resistance; the capillary resistance; the venous resistance; the external radius of the nondeformed (empty) pericardium; the Young modulus of the pericardial wall material; and/or one or more regulation coefficients related to: left-ventricular EDV (end diastolic volume); right-ventricular EDV; left-atrial presystolic volume; right-atrial presystolic volume; blood pressure in Ao; blood pressure in Pa; blood pressure in L2; blood pressure in B2; or a combination thereof.

### Monitoring

According to an optional embodiment of the present invention, the system and method provides the heart function monitoring based on the analysis previously described or otherwise by using one or more parameters obtained from a detected cardiac event using at least one and more preferably a plurality of cardio-physiological mathematical models as previously described. Optionally and more preferably, the monitoring process is based upon information obtained during a previous in depth cardiac analysis, for example by performing an echocardiogram. However, this in depth analysis may optionally need to be repeated if there is a major change in the patient—for example after a heart attack.

Optionally and preferably, monitoring comprises measuring at least one parameter selected from the group consisting of pressure in right or left atrium, or left/right ventricle, and/or pulmonary artery, or a combination thereof, for a sufficiently extended period of time for regulatory processes to be determined.

For determining short term regulatory processes, the sufficiently extended period of time is at least 1 hour. After determination of the short-term regulatory process (by monitoring), the operation of the heart is optionally monitored in real time to determine the medium and long term regulatory processes for the sufficiently extended period of time which is at least one week, preferably at least two weeks, more preferably at least three weeks, most preferably at least one month or most preferably at least any week selected from the group consisting of 4 weeks, 5 weeks, 6 weeks, 7 weeks, 8 weeks, 9 weeks, 10 weeks, 11 weeks, 12 weeks, 13 weeks, 14 weeks, or 15 weeks or more.

Optionally, according to at least some embodiments, the monitoring is performed in an invasive or minimally invasive manner. As a non-limiting example of an invasive monitoring process, after a by-pass operation or any type of open heart surgery, optionally a sensor may be placed in the left ventricle to monitor the patient after surgery. As a non-limiting example of a minimally invasive monitoring process, when angioplasty is performed, optionally a stent with a sensor is inserted.

### Prediction

According to an optional embodiment of the present invention, the system and method provides the prediction based on the analysis previously described or otherwise by using one or more parameters obtained from a detected cardiac event using at least one and more preferably a plurality of cardio-physiological mathematical models as previously described.

For subjects or patients suffering from heart disease of any type, preferably further information is added to the model in order to account for the one or more effects of regulatory and/or compensatory functions which arise in the diseased heart or cardiac system.

Most preferably, the system and method of the present invention provides a user, preferably a physician, with a plurality of optional response strategies based on the analytical evaluation of at least one or more preferably a plurality of cardio-physiological mathematical processes.

### Response-Feedback

An optional preferred embodiment of the present invention overcomes the deficiencies of the background by providing a system and method for abstracting at least one or more, optional response protocols based on the prediction and analysis, and/or monitoring, as previously described, to provide feedback to the patient. A non-limiting example of such feedback comprises providing an alarm to the patient and/or medical personnel, and/or selecting a treatment protocol based on the predictive and analytical results of at least one or more cardio-physiological events, and/or based upon monitoring of the patient. Optionally, a response or treatment protocol may be determined by a physician and used to directly provide such treatment optionally with implanted or external devices such a defibrillator, drug pump or the like effectors. Such treatment selection represents personalization of treatment, whether through administration of a medicine, medical or surgical based treatment, and so forth, based upon one or more physiological parameters of the individual patient.

Individual v. Group

According to some embodiments of the present invention, there is provided a system and method for predicting the changes and progress of cardio-physiological processes in a general patient and/or a specific individual patient.

According to some embodiments of the present invention, there is provided a system and method for modeling various specific cardio-physiological processes for a general patient and/or a specific individual patient.

Continuous vs. Triggered

A preferred embodiment of the present invention analyzes a plurality of parameters for analysis with at least one or more preferably a plurality of dynamic cardio-physiological mathematical models. Most preferably, parametric data is collected directly from the heart, optionally, using an implanted device for example including but not limited to a pacemakers, monitoring systems, standalone sensors. Optionally, a plurality of implanted sensors may be used to obtain the parametric data, for example including but not limited to parameters that are controllably evaluated, preferably and optionally on a short term repetitive basis, for example including but not limited to the left ventricle blood pressure; the effective Young modulus of the left ventricle wall; the deformation-related increments of internal left ventricle radius; the deformation-related increments of external left ventricle radius; the stress of the external left ventricle wall; the right ventricle blood pressure; the effective Young modulus of the right ventricle wall; the deformation-related increments of internal right ventricle radius; the deformation-related increments of external 1 right ventricle radius; the stress of the external right ventricle wall; the left atrium blood pressure; the effective Young modulus of the left atrium wall; the deformation-related increments of internal left atrium radius; the deformation-related increments of external left atrium radius; the stress of the external left atrium wall; the right atrium blood pressure; the effective Young modulus of the right atrium wall; the deformation-related increments of internal right atrium radius; the deformation-related increments of external 1 right atrium radius; the stress of the external right atrium wall; the aortic blood pressure; the density of blood fluid in aorta; the axial blood flow velocity in aorta; the axial blood flow velocity just before the entrance to aorta; the aortic pressure wave propagation velocity relative to the flow; the effective Young modulus of the aortic wall; the deformation-related increments of the aortic radius; the vena cava blood pressure; the density of blood fluid in vena cava; the axial blood flow velocity in vena cava; the axial blood flow velocity just after the exit from vena cava; the deformation-related increments of the vena cava radius; the pulmonary artery blood pressure; the density of blood fluid in pulmonary artery; the axial blood flow velocity in pulmonary artery; the axial blood flow velocity just before the entrance to pulmonary artery; the pulmonary artery pressure wave propagation velocity relative to the flow; the effective Young modulus of the pulmonary artery wall; the pulmonary resistance; the deformation-related increments of the pulmonary artery radius; the pulmonary vein blood pressure; the density of blood fluid in pulmonary vein; the axial blood flow velocity in pulmonary vein; the axial blood flow velocity just after the exit from pulmonary vein; the pulmonary vein pressure wave propagation velocity relative to the flow; or the deformation-related increments of the pulmonary vein radius the blood pressure in L1; the blood pressure in L2; the blood pressure in L3; the average effective Young modulus of L1 walls; the average effective Young modulus of L2 walls; the average effective Young modulus of L3 walls; the absolute deformation-related increment of the L1 radius; the absolute deformation-related increment of the L2 radius; the absolute deformation-related increment of the L3 radius; the L1 resistance; the L2 resistance; the L3 resistance; the blood pressure in system arteries; the blood pressure in capillaries; the blood pressure in veins; the average effective Young modulus of system arterial walls; the average effective Young modulus of capillaries walls; the average effective Young modulus of veins walls; the absolute deformation-related increment of the system arterial radius; the absolute deformation-related increment of the capillary radius; the absolute deformation-related increment of the vein radius; the system arteries resistance; the capillaries resistance; the veins resistance; or a combination thereof.

Optionally, long term parameters may be used to abstract an appropriate model according to the present invention, optionally they may be evaluated over a longer period of time for example monthly, weekly, or annually for example including but not limited to: the internal radius of the nondeformed (empty) left ventricle; the external radius of the nondeformed (empty) left ventricle; the internal radius of the nondeformed (empty) right ventricle; the external radius of the nondeformed (empty) right ventricle; the internal radius of the nondeformed (empty) left atrium; the external radius of the nondeformed (empty) left atrium; the internal radius of the nondeformed (empty) right atrium; the external radius of the nondeformed (empty) right atrium; the (internal) radius of the nondeformed (empty) aorta; the thickness of the nondeformed (empty) aorta; the effective Young modulus of the vena cava wall; the (internal) radius of the nondeformed (empty) vena cava; the thickness of the nondeformed (empty) vena cava; the (internal) radius of the nondeformed (empty) pulmonary artery; the thickness of the nondeformed (empty) pulmonary artery; the effective Young modulus of the pulmonary vein wall; the (internal) radius of the nondeformed (empty) pulmonary vein; the thickness of the nondeformed (empty) pulmonary vein; the Poisson isentropic exponent of the blood fluid; the external radius of the nondeformed (empty) pericardium; or the Young modulus of the pericardial wall material, the (internal) radius of the nondeformed (empty) L1; the (internal) radius of the nondeformed (empty) L2; the (internal) radius of the nondeformed (empty) L3; the length of L1; the length of L2; the length of L3; the density of blood in L1; the density of blood in L2; the density of blood in L3; the viscosity-related resistance coefficient of the blood flow in L1; the viscosity-related resistance coefficient of the blood flow in L2; the viscosity-related resistance coefficient of the blood flow in L3; the average radius of the nondeformed (empty) system arteries; the average thickness of the nondeformed (empty) system arteries; the average length of system arteries; the density of blood in system arteries; the viscosity-related resistance coefficient of the blood flow in system arteries; the average radius of the nondeformed (empty) system capillaries; the average thickness of the nondeformed (empty) system capillaries; the average length of system capillaries; the density of blood in system capillaries; the viscosity-related resistance coefficient of the blood flow in system capillaries; the average radius of the nondeformed (empty) system veins; the average thickness of the nondeformed (empty) system veins; the average length of system veins; the density of blood in system veins; the viscosity-related resistance coefficient of the blood flow in system veins; the regulation coefficients regulating: according left-ventricular EDV; regulation coefficients regulating: according right-ventricular EDV; according left-atrial presystolic volume; according right-atrial presystolic volume; according blood pressure in Ao; according blood pressure in Pa; according blood pressure in L2; according blood pressure in B2; or a combination thereof.

Optionally, the parametric data may be obtained from an intrinsic device for example a pacemaker, monitoring system comprising a plurality of sensor, or standalone sensor.

Optionally, such data may be obtained from external third party devices for example including but not limited to imaging device, research database, database or the like source of cardio-physiological data that is not implanted. The present invention, in different embodiments, is operative for implanted devices and/or for non-implanted devices.

Most preferably, the system and method according to a preferred embodiment of the present invention preferably predict the heart condition dynamic nature, future direction, provide the various scenarios of the condition and optional correction, find the suitable solution and send the recommendations to the physician regarding patients with chronic heart failure.

According to some embodiments of the present invention, there is provided a patient predictive system, in which the heart simulation model is constructed for a particular patient, optionally and preferably with input from one or more cardiac function measurement devices (such as an echocardiogram for example). The system also preferably features a warning module for warning the patient and/or the physician or other medical personnel in case of a potential problem with the cardiac function of the patient. In addition, the system optionally and preferably features a treatment recommendation module, for recommending one or more treatments for the patient, which may optionally comprise one or more of drug therapy, medical device based therapy (including but not limited to a pacemaker, a stent, an artificial valve and the like) or “non-medical” therapies, including but not limited to diet, exercise and so forth.

According to other embodiments of the present invention, there is provided a patient monitoring system, in which the cardiac function of the patient is monitored at least intermittently and more preferably periodically. For example, the cardiac function of the patient could optionally be monitored with some type of implanted sensor; additionally or alternatively, the cardiac function could be monitored with a non-implanted sensor. In any case, data from one or more sensors is preferably fed to a monitoring module, which uses the previously constructed heart simulation module to analyze such data from one or more sensors. More preferably, the monitoring module then determines whether the cardiac function of the patient is stable, improving or deteriorating. If the cardiac function of the patient is deteriorating, or even if an improvement is expected but is not detected, the monitoring module preferably alerts the patient and/or the physician or other medical personnel.

The above predictive and/or monitoring systems may also optionally be adapted for use in clinical trials, for example for determining whether a particular therapy is effective. According to yet other embodiments of the present invention, there is provided a clinical trial management system, in which the above predictive and/or monitoring systems are implemented for a plurality of subjects in the clinical trial. The clinical trial management system also preferably features a management module for analyzing the results from the system(s) for each subject, for example to detect any potential problems earlier in the trial, to make certain that one or more outcomes are met (including intermediate stage outcomes and the like) and/or to collect all of the overall information from the subjects.

The clinical trial management system also optionally and preferably features a simulation module for simulating the PD/PK of one or more drugs; even if the clinical trial is for a medical device, typically the subjects will also be taking one or more drugs and so such a simulation module is potentially useful for all types of clinical trials.

The clinical trial management system also optionally and preferably features a regimen management module for optimizing the treatment regimen for the clinical trial, optionally and preferably before the clinical trial starts. The treatment regimen may optionally feature treatment involving one or more drugs and/or medical device effects being tested in the trial, and/or may also optionally relate to one or more drugs and/or medical device effects that are not being tested in the trial but which may optionally be taken by subjects in that trial.

US Patent Application No. 2006/167637 to Optimata describes a computerized top down biological process which is constructed from sufficient patient data so as to form a “general patient”. However, this application does not teach or suggest a cardiac model, nor are any of the disclosed models based upon equations derived from physics. Indeed, none of the disclosed processes relate to mechanical biological functions.

By contrast, as disclosed herein and without any intention of being limiting in any, the present invention relates to a bottom-up simulation of cardiac function, which is based upon the mechanics of such function and also upon equations derived from physics, and which is also specifically performed for a particular patient, as opposed to a “general patient”. Thus, the simulated function relates to the heart as a mechanical, physical object, as opposed to a purely biological non-mechanical process, as well as relating to a specific patient.

Furthermore the present invention, in at least some embodiments, relates to selection of an appropriate treatment protocol. Because the simulation of cardiac function is specific to a particular patient, the simulation enables those aspect(s) of the cardiac function which are problematic or likely to be problematic to be identified, such that a treatment protocol may be selected from a limited group of protocols. By contrast, the teachings of the above application of Optimata require processing of a large amount of data by considering all possible treatment protocols for optimization, since the biological process is constructed for a “general patient”, not for a specific patient.

Unless otherwise defined the various embodiments of the present invention may be provided to an end user in a plurality of formats, platforms, and may be outputted to at least one of a computer readable memory, a computer display device, a printout, a computer on a network or a user.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-C are schematic block diagrams of an exemplary system according to the present invention;

FIG. 2 is an exemplary method according to the present invention according to some embodiments of the present invention for prediction;

FIG. 3 shows a flowchart of an exemplary method according to at least some embodiments of the present invention wherein at least one and more preferably a plurality of mathematical models modeling the cardio-physiological processes of the heart are used to produce a heart functional model;

FIG. 4 provides a schematic map of the plurality of parameters describing the heart failure state;

FIG. 5 provides a schematic map of a plurality of parameters for monitoring the state of the heart;

FIG. 6 provides a schematic diagram of an optional system 600 according to an optional embodiment of the present invention;

FIG. 7 provides a schematic diagram of an optional system 700 according to an optional embodiment of the present invention;

FIG. 8 is a flowchart of an exemplary method for operating with the exemplary dynamic model of the heart as described below;

FIG. 9 shows an exemplary monitoring system 900 according to some embodiments of the present invention;

FIGS. 10A-10F show the output of various exemplary parameters for use in various embodiments of the present invention;

FIG. 11 shows a schematic block diagram of a patient predictive system according to some embodiments of the present invention;

FIG. 12 shows a schematic block diagram of a patient monitoring system according to some embodiments of the present invention; and

FIGS. 13-16 show that the above predictive and/or monitoring systems may also optionally be adapted for use in clinical trials, for example for determining whether a particular therapy is effective.

### DESCRIPTION OF THE PREFERRED EMBODIMENTS

The principles and operation of the present invention may be better understood with reference to the drawings and the accompanying description.

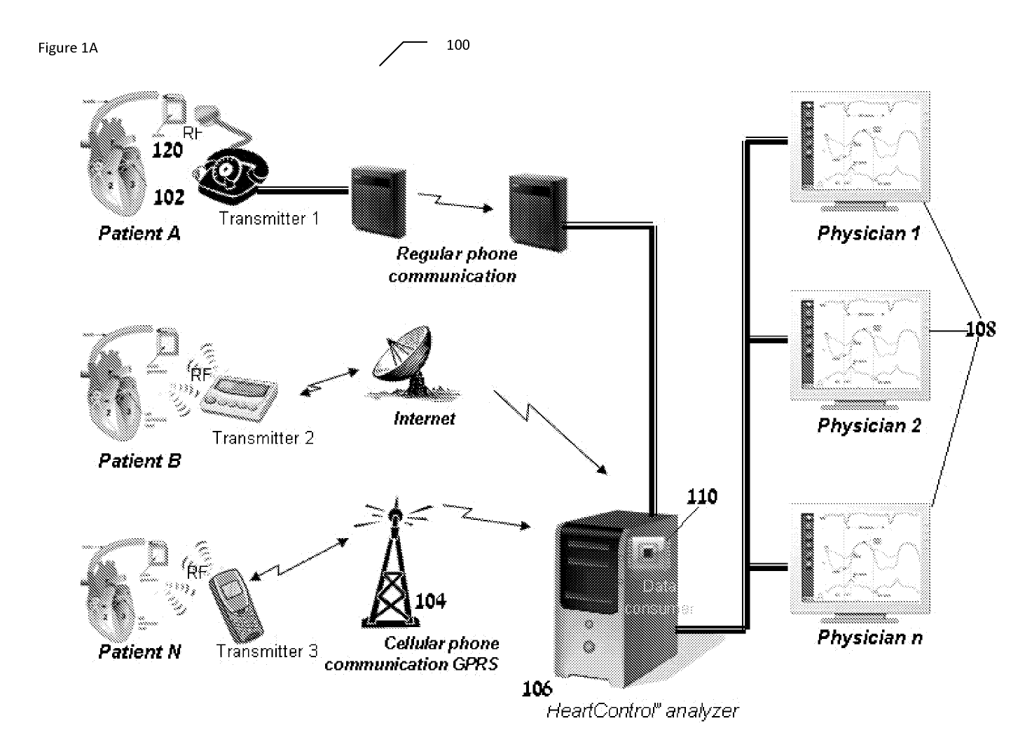

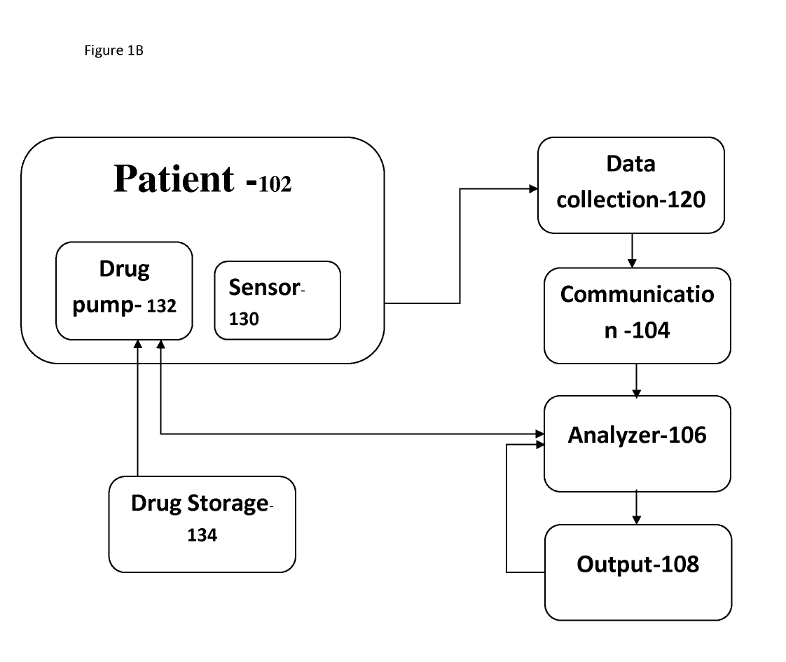

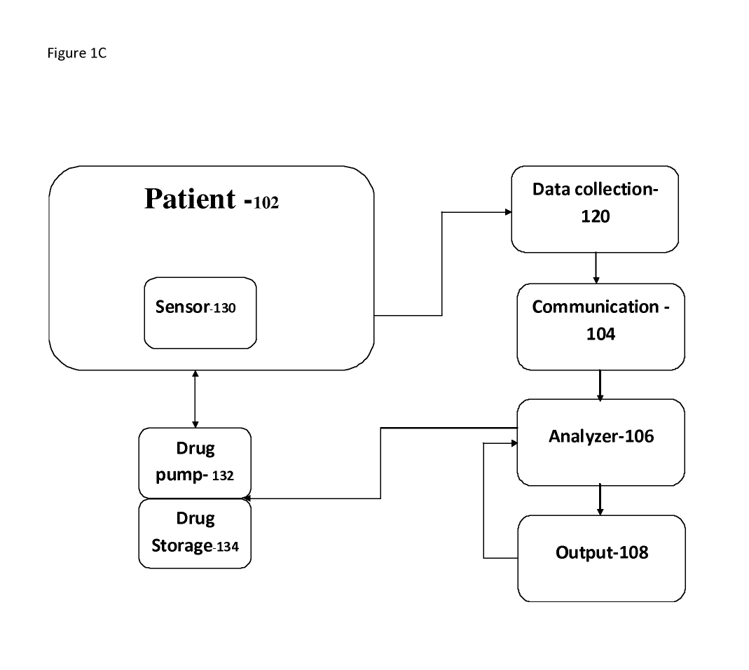

FIG. 1A shows a system 100 according to the present invention. System 100 comprises input module 102, communication module 104, processing center 106 and output module 108. Preferably input for system 100 is obtained from an input source 102, most preferably a user comprising a pacemaker or otherwise implanted at least one or more sensors providing directly measured data collected involving the cardio-physiological state of the heart. Optionally, input source 102 communicates parameters to data collection device 120 optionally via communication protocols as is known and accepted in the art for example including but not limited to Bluetooth, RF, IR, optical (preferably without a direct physical connection), or the like as is known in the art. Optionally and preferably, non implanted data may be obtained using external devices for example including but not limited to imaging devices, CT, PET, MRI, ultrasound, echo, blood works or the like non implanted devices may be utilized to obtain non-implanted data related to the cardio-physiological state of the heart. Optionally and preferably, a combination of implanted parameters and non-implanted parameters are entered into data collection device 120 according to the present invention. Input module 102 most preferably provides system 100 with a plurality of dynamic parameters that are most preferably updated on a regular basis for example every hundredth of a second.

Optionally, the plurality of parameters includes but are not limited to: left ventricle blood pressure, effective Young modulus of the left ventricle wall; deformation-related increments of internal left ventricle radius; deformation-related increments of external left ventricle radius; stress of the external left ventricle wall; right ventricle blood pressure; effective Young modulus of the right ventricle wall; deformation-related increments of internal right ventricle radius; deformation-related increments of external 1 right ventricle radius; stress of the external right ventricle wall; left atrium blood pressure; effective Young modulus of the left atrium wall; deformation-related increments of internal left atrium radius; deformation-related increments of external left atrium radius; stress of the external left atrium wall; right atrium blood pressure; effective Young modulus of the right atrium wall; deformation-related increments of internal right atrium radius; deformation-related increments of external right atrium radius; stress of the external right atrium wall; aortic blood pressure; density of blood fluid in aorta; axial blood flow velocity in aorta; axial blood flow velocity just before the entrance to aorta; aortic pressure wave propagation velocity relative to the flow; effective Young modulus of the aortic wall; deformation-related increments of the aortic radius; vena cava blood pressure; density of blood fluid in vena cava; axial blood flow velocity in vena cava; axial blood flow velocity just after the exit from vena cava; vena cava pressure wave propagation velocity relative to the flow; deformation-related increments of the vena cava radius; pulmonary artery blood pressure; the pulmonary resistance; density of blood fluid in pulmonary artery; axial blood flow velocity in pulmonary artery; axial blood flow velocity just before the entrance to pulmonary artery; pulmonary artery pressure wave propagation velocity relative to the flow; effective Young modulus of the pulmonary artery wall; deformation-related increments of the pulmonary artery radius; pulmonary vein blood pressure; density of blood fluid in pulmonary vein; axial blood flow velocity in pulmonary vein; axial blood flow velocity just after the exit from pulmonary vein; pulmonary vein pressure wave propagation velocity relative to the flow; deformation-related increments of the pulmonary vein radius; internal radius of the nondeformed (empty) left ventricle; external radius of the nondeformed (empty) left ventricle; internal radius of the nondeformed (empty) right ventricle; external radius of the nondeformed (empty) right ventricle; internal radius of the nondeformed (empty) left atrium; external radius of the nondeformed (empty) left atrium; internal radius of the nondeformed (empty) right atrium; external radius of the nondeformed (empty) right atrium; (internal) radius of the nondeformed (empty) aorta; thickness of the nondeformed (empty) aorta; effective Young modulus of the vena cava wall; (internal) radius of the nondeformed (empty) vena cava; thickness of the nondeformed (empty) vena cava; (internal) radius of the nondeformed (empty) pulmonary artery; thickness of the nondeformed (empty) pulmonary artery; effective Young modulus of the pulmonary vein wall; (internal) radius of the nondeformed (empty) pulmonary vein; thickness of the nondeformed (empty) pulmonary vein; Poisson isentropic exponent of the blood fluid; external radius of the nondeformed (empty) pericardium, or the like.

Optionally at least one or more and preferably a plurality of parameters may be updated automatically at a controllable frequency for example every hundredth of a second.

Optionally, some parameters are long term parameters the change over a long period of time for example in the order of weeks, months and may be communicated accordingly. Preferably the time frame is selected to encompass velocity of the rate of change of the various physiological and/or morphological changes, more preferably specific for each parameter for the individual subject or patient.

Optionally, parameter communication may be triggered automatically using for example including but are not limited to different compensatory mechanisms describing equations; using external devices information for example including but not limited to imaging devices, CT, PET, MRI, ultrasound, echo, blood works or the like non implanted devices may be utilized to obtain non-implanted data related to the cardio-physiological state of the heart; users decisions, or by a third party solutions.

According to preferred embodiments of the present invention, an echocardiogram (“echo”) is optionally and preferably performed in order to determine one or more of the above parameters, including but not limited to anatomical features (including but not limited to one or more of arterial shape; the internal radius of the nondeformed (empty) left ventricle; the external radius of the nondeformed (empty) left ventricle; the internal radius of the nondeformed (empty) right ventricle; the external radius of the nondeformed (empty) right ventricle; the internal radius of the nondeformed (empty) left atrium; the external radius of the nondeformed (empty) left atrium; the internal radius of the nondeformed (empty) right atrium; the external radius of the nondeformed (empty) right atrium; the (internal) radius of the nondeformed (empty) aorta; the thickness of the nondeformed (empty) aorta; the (internal) radius of the nondeformed (empty) lung blood vessel; the thickness of the nondeformed (empty) lung blood vessel; the (internal) radius of the nondeformed (empty) vena cava; the thickness of the nondeformed (empty) vena cava; the (internal) radius of the nondeformed (empty) pulmonary artery; the thickness of the nondeformed (empty) pulmonary artery; the (internal) radius of the nondeformed (empty) pulmonary vein; the thickness of the nondeformed (empty) pulmonary vein; the average radius of the nondeformed (empty) pulmonary arteries; the average thickness of the nondeformed (empty) pulmonary arteries; the average length of pulmonary arteries; the average radius of the nondeformed (empty) pulmonary capillaries; the average thickness of the nondeformed (empty) pulmonary capillaries; the average length of pulmonary capillaries; the average radius of the nondeformed (empty) pulmonary veins; the average thickness of the nondeformed (empty) pulmonary veins; the average length of pulmonary veins; the average radius of the nondeformed (empty) systemic arteries; the average thickness of the nondeformed (empty) systemic arteries; the average length of systemic arteries; the average radius of the nondeformed (empty) systemic capillaries; the average thickness of the nondeformed (empty) systemic capillaries; the average length of systemic capillaries; the average radius of the nondeformed (empty) systemic veins; the average thickness of the nondeformed (empty) systemic veins; the average length of systemic veins; the external radius of the nondeformed (empty) pericardium). An echocardiogram may also optionally be used for determining one or more parameters relating to the “deformed” versions of the above features, from which (for example and without limitation), elasticity may optionally be determined.

Similarly, according to other preferred embodiments, one or more other of the above parameters may also optionally be determined according to one or more methods known in the art, for example with regard to determining blood density, blood velocity (which may optionally be determined by using an echocardiogram and/or MRI or other types of tomography such as CT scans for example) and so forth.

Optionally, an automatic trigger for initiating parametric communication may for example include a threshold crossing change for at least one or more parameters. Optionally, at least one or more of parameters are obtained from a non implanted source for example an imaging device, and are updated upon availability. Preferably third party data which is from a non implanted device or diagnostic technology is provided directly to analyzer 106.

Data collection device 120 preferably, collects all available and/or required cardiac parameters communicating them to processing center 106 preferably utilizing communication module 104. Preferably, communication between data collection device 120 and processing center 106 facilitated by communication module 104 may utilize optional communication protocols, configurations and systems for example including but not limited to wireless, wired, cellular, optical, landline, communication or the like as is known in the art. For example communication may be achieved over a landline telephone network, cellular, wireless, satellite network, GPRSM, internet, text, email, markup language or the like communication protocols as is known and accepted in the art.

Preferably, processing center 106 comprises a data consumer 110 that preferably receives the data transmitted over communication module 104. For example, data consumer 110 may optionally be implemented as software and/or as a particular device. Most preferably, processing center 106 performs an analysis of the input material to analyze the plurality of parameters obtained from input module 102. Preferably producing an output that is communicated to output module 108 for example to at least one or more output sources for example including but not limited to a physician, call center, health care provider, health insurance agency, emergency services agency or the like. Optionally, output module may be delivered via network communication or any communication protocols or configuration known and accepted in the art. Most preferably, communication involving cardio-physiological parameters, protocols, user data, protocols or otherwise system and user sensitive or specific data is communicated in a secure manner as is known and described in the art. Output module 108 may be provided in plurality of controllable optional modalities for example including but not limited to text, email, fax, phone call, SMS, or the like as is known and accepted in the art.

Most preferably, processing center comprises a method according to a preferred embodiment of the present invention wherein cardio-physiological data is analyzed preferably by at least one or more preferably a plurality of mathematical models relating to the cardio-physiological state of the heart. Preferably, the parameters received from input module 102 are processed to produce an output for example a predictive model of the cardio-physiological state of the heart indicating optionally long term and/or short term prediction of the cardio-physiological state. More preferably based on at least one short or long term prediction the system and method of the present invention is able to determine a recommendation for a physician or other relevant medical personnel, for example for a prevention solution or other treatment solution. Optionally, the predictive model abstracted by a preferable method of the present invention, optionally enables the abstraction of responsive action. Optionally, the responsive action may be communicated and delivered via output module 108.

FIGS. 1B-C show a schematic block diagram of optional embodiments of the present invention, similar numbering is used to indicate similar functioning parts as depicted in FIG. 1A. FIGS. 1B and 1C depict optional embodiments of system 100 of FIG. 1A further comprising a drug pump 132 that is optional implanted as depicted in FIG. 1B forming system 101 or placed externally as depicted in FIG. 1C forming system 103. Data collector 120 is provided with cardio-physiological data from patient 102 most preferably through at sensor module 130 for example including but not limited to a pacemaker Preferably the data is analyzed and processed as described in FIG. 1A, with the additional option to control a drug pump 132 that is connected to drug storage 134. Preferably, control of drug pump 132 and drug storage 134 devices is conveyed to as a result of output 108. Preferably, output 108 is reviewed by a physician that may optionally control output 108 that may be utilized to provide instructions to pump 132. Most preferably, drug pump 132 controls drug storage module 134. Preferably, drug pump 132 is controllable with analyzer 106 to provide patient 102 with the appropriate dosage. Optionally, control of drug pump 132 may be facilitated from analyzer 106 through communication module 104.

FIG. 1C provides an additional depiction of FIG. 1B wherein drug pump 132 is disposed externally. Therein system 103 and/or 101 provide patient 102 with a controllable drug dosage 134 using a drug delivery pump 132 in accordance with the dynamic cardio-physiological state of the heart as sensed by sensor 130 providing dynamic control of a patients chronic heart failure condition.

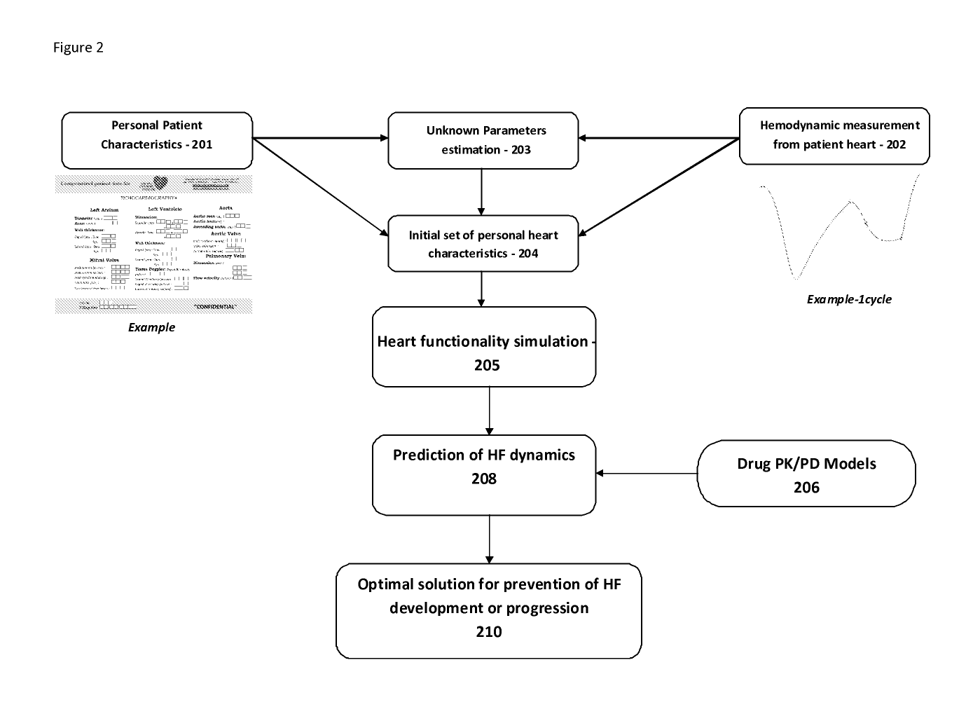

FIG. 2 shows a flowchart of an exemplary method according to the present invention wherein at least one and more preferably a plurality of mathematical models modeling the cardio-physiological processes of the heart are used to produce a heart functionally model, most preferably for the purposes of producing predictive and responsive actions in response to the determined cardio-physiological state of the heart. Most preferably, the analytical method is undertaken by processing center 106 of FIG. 1. Optionally and preferably, the analysis according to a preferred method of the present invention produces a patient specific heart functionality model. Optionally, system 100 depicted in FIG. 1 can learn and update a patient specific hearth functionality model in accordance with patient specific parameters.

In stage 201 user specific personal data is determined, preferably using information from an external device, for example including but not limited to imaging devices, PET, MRI, CT scan ultrasound, echo, blood works or the like non implanted devices may be utilized to obtain non-implanted data related to the cardio-physiological state of the heart.

In stage 202 hemodynamic parameters specific to a user are further determined. Optionally, parameters may be implanted parameters or external parameters as defined previously. Preferably, in stage 205 an initial heart functionality model is abstracted based on the parameters entered in stages 201 and 202. Most preferably, a set of initial global models or one global model is simulated to determine the state of heart functionality; as described below, the dynamics of the process are then predicted.

In stage 208 the initial heart functional model abstracted in stage 205 is preferably used to produce a dynamic heart function predication model most preferably by implementing the dynamic model according to the present invention with the monitored data, to demonstrate the dynamics of the process. Optionally and preferably in stage 208 the predictive model of stage 206 is simulated together with pharmaceutical models identifying or accommodating the relevant PK/PD model. In stage 210 the predictive model of stage 206 is further analyzed with the dynamic mathematical models according to the present invention to produce an integrative depiction of the heart functioning by providing optional response actions, most preferably to prevent the development and/or advancement of heart failure. Optionally and preferably, a variety of different solutions are proposed as an output that is preferably communicated by output module 108 of FIG. 1 to at least one or more of a physician, call center or other healthcare provider to further analyze the situation. Preferably, relevant solutions are proposed to an appropriate health care provider using one or more rules, preferably based on at least one or more of operation research methods, particularly search algorithms.

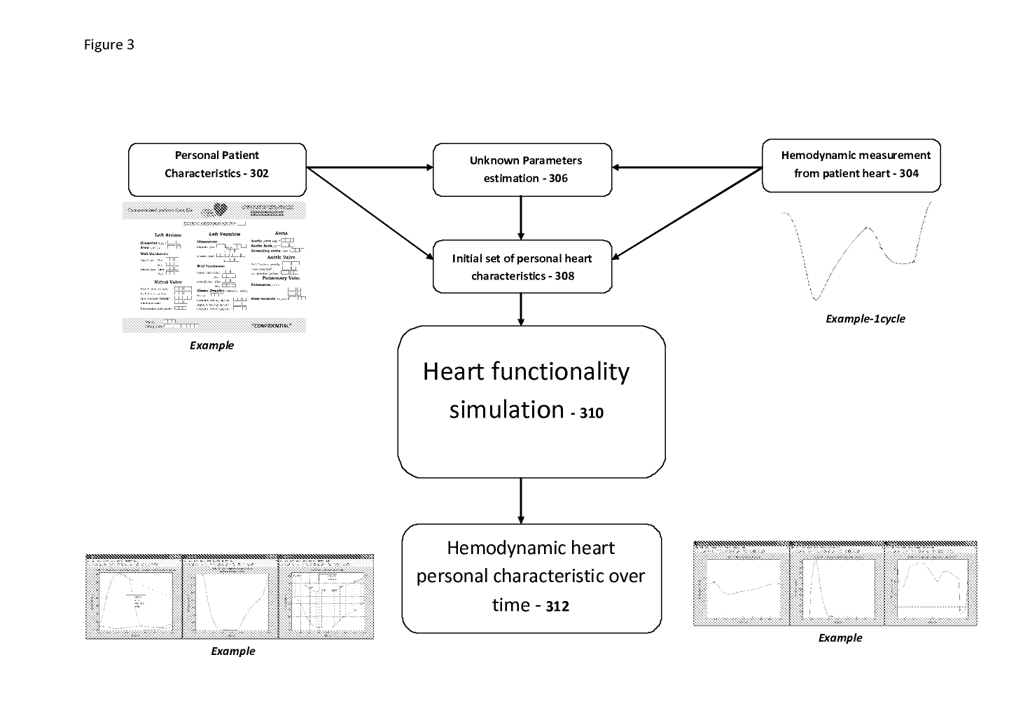

FIG. 3 shows a flowchart of an exemplary method according to at least some embodiments of the present invention wherein at least one and more preferably a plurality of mathematical models modeling the cardio-physiological processes of the heart are used to produce a heart functional model, most preferably for the purposes of monitoring the patient on the basis of the determined cardio-physiological state of the heart. As for the method of FIG. 2, most preferably, the analytical method is undertaken by processing center 106 of FIG. 1. Optionally and preferably, the analysis according to a preferred method of the present invention produces a patient specific heart functionality model. Optionally, system 100 depicted in FIG. 1 can learn and update a patient specific hearth functionality model in accordance with patient specific parameters.

In stage 301 user specific personal data is determined, preferably using information from an external device, for example including but not limited to imaging devices, PET, MRI, CT scan ultrasound, echo, blood works or the like non implanted devices may be utilized to obtain non-implanted data related to the cardio-physiological state of the heart. In addition, preferably hemodynamic measurements are taken from the patient's heart in stage 304. Any remaining unknown parameters are then preferably estimated in stage 306.

In stage 308 hemodynamic parameters specific to a user are further determined. Optionally, parameters may be implanted parameters or external parameters as defined previously. An initial heart functionality model is abstracted based on the parameters entered in stages 301 and 308. Most preferably, a set of initial global models or one global model is simulated to determine the state of heart functionality; as described below, the dynamics of the process are then predicted.

In stage 310 the initial heart functional model abstracted in stage 308 is preferably used to produce a dynamic heart function monitoring model most preferably by implementing the dynamic model according to the present invention with the monitored data, to demonstrate the dynamics of the process. Optionally and preferably in stage 310 the monitoring model of stage 308 is simulated together with any updated data obtained from extended monitoring of the patient as previously described.

In stage 312 the monitoring model of stage 310 is further analyzed with the dynamic mathematical models according to the present invention to produce an integrative depiction of the heart functioning by providing optional response actions, most preferably to prevent the development and/or advancement of heart failure. Optionally and preferably, a variety of different solutions are proposed as an output that is preferably communicated by output module 108 of FIG. 1 to at least one or more of a physician, call center or other healthcare provider to further analyze the situation. Preferably, relevant solutions are proposed to an appropriate health care provider using one or more rules, preferably based on at least one or more of operation research methods, particularly search algorithms. Furthermore, the process of stage 312 is optionally repeated a plurality of times as more data from monitoring the patient for an extended period of time becomes available.

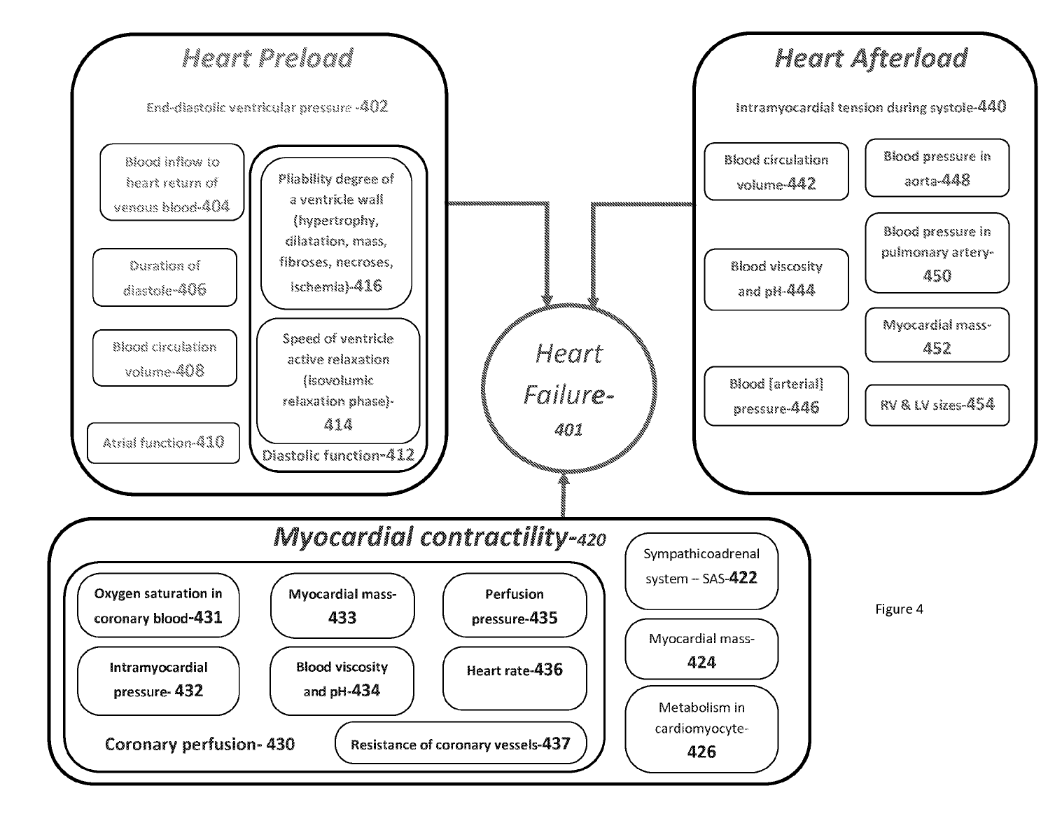

FIG. 4 provides a schematic map of the plurality of parameters describing the heart failure state and that are considered by the system and method of the present invention in abstracting heart failure model 401 so that a suitable solution according to the method of FIG. 2 may be provided. FIG. 4 shows parameter array 400 comprising three primary inputs: heart preload parameters 402, myocardial contractility parameters 420 and heart afterload parameters 440 contributing to Heart Failure model 401. Preferably, heart preload parameters 402 comprise blood inflow data 404 (with return of venous blood), duration of diastole 406, blood circulation volume 408, atrial function 310 and Diastolic function parameters 412. Optionally, diastolic function parameters 412 further comprise speed of ventricle active relaxation (isovolumic relaxation phase) 414 and degree of ventricle wall pliability 416, the latter of which optionally is impacted by one or more factors, including but not limited to hypertrophy, dilatation, mass, fibroses, necroses and/or ischemia. Most preferably, these parameters are taken into consideration when forming and solving for the mathematical models.

Preferably, myocardial contractility parameters 420 comprise one or more of coronary perfusion data 430, SAS (Sympathicoadrenal system) 422, myocardial mass 424, metabolism in cardiomyocyte 426 or the like, or a combination thereof. Parameters relating to coronary perfusion optionally include but are not limited to one or more of: Oxygen saturation in coronary blood 431; Myocardial mass—433; Perfusion pressure—435; Intramyocardial pressure—432; Blood viscosity and pH—434; Heart rate—436; and/or Resistance of coronary vessels—437.

Preferably parameters relating to intramyocardial testing during systole 440 (also related to heart afterload) are also considered in abstracting the model 401 according to the present invention. Optionally, systolic parameters 440 optionally comprise blood circulation volume 442, blood viscosity and pH 444, ventricle sizes 454 (optionally separately for left and right ventricles), pulmonary artery blood pressure (for example for data on the right ventricle) 450, aortic blood pressure (for example for data on the left ventricle) 448, arterial blood pressure 446.

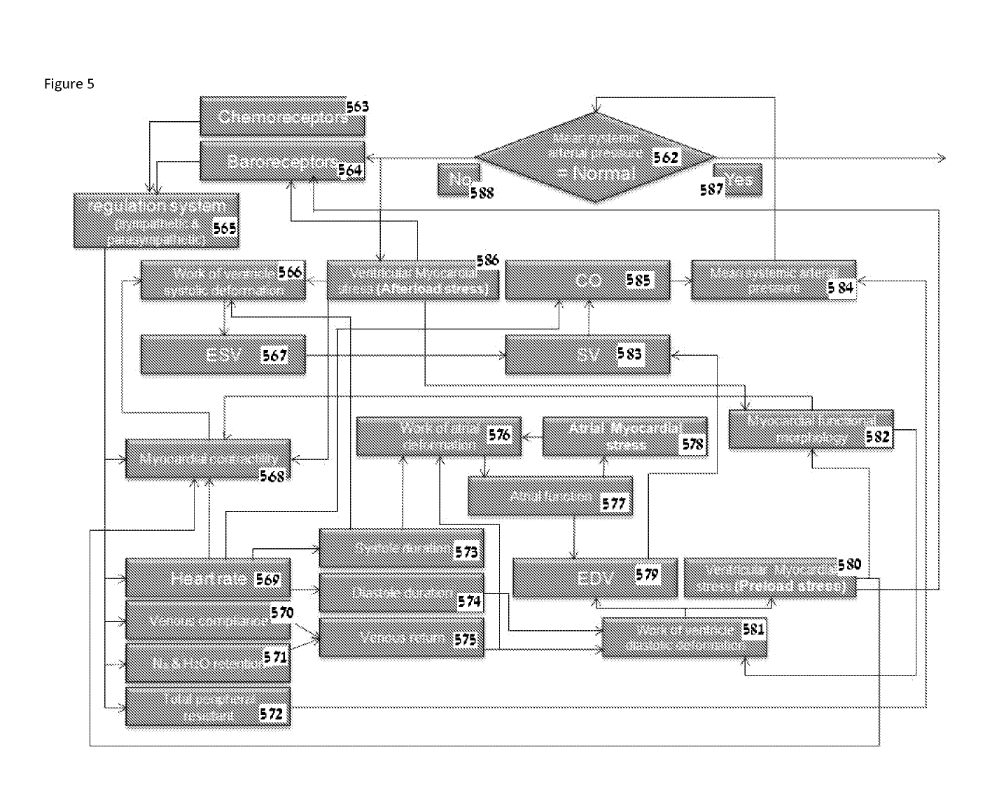

FIG. 5 provides a schematic map of a plurality of parameters for monitoring the state of the heart and that are considered by the system and method of the present invention in conjunction with heart failure model 401 so that the patient's condition may be monitored over time. As many of the parameters below relate to regulatory processes, and not only single parameter measurements, optionally and preferably the patient is monitored for a sufficiently extended period of time as described above in order for these measurements to be made accurately.

FIG. 5 shows a parameter array and the interrelationships between these parameters during heart operation process. As shown, the monitoring parameters are preferably examined in the following order. First, it is determined whether the mean systemic arterial pressure is normal, as parameter 562; if yes (587), then the patient is considered to have a normal condition and further examination of the regulation is not necessary. If no (588), then preferably the operation of the baroreceptors (564) and chemoreceptors (563) are examined, which in turn leads to examination of the sympathetic and parasympathetic regulation systems 565. In turn, these systems relate to myocardial contractility 568. Such contractility in turn relates to heart rate 569, venous compliance 570, sodium and water retention 571 and total peripheral resistance 572. Heart rate 569 relates to systole duration 573 and diastole duration 574, while venous compliance 570 and sodium and water retention 571 relate to venous return 575.

Systole duration 573 in turn impacts upon the work of atrial deformation 576, as does venous return 575. The work of atrial deformation 576 is in a feedback cycle with atrial function 577 and atrial myocardial stress 578, each of which impacts upon the next in a cycle.

Atrial function 577 also impacts upon EDV 579, which is also impacted by the work of ventricle diastolic determination 581; the latter parameter is affected by diastole duration 574 and venous return 575. The work of ventricle diastolic deformation 581 impacts upon preload stress 580 (ventricular myocardial stress), which in turn affects myocardial functional morphology 582, which in turn feeds back to the work of ventricle diastolic deformation 581. Myocardial functional morphology 582 is also affected by total peripheral resistance 572.

Systole duration 573 affects the work of ventricle systolic deformation 566 (which is also affected by myocardial contractility 568), which in turn affects ESV 567. ESV 567 affects SV 583, which is also affected by EDV 579. SV 583 affects CO 585, which is also affected by heart rate 569. Myocardial contractility 568 is also affected by afterload stress 586 (ventricular myocardial stress), which is again affected by myocardial functional morphology 582, thereby indirectly affecting CO 585.

CO 585 directly impacts upon mean systemic arterial pressure 584, leading back to the consideration of parameter 562 as to whether this pressure is normal or not.

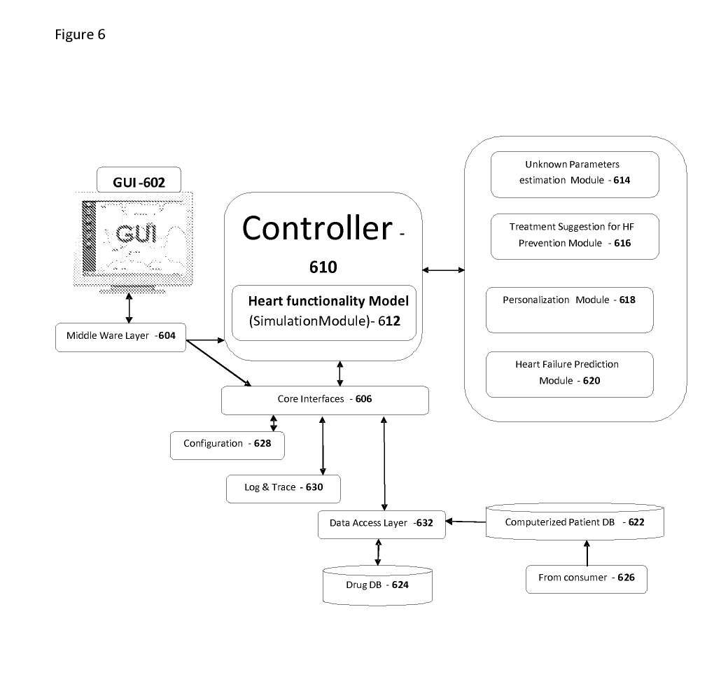

FIG. 6 provides a schematic diagram of an optional system 600 according to an optional embodiment of the present invention. System 600 provides a more detailed description of processing center 106 of FIG. 1, comprising user interface 602, an optional middleware layer 604 (preferably for converting all necessary information from a variety of data types and/or different inputs into an integrated format), interface 606, controller 610, simulation module 612, unknown parameters estimation module 614, treatment selection module 616, personalization module 618 and prediction module 620.

Preferably, user interface 602 provides a user preferably a physician with the user friendly interface providing means for viewing, analyzing, with the patient parameters, mathematical models, predictions, analysis, recommended responsive actions, patient specific module or other controllable features associated with the system and method of the present invention. Most preferably, the physician can control actions taken and prescribed to a patient in a user friendly manner. User interface 602 is provided with a processing middle ware layer 604 that preferably provides seamless transition from the core interface module 606. Preferably core interface module 606 comprises the primary interface providing communication with parameters obtained from the implanted sensors, for example a pacemaker Core interface module 606 communicates with configuration module 632, log and trace module 630 and data access layer module 628 individually facilitating the seamless flow of information from the plurality of sensor to the user inter interface 602.

Controller 610 preferably undertakes the necessary activity to control the plurality of modules 614-620 and the core interfaces. However, most preferably, controller 610 provides control for simulation module 612 in abstracting a heart functionality model as previously described in FIG. 2. Controller 610 provides simulation module 612 with the required parameters from the plurality of modules and models utilized according to the present invention. Most preferably, the prediction module 620 provides a user with the cardio-physiological prediction according to the current status and parameter reading of the heart. Personalization module 618 provides controller 610 with the ability to personalize a model in accordance with a particular patient's parametric readings and changes. Module 616 provides system 600 with one or more potential treatment solutions that preferably take into account the available treatments type of implanted sensors, effectors and the like. Module 614 learns and adapts itself to unknown parameters, new parameters, and unexpected changes, by using one or more operation research search algorithms, specific personal data from stage 200 in FIG. 2, and the results of the simulation of the heart functionality model in stage 204 of FIG. 2 from the time of monitoring of at least one and more preferably a plurality of cardiac parameters.

Preferably controller 610 provides simulation module 612 with the ability to integrate the results of the various modules 614-620 to come up with a holistic model that fits the parametric measured optionally internally or externally as previously described.

Preferably, patient parameters repository 622 and drug repository 624 are utilized to provide system 600 with pertinent data relating to both the drug optionally utilized as part of the treatment of a patient as well as data relating to the patient himself. Optionally, some of the data available to patient parameters repository 622 is obtained from an external source 626 for example including a health care database, patient, physician or the like.

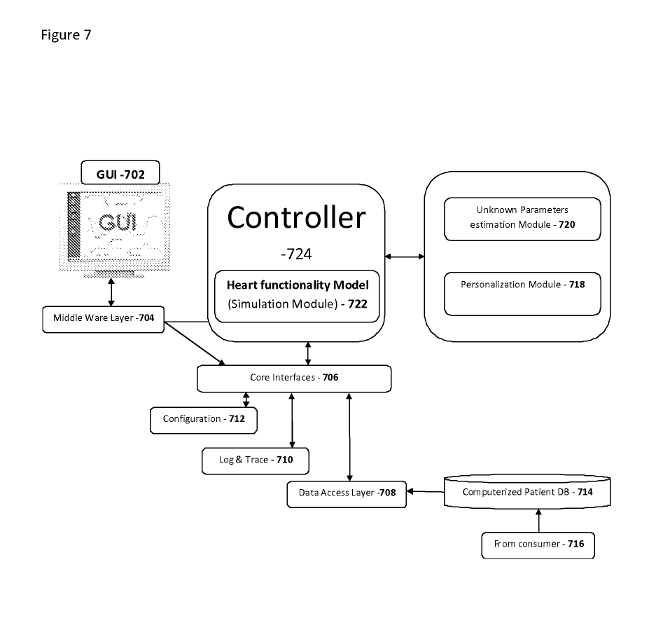

FIG. 7 provides a schematic diagram of an optional system 700 according to an optional embodiment of the present invention. System 700 provides a more detailed description of processing center 106 of FIG. 1, in this embodiment adapted for monitoring of the patient as opposed to predicting a future patient state. System 700 optionally and preferably comprises user interface 702, an optional middleware layer 704 (preferably for converting all necessary information from a variety of data types and/or different inputs into an integrated format), core interface 706, controller 724, configuration module 712, unknown parameters estimation module 720, personalization module 718 and heart functionality simulation module 722.

Preferably, user interface 702 provides a user preferably a physician with the user friendly interface providing means for viewing, analyzing, with the patient parameters, mathematical models, predictions, analysis, recommended responsive actions, patient specific module or other controllable features associated with the system and method of the present invention. Most preferably, the physician can control actions taken and prescribed to a patient in a user friendly manner. User interface 702 is provided with a processing middle ware layer 704 that preferably provides seamless transition from the core interface module 706.

Preferably core interface module 706 comprises the primary interface providing communication with parameters obtained from the implanted sensors, for example a pacemaker Core interface module 706 communicates with configuration module 712, log and trace module 710 and data access layer module 708 individually facilitating the seamless flow of information from the plurality of sensor to the user interface 702.

Controller 724 preferably undertakes the necessary activity to control the plurality of modules 704, 722, 720, 718 and the core interfaces 706. However, most preferably, controller 724 provides control for simulation module 722 in abstracting a heart functionality model as previously described in FIG. 2. Controller 724 provides simulation module 722 with the required parameters from the plurality of modules and models utilized according to the present invention. Personalization module 718 provides controller 724 with the ability to personalize a model in accordance with a particular patient's parametric readings and changes.

The results of monitoring the patient over time, shown as information 716, are preferably provided through a computerized patient database 714 so that both current and historical patient information are both preferably available through data access layer 708. This information is preferably ultimately used by heart function simulation model 722 to analyze the current state of the patient's cardiac function with regard to the previously determined model and also the current and historical data. Such an analysis enables the physician, for example, to determine whether a current treatment regimen is having the desired effect upon the patient, and also whether the patient's condition is steady, improving or deteriorating for example.

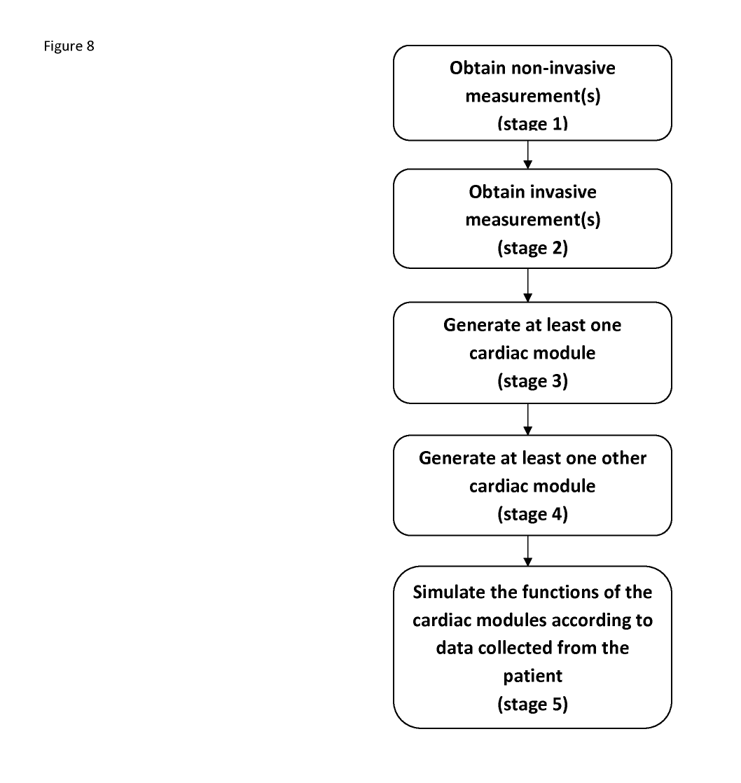

FIG. 8 is a flowchart of an exemplary method for operating with the exemplary dynamic model of the heart as described below. In stage 1, one or more non-invasive measurements are optionally performed. In stage 2, one or more invasive measurements are performed. Optionally the stages are switched; also optionally only one stage is performed.

In stage 3, optionally, at least one cardiac module is generated for most preferably modeling at least one and more preferably a plurality of individual cardio-physiological events of the heart, for example relating to the incoming and outgoing blood flows, and/or elasticity that are combined to provide a single cardio-physiological model. Most preferably the module may optionally include but is not limited to one or more of the following: the elasticity equation for the set {blood flow in artery, arterial walls} only; the elasticity equation for the set {blood flow in vein, venous walls} only; The elasticity equations for the set {blood flow in ventricle ventricle walls} only; the elasticity equations for the set {blood flow in atrium atrial walls} only; equations (hydrodynamic equation of continuity (the conservation of mass), conservation of the axial component of momentum) for the set {blood flow in artery arterial walls}; equations (hydrodynamic equation of continuity (the conservation of mass), conservation of the axial component of momentum) for the set {blood flow in vein+venous walls}; the equations binding the ventricular and arterial flows and wall elasticity on systole (Conservation of mass, Conservation of momentum, Moens-type equation, Conservation of energy); the equations binding the arterial flow and wall elasticity on diastole (hydrodynamic equation of continuity (the conservation of mass), conservation of the axial component of momentum, Conservation of energy); the equations binding the venous-atrial and ventricular flows and wall elasticity on rapid and reduced ventricular filling and atrial systole (Conservation of mass, Conservation of momentum, Moens-type equation, Conservation of energy); the equations binding the venous-atrial flow and wall elasticity when the (mitral or tricuspid, respectively) valve is closed (hydrodynamic equation of continuity (the conservation of mass), conservation of the axial component of momentum, Conservation of energy, Moens-type equation); the equations binding the blood flows in pulmonary artery, lung blood vessel and pulmonary vein and wall elasticity; the empirical equations binding relation between the physiological parameters and describing the regulatory and compensatory mechanisms of heart functionality; or the like.

In stage 4, preferably at least one other module is generated, again more preferably selected from the above list. However, optionally only one module is generated, such that stage 4 is optionally not performed.

In stage 5, the functions of the plurality of modules are preferably simulated for an actual patient according to the data collected, such that the functions of the plurality of modules enable the heart functions to be modeled.

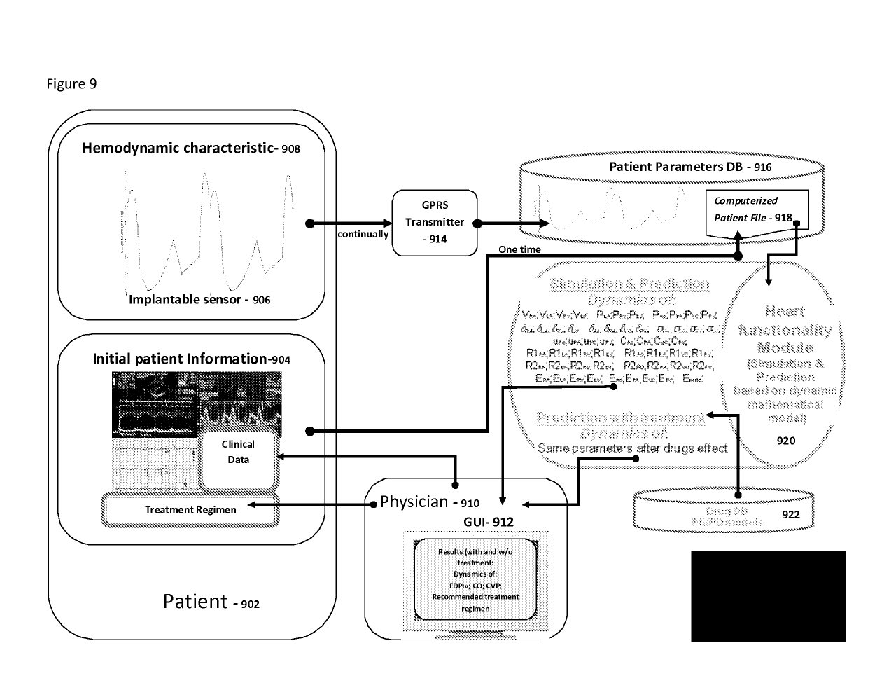

FIG. 9 shows an exemplary monitoring system 900 according to some embodiments of the present invention. As shown, a system 900 uses monitoring information 902 about the patient. Such monitoring information 902 preferably includes initial patient information 904 (for example including but not limited to clinical data and treatment regimen information) and also monitored information collected over time about one or more hemodynamic characteristics 908, for example optionally from an implantable sensor 906 as described herein.

Information from the implantable sensor 906 or other monitoring device is preferably provided continually to a patient parameters database 916, for example optionally and preferably through a GPRS transmitter 914. Within the patient parameters database 916, there is preferably (for example) a computerized patient file 918, which more preferably includes the previously described initial patient information 904 and also the continually received patient data.

The information in computerized patient file 918 is preferably provided to a heart functionality module 920, which includes simulation and prediction of the heart function of the patient, based upon a dynamic mathematical model. Heart functionality module 920 also preferably assesses the impact of one or more drugs on the patient, for example based upon drug database models 922, which in turn include information about parameters 924 that may be affected by such drugs.

All of this information is preferably made available as physician information 910 through a physician interface 912.

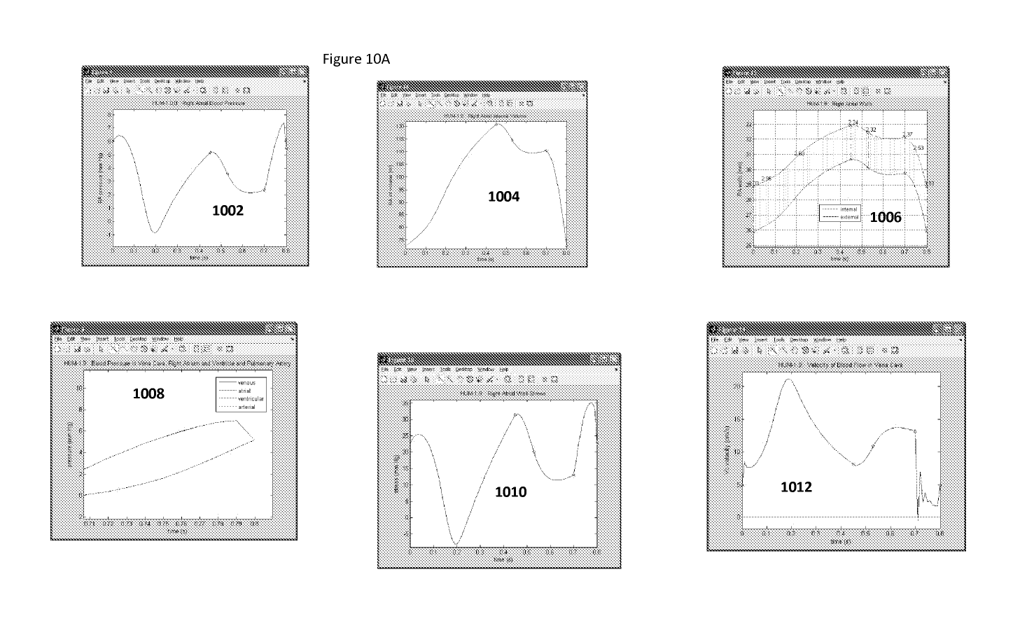

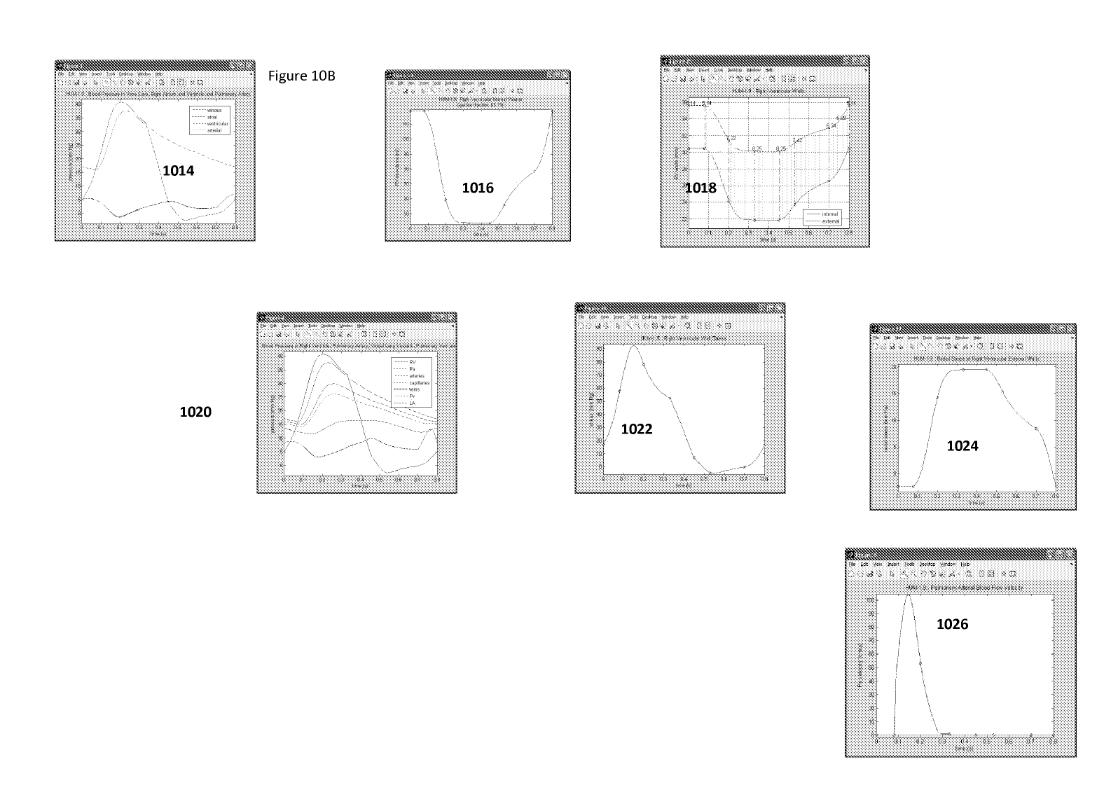

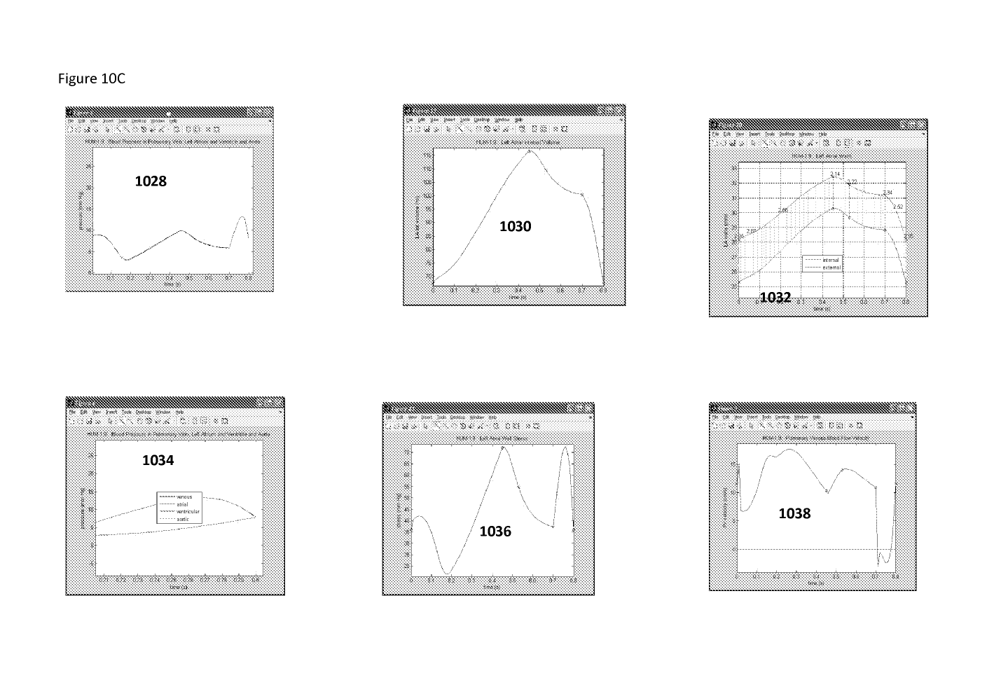

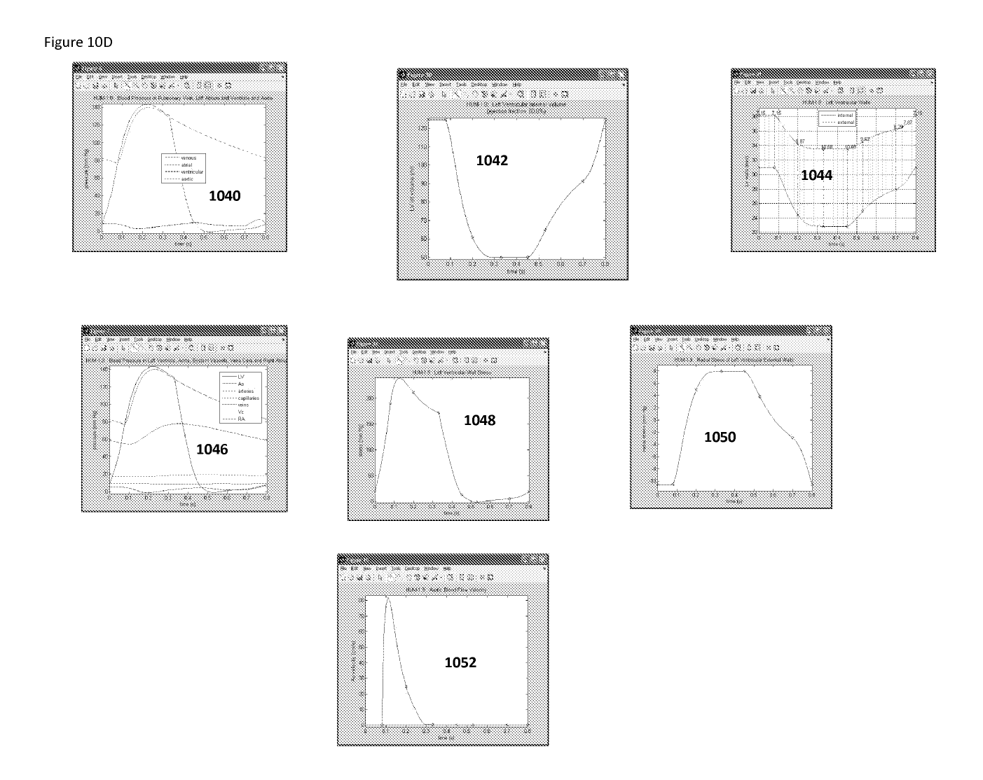

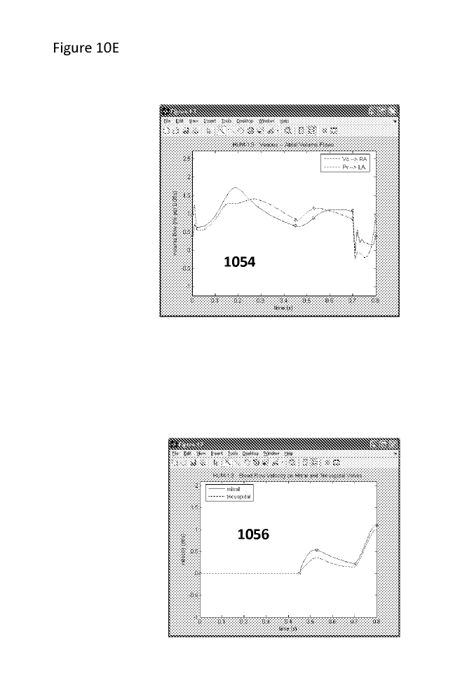

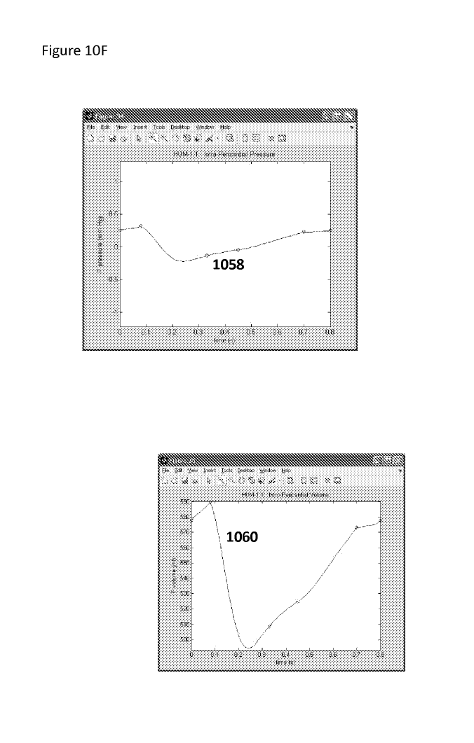

FIGS. 10A-10F show the output of various exemplary parameters for use in various embodiments of the present invention. FIG. 10A shows right atrial parameters: right atrial blood pressure 1002, right atrial internal volume 1004, right atrial walls 1006, blood pressure in the vena cava, right atrium and ventricle and pulmonary artery 1008, right atrial wall stress 1010 and velocity of blood flow in vena cava 1012.

FIG. 10B shows right ventricle parameters: blood pressure in the vena cava, right atrium and ventricle and pulmonary artery 1014; right ventricle internal volume 1016; right ventricle walls 1018; blood pressure in right ventricle, pulmonary artery, virtual lung vessels and pulmonary vein 1020; right ventricular wall stress 1022; radial stress of right ventricular external walls 1024; and pulmonary artery blood flow velocity 1026.

FIG. 10C shows left atrial parameters: left atrial blood pressure 1028, left atrial internal volume 1030, left atrial walls 1032, blood pressure in the pulmonary vein, left atrium and ventricle and aorta 1034, left atrial wall stress 1036 and velocity of blood flow in the pulmonary vein 1038.

FIG. 10D shows left ventricle parameters: blood pressure in the pulmonary vein, left atrium and ventricle and aorta 1040; left ventricle internal volume 1042; left ventricle walls 1044; blood pressure in left ventricle, aorta, system vessels, vena cava and right atrium 1046; left ventricular wall stress 1048; radial stress of left ventricular external walls 1050; and aortic blood flow velocity 1052.

FIG. 10E shows flow parameters: venous-atrial volume flows 1054; and blood flow velocity on mitral and tricuspidal valves 1056. FIG. 10F shows pericardium related parameters: intra-pericardial pressure 1058; and intra-pericardial volume 1060.

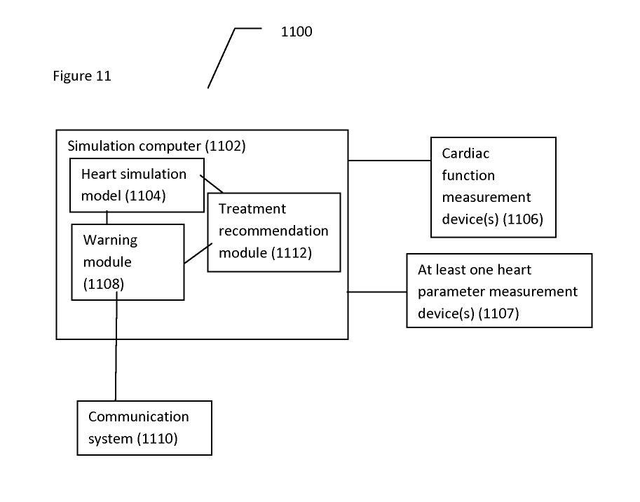

FIG. 11 shows a schematic block diagram of a patient predictive system according to some embodiments of the present invention. As shown, a system 1100 preferably features a simulation computer 1102 for operating a heart simulation model 1104 that is constructed for a particular patient, optionally and preferably with input from one or more cardiac function measurement devices 1106 (such as an echocardiogram for example), as well as optionally and preferably with input from at least one heart parameter measurement device(s) 1107, for example including but not limited to an internal sensor, an external sensor, any type of cardiac related measuring device and so forth, as described in greater detail below. Simulation computer 1102 operates heart simulation model 1104 by performing the necessary calculations; if additional data is required, then simulation computer 1102 preferably communicates this need to the physician or other medical personnel.

The system 1100 also preferably features a warning module 1108, operated by simulation computer 1102, for warning the patient and/or the physician or other medical personnel in case of a potential problem with the cardiac function of the patient (shown herein as being connected to a communication system 1110, including but not limited to a cellular telephone system, pager system, PSTN telephone system and so forth) according to information obtained from the above operation of simulation computer 1102 with heart simulation model 1104. Warning module 1108 may also optionally and preferably communicate the need for additional data, as described above, to the physician or other medical personnel.

In addition, the system 1100 optionally and preferably features a treatment recommendation module 1112, also preferably operated by simulation computer 1102, for recommending one or more treatments for the patient, which may optionally comprise one or more of drug therapy, medical device based therapy (including but not limited to a pacemaker, a stent, an artificial valve and the like) or “non-medical” therapies, including but not limited to diet, exercise and so forth. Warning module 1108 may also optionally and preferably communicate with treatment recommendation module 1112, for example in order to recommend a treatment in case of a warning to the patient and/or physician or other medical personnel.

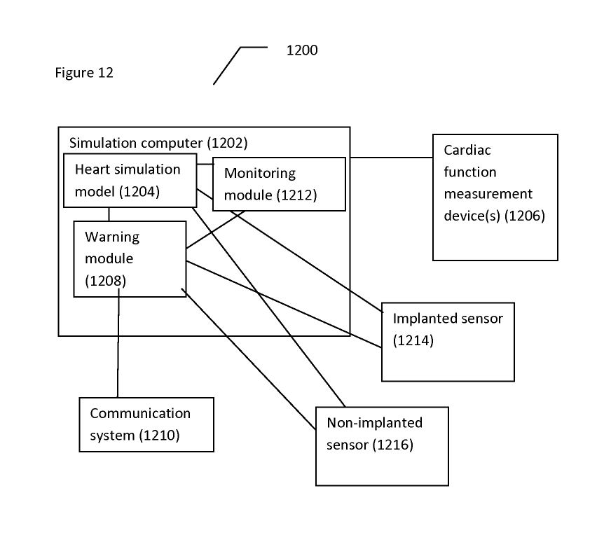

FIG. 12 shows a schematic block diagram of a patient monitoring system according to some embodiments of the present invention. As shown, a system 1200 preferably monitors the cardiac function of the patient is monitored at least intermittently and more preferably periodically. System 1200 preferably features some type of implanted sensor 1214 for monitoring the cardiac function of the patient. System 1200 may also, additionally or alternatively, feature a non-implanted sensor 1216.

In any case, data from sensors 1214/1216 is preferably fed to a monitoring module 1212, which is operated by a simulation computer 1202 and which uses a heart simulation model 1204 that is constructed for a particular patient, optionally and preferably with input from one or more cardiac function measurement devices 1206 (such as an echocardiogram for example). Simulation computer 1202 operates heart simulation model 1204 by performing the necessary calculations; if additional data is required, then simulation computer 1202 preferably communicates this need to the physician or other medical personnel.

Monitoring module 1212 uses the previously constructed heart simulation model 1204 to analyze such data from one or more sensors 1214/1216. More preferably, the monitoring module 1212 then determines whether the cardiac function of the patient is stable, improving or deteriorating. If the cardiac function of the patient is deteriorating, or even if an improvement is expected but is not detected, the monitoring module 1212 preferably alerts the patient and/or the physician or other medical personnel, most preferably through a warning module 1208 for warning the patient and/or the physician or other medical personnel in case of a potential problem with the cardiac function of the patient (shown herein as being connected to a communication system 1210, including but not limited to a cellular telephone system, pager system, PSTN telephone system and so forth). Warning module 1208 may also optionally and preferably communicate the need for additional data, as described above, to the physician or other medical personnel.

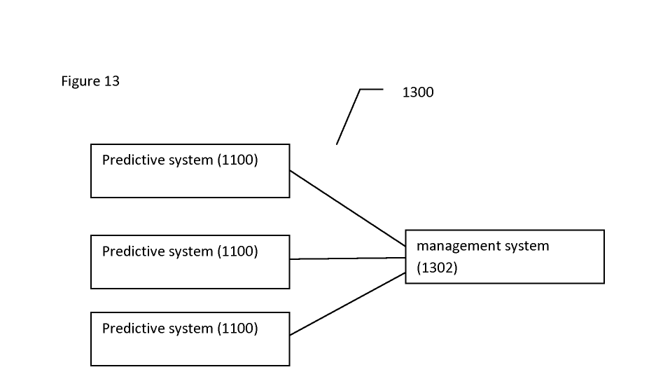

FIGS. 13-16 show that the above predictive and/or monitoring systems may also optionally be adapted for use in clinical trials, for example for determining whether a particular therapy is effective.

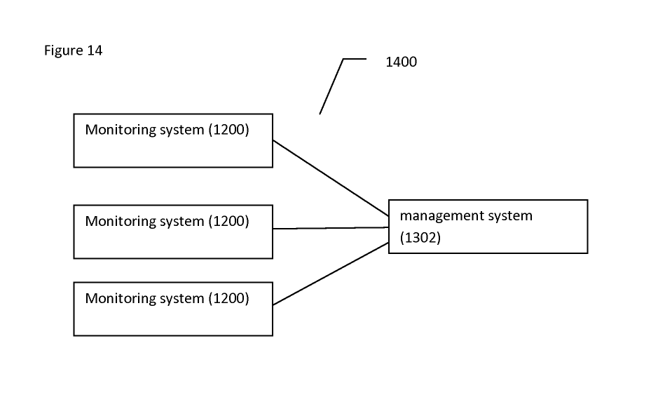

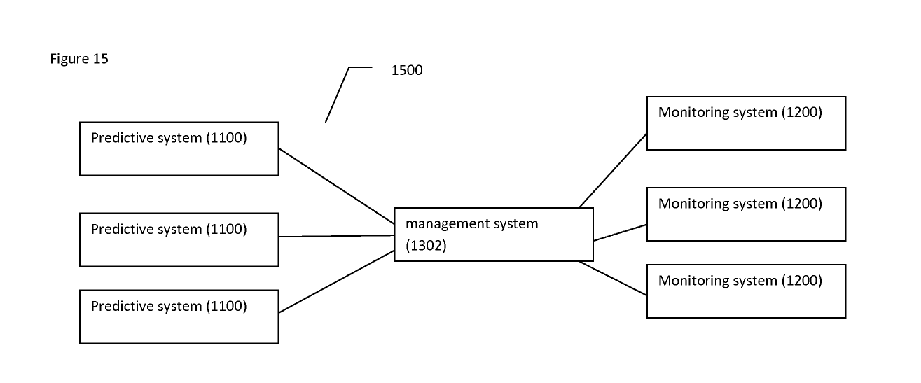

FIG. 13 shows a system 1300, in which predictive system 1100 is provided for a plurality of subjects of the clinical trial. FIG. 14 shows a system 1400, in which monitoring system 1200 is provided for a plurality of subjects of the clinical trial. For both systems 1300 and 1400, preferably a clinical trial management system 1302 is provided, for managing the data obtained through the clinical trial and also optionally and preferably for flagging any problems found during the clinical trial. FIG. 15 shows a combination of the systems of FIGS. 13 and 14.

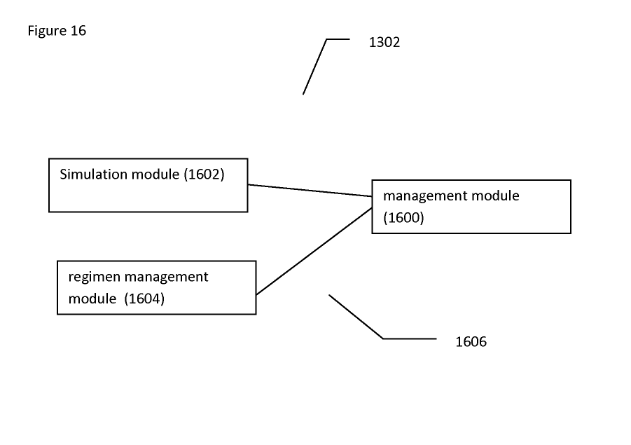

FIG. 16 shows clinical trial management system 1302 in more detail. Clinical trial management system 1302 also preferably features a management module 1600 for analyzing the results from the predictive and/or monitoring system(s) for each subject, for example to detect any potential problems earlier in the trial, to make certain that one or more outcomes are met (including intermediate stage outcomes and the like) and/or to collect all of the overall information from the subjects.

The clinical trial management system 1302 also optionally and preferably features a simulation module 1602 for simulating the PD/PK of one or more drugs; even if the clinical trial is for a medical device, typically the subjects will also be taking one or more drugs and so such a simulation module is potentially useful for all types of clinical trials.

The clinical trial management system 1302 also optionally and preferably features a regimen management module 1604 for optimizing the treatment regimen for the clinical trial, optionally and preferably before the clinical trial starts. The treatment regimen may optionally feature treatment involving one or more drugs and/or medical device effects being tested in the trial, and/or may also optionally relate to one or more drugs and/or medical device effects that are not being tested in the trial but which may optionally be taken by subjects in that trial.

All of these modules are optionally and preferably operated by a clinical trial management computer 1606.

A detailed description of a non-limited embodiment of simulation of cardiac function according to the present invention is provided below; the stages describe follow those of FIG. 8. First, data is collected from a particular patient, for example as described in stages 1 and 2 of FIG. 8 above.

Next, as described, at least one module is constructed. The below relates to a closed mathematical description for the systemic and pulmonary blood circulation on all phases of a cardiac cycle based on fundamental physical conservation laws (fluid dynamics and elasticity) and involving a restricted number of empirically derived formulas.

Such modeling provides an inventive advance over simpler heart models, such as that of WO2007109059, hereby incorporated by reference as if fully set forth herein, which only relates to ejection fraction.

The model assumptions, dynamic parameters and governing equations are completely similar for left atrium (LA), left ventricle (LV), aorta (Ao), systemic (body) vessels (arteries (B1), capillaries (B2) and veins (B3)) and vena cava (Vc), and, respectively, right atrium (RA), right ventricle (RV), pulmonary artery (Pa), virtual pulmonary vessels (arteries (L1), capillaries (L2) and veins (L3)) and pulmonary vein (Pv). Therefore, common terms such as “atrium”, “ventricle”, “artery”, “vein” and so on are used in any descriptions, and the same notations for similar parameters in any similar equations. Next, we use a brief notation “P” for the pericardium. Core model dynamic parameters are described in sect. 2 (using shortened notations). The complete parameter list including full notations is provided in Table 1.

### 1. The Fundamental Assumptions and Simplifications

1.1 For computational simplicity, an atrium, ventricle and pericardium (P) are treated as spherical chambers with elastic walls. (Here and in what follows, the property of “elasticity” also includes the properties of homogeneity and isotropy). Next, we have assumed that he pericardial and myocardial walls touch each other. Arteries and veins are considered as round cylindrical pipes with elastic walls, the flow motion accepted as rotary symmetric (so that the angular flow velocity equals zero), and the terms related to the wave reflection in the wall in any equations are ignored.
1.2. Blood viscosity in relatively broad vessels, like Ao, Pa, Vc and Pv, is neglected, and, therefore, the boundary condition of no-slip on the arterial wall is not considered; therefore we have used the Euler approximation of the Navier-Stokes equation to describe the flow in those vessels. However, the viscosity cannot be ignored in any correct description of the flow in systemic and virtual lung vessels (B1-B3 and L1-L3); therefore we have used the well-known Hagen-Poiseuille formula for a steady-state flow, which describes a solution of the Navier-Stokes system of equations.
1.3. The vessel's wall thickness, h, is assumed to be substantially smaller than the radius R of the cylinder, h=R, therefore, the terms of order o(h/R) in any equations are neglected (the ratio h/R is relatively constant, having a value of approximately 0.14 in the large arteries, 0.25 in the medium-size arteries, and similar, in veins [Kapel'ko 1996]).
1.4. Elastic response of the Vc, Pv, B2, B3, L2 and L3 wall material to the blood pressure (the effective Young modulus) is assumed to be a long-term constant. For Ao and Pa, the similar modulus may change following changes in the applied pressure. For B1 and L1, we have assumed that the similar modulus may change only as a result of cardiac regulation. For atria and ventricles, the similar modulus is assumed to be a sum of a passive and active component. The passive component may change following changes of the blood volume in the chamber, whereas the active one changes during systole of that chamber.
1.5. We have assumed that the vessels are not deformed in the tangential directions.
1.6. The pressure-related deformations of the walls are treated here as quasi-static. Therefore, vibrations of the walls are disregarded, and the corresponding terms are omitted in the elasticity equation. This also allows us to disregard changes in the kinetic energy caused by the vibrations.
1.7. For computational simplicity, the blood density in the atria, ventricles, veins and systemic and virtual lung vessels is accepted as a long-term constant.
1.8. For the same simplicity, at any fixed moment of time the blood pressure is accepted as constant throughout a whole chamber (an atrium or ventricle); therefore, the flow inside the chambers may be disregarded. However, one cannot assume an equality of atrial and ventricular blood pressures even if the (mitral or tricuspid, respectively) valve between them is open; therefore, we compute flows between these chambers. Next, we have not assumed equalities of venous and atrial blood pressures; therefore, we compute flows between them.
1.9. For computational simplicity, at any fixed moment of time the pressure, density, axial velocity of the flow and the pressure wave propagation velocity are accepted as constant throughout any radial cross-sections of Ao or Pa.
1.10. We accept that the elasticity potential energy of atrial and ventricular walls is transformed into the mechanical work of deformation without heat-related dissipations. We consider changes in the blood fluid and vessel or myocardium wall temperature as negligibly small; therefore we disregard changes in internal energies of the fluid elements. We use an empirically derived formula for the active Young modulus component (sect. 1.4) to describe changes in the cell energy properties which are caused by either depolarization or repolarization and result in changes of the elastic response of the myocardial walls.
1.11. The dynamic parameters, such as the mass, momentum and energy corresponding to the blood flow, are accepted to be continuous everywhere including the pressure wave edges in Ao and Pa.
1.12. We accept external vessel walls never be stressed (i.e. always be under zero stress). Next, we accept that the pericardial external walls are being under constant (e.g. zero) stress or, alternatively, under any other determinate stress.
1.13. We agree that the blood pressure does not include a background pressure (which normally is positive and may be individual for a subject).

### 2. The Core Model Dynamic Parameters

2.1. For large vessels (Ao, Pa, Vc, Pv): The effective Young modules, E, lengths, l, radii, R, their deformation-related increments, δ, thicknesses, h, blood pressures, p, densities, ρ, axial flow velocities, u, Young modules of arteries referred to zero pressure E₀, pressure wave propagation velocities in arteries (with respect to a stationary observer), c, the volume flows, Q.
2.2. For virtual systemic and virtual pulmonary vessels (B1, B2, B3 and L1, L2, L3): The effective Young modules, E, lengths, l, radii, R, their deformation-related increments, δ, thicknesses, h, blood pressures, p, densities, ρ, the viscosity-related resistance coefficients, μ, resistances, Res, volume flows, Q.
2.3. For chambers (RA, LA, RV, LV, P): The effective Young modules, E: of atrial, E_{A}, ventricular, E_{V}, and pericardial walls, E_{P}, active, E_{a,A}, E_{a,V}, and passive, E_{p,A}, E_{p,V}, atrial and ventricular Young modules (E=Eₐ+Eₚ); internal and external radii, R₁, R₂: atrial, R_{A,1}, R_{A,2}, ventricular, R_{V,1}, R_{V,2}, and pericardial, R_{P,1}, R_{P,2}; deformation-related increments, δ₁, δ₂: of internal and external atrial, δ_{A,1}, δ_{A,2}, ventricular, δ_{V,1}, δ_{V,2}, and pericardial radii, δ_{P,1}, δ_{P,2}; atrial and ventricular blood density, ρ_{A} (which we accept to be equal to the blood density in veins and systemic and virtual lung vessels); blood pressures, p: atrial, p_{A}, ventricular, p_{V}, and pericardial, p_{P}; flow velocities on mitral (respectively, tricuspid) valve, U_{A}; pressure wave propagation velocities, c_{A}; mitral (or tricuspid) valve radius, Rᵥₐₗᵥₑ.
2.4. The complete parameter list is in Table 1: the parameters of validity for a cardiac cycle (basic, panel A1, and derived, panel A2), the parameters updated every 10⁻² s (panel B), the regulation parameters (constant, panel C1, and derived, of validity for the cycle, panel C2), and the parameters of Heart physiology determining the cycle (panel D).

### 3. The Governing System of Equations

Below in this section, we formulate the governing system of equations with the use of conservation laws and two boundary conditions that are applied to balance the fluid and wall motions (sect. 3.1). The system is introduced in a few steps (3.1-3.10).
3.1. The boundary conditions:
The Boundary Condition #1: The blood pressure on the wall must be equal to the wall stress (by Newton's third law);
The boundary condition #2: A radial component of the flow velocity (in the artery) must be equal to the velocity of the radial wall deformation.
3.2. The elasticity equation for a set as {blood flow in a vessel+the vessel's walls} separately. Following assumptions 1.3-1.6 and 1.13, the stress and strain of vessel walls are linked together by Elasticity equation (Generalized Hooke's law) [Landau et al. 1986], [Timoshenko et al. 1970] as follows:

p=(Eh/R)·(δ/R). (1)

(For simplicity in this equation, Poisson elasticity coefficient of the arterial wall material is accepted as equaling zero; see Appendix for a deduction.) We have to emphasize that the same form of equation (1) is valid for the whole cardiac cycle including any phases of systole or diastole.
3.3. The elasticity equations for a set as {blood flow in a chamber+the chamber's walls} separately. Using assumption 1.6, the generalized Hooke's law [Landau et al. 1986], [Timoshenko et al. 1970] applied to the chamber brings the following linear expressions for the external pressure, p₂, and the deformation-related increment of the external radius, δ₂, via the similar increment of the internal radius, δ₁, and the blood pressure inside the chamber, p:

(δ₂−a₁₁δ₁)E=a₁₂R₁(p−p₀), (2)

a₂₁δ₁E+R₁(a₂₂p+p₂)=0, (3)

where 3a₁₁=2k+k⁻², −3a₁₂=k−k⁻², 3a₂₁=2(1−k⁻³) and −3a₂₂=1+2k⁻³, using k=R₂/R₁ (so that k>1). Particularly for atria or ventricles, p₂=p_{P}+const. (The constant terms, which can be determined directly from the initially input data, may be different for different chambers.) For pericardium, p₂ should be determined in accordance with the assumption from sect. 1.12, and the internal pericardial radius is defined so that its internal volume (considering the increment) equals to the sum of the external myocardial volumes (considering the increments). The compensating term −p₀ (which has the dimension of pressure, or stress, and may be different for different chambers) must be added to equation (2) because of non-homogeneity and anisotropy of the chamber's wall material. (For simplicity in equations (2) and (3), Poisson elasticity coefficient of the wall material is accepted as equaling zero; see Appendix for a deduction.)
In addition to (2) and (3), we have applied the equation of conservation of myocardial volume

(R₂+δ₂)³−(R₁+δ₁)³=const. (4)

(As known from Heart physiology, this conservation law holds in humans with a tolerance of 3%). Usage equation (4) enables one just to apply equation (2) to the determination of p₀.
3.4. The governing equations for a set as {blood flow in an artery (vein)+the arterial (venous) walls} separately. Equation (1), an equation of incompressibility and the boundary conditions 1 and 2 bind the radial flow velocity and u with pressure p and elasticity of the wall material. This allows us to eliminate the radial flow velocity from the final system leading to the well-known Moens equation (7) that binds u with p and elasticity of the wall material [Dinnar 1981], [Fung 1997]. After these eliminations, we obtain the three independent equations for the blood flow in the artery: a hydrodynamic equation of continuity (conservation of mass) (5), the axial component of Euler equation (i.e. conservation of the axial component of momentum without the viscosity term) (6) and the Moens equation (7). The deformation-related radius increment δ can be determined via p and E from equation (1).
Finally, the governing equations comprise the above (1) and, (5)-(8) as below:
The hydrodynamic equation of continuity (the conservation of mass) [Landau et al. 1987]:

$$\frac{\partial }{\partial t} {\int \int \int }_{D} ρ {d}^{3} x = - ρ 〈 {v}^{ρ} , {n}^{ρ} 〉 d S , \qquad ( 5 )$$

where \vec{v} is the flow velocity vector, [symbol] denotes the spatial scalar product, d³x is the related Euclidean spatial volume element, D denotes any fixed compact domain in the vessel with a piecewise smooth boundary ∂D, and \vec{n} is the outward unit normal and dS is the correspondingly oriented area element on ∂D.
The axial component of Euler equation (the conservation of the axial component of momentum without the viscosity term) [Landau et al. 1987]:

$$\frac{\partial }{\partial t} {\int \int \int }_{D} ρ u {d}^{3} x = - [ {pn}_{x} + ρ u 〈 {v}^{ρ} , {n}^{ρ} 〉 ] d S , \qquad ( 6 )$$

where nₓ is the axial component of \vec{n} and the rest of parameters is the same as above.
(Obviously, the radial component of the flow velocity will be cleared from (5) and (6) if the surface ∂D is a part (or the whole) of a radial cross-section. As with any D, the radial component would not appear if we replaced equations (5), (6) with their linear approximations, or—without the linearization—under assumptions 1.1, 1.2 and 1.9. However, with these assumptions and without the linearization, the wave propagation velocity c has to be considered in (5) and (6) [landau et al. 1987, and references therein]).
The Moens equation:

$$\frac{\partial }{\partial t} \int \int p d S = - \frac{Eh}{2 R} \cdot \frac{\partial }{\partial x} \int \int u d S , \qquad ( 7 )$$

where parameters are the same as above, and the integrals are taken over a radial cross-section of the vessel.
The equation of conservation of energy:

E=const (for Ao,Pa,Vc and Pv), (8)

E=E₀e^{αp(1-u/c)} (optionally, for Ao and Pa),

where α is a small constant of the dimension pressure⁻¹ (we have used α=0.017 (mmHg)⁻¹). The first of these equations was previously discussed in [Roytvarf et al. 2008]; the second one follows directly from the assumptions in sect. 1.4.
We have to emphasize that the same form of equations (5)-(8) is valid for the whole cardiac cycle including any phases of systole or diastole. See Appendix for deductions of equations (5), (6) in a relevant special case and equation (7).
3.5. The governing equations for a set as {blood flow in a virtual systemic (virtual pulmonary) vessel+this vessel's walls} separately. These include the above equations (1), (5) and (7)—for any of the considered vessels. Next, the second of (8) is included—for B2, B3 and L2, L3; for B1 and L1, we include either the second of (8), if the cardiac regulation is not considered, or a proper modification of that equation considering the regulation (in accordance with the assumptions in sect. 1.4). Next, equation (6) has to be substituted by
The Hagen-Poiseuille equation [Landau et al. 1987], [Levich 1962]:

$$u = \frac{{( R + δ )}^{2}}{8 μ} \cdot \frac{\partial p}{\partial x} , \qquad ( 9 )$$

which in the terms of the volume flow velocity can be in the first approximation (omitting terms of order smaller than or equal to \dot{δ}) written as

$$\dot{Q} = \frac{{π ( R + δ )}^{4}}{8 μ} \cdot \frac{\partial p}{\partial x}$$

(Q is the volume flow). Particularly to steady-state Poiseuille flows, we have “the Ohm law”

$$\dot{Q} = \frac{Δ p}{Res} ,$$

using the resistance

$$Res = \frac{8 μ l}{{π ( R + δ )}^{4}}$$

(Δp is the difference between blood pressures at the endpoints of the vessel, and l is the length of that vessel).
3.6. The governing equations for a set as {blood flow in an atrium (ventricle)+the atrial (ventricular) walls} separately. These include equations (2)-(3) and,
The equation of conservation of energy:

E=Eₐ+Eₚ. (10)

In equation (10), the passive and active components of the effective Young modulus should be determined by empirically derived formulas

Eₚ=Eₚ₀+Aₚe^{C}^{_{δ}}^{(1+δ}^{₁}^{/R}^{₁}⁾^{³}^{-C}^{ₕ}^{(R}^{₂}^{+δ}^{₂}^{-R}^{₁}^{-δ}^{₁}^{)-C}^{ₚ}^{p} (11)

using constant parameters Eₚ₀, Aₚ, C_{δ}; Cₕ and Cₚ (which may be different for different chambers, vary between cardiac cycles but should be the same within a cardiac cycle), and

$${E}_{a} = {E}_{a 0} \pm {A}_{a} {e}^{- {C}_{a} / {\vert t - {t}_{a} \vert}^{{n}_{a}}} \qquad ( 12 )$$

using constant parameters Eₐ₀, Aₐ, Cₐ and tₐ which also may be different for different chambers, and are different for the contraction and relaxation of the same chamber within a cardiac cycle; t denotes time. (Refer sect. 4.2 below for a complete formula for Eₐ.)
3.7. The governing equations binding the ventricular and arterial flows and wall elasticity during rapid or reduced ejection. These comprise above equations (1)-(8) and (10)-(12) and equations (13)-(15) below expressing conservation and Hooke's laws:
Conservation of mass: the instantaneous changes in the masses of blood in the ventricle and artery are summed up to zero. With setting the origin of the arterial axis on the valve and taking into account incompressibility of the fluid and assumptions 1.1 and 1.11, it may be written in the terms of zero instantaneous summarized volume changes:

d(V_{V,1}+Q)/dt=0

(“V” is an abbreviation for “LV” or “RV”), where Q is the volume flow from the ventricle to the artery, which, with using expressions

$$d {V}_{V , 1} = d [ \frac{4 π}{3} {( {R}_{V , 1} + {δ}_{V , 1} )}^{3} ] ,$$

dQ=π(R+δ)²dx for the differentials (in accordance with assumption 1.1), will take the form as

4[R_{V,1}+δ_{V,1}(t)]²\dot{δ}_{V,1}=−[R+δ(t,0)]²\dot{x}(t,0), (13)

where the dot denotes the full derivative with respect to time (t is counted while the valve between the ventricle and artery is open), and \dot{x}(t, 0) is the flow velocity on the valve, on the side of the ventricle (which will be different from the velocity u(t,0) on the side of the artery with using the shock wave formalism for the pressure wave description.)
Conservation of momentum: with taking into account assumptions 1.1, 1.2, 1.8 and 1.11 it may be written as follows:

ρ(t,0)·[\dot{x}(t,0)−u(t,0)]·[c(t,0)−u(t,0)]=p_{V}(t)−p(t,0) (14)

(t is counted while the valve is open). See Appendix for a deduction of (14).
The Moens-type equation:

$${p}_{v} ( t ) - p ( t , 0 ) = \frac{Eh}{2 R} \cdot \frac{\dot{x} ( t , 0 ) - u ( t , 0 )}{c ( t , 0 )} \qquad ( 15 )$$

(which was previously discussed in [Roytvarf et al. 2008] and can be derived using the similar arguments as in [Landau et al. 1987]).
Remark. Equations (13)-(15) can be sharpened if we multiply \dot{x}(t,0), the right-hand side of (13) and all terms with indices “V” in (14) and (15) by

$$Z ( t ) = {[ \frac{R + {δ}_{0} ( t )}{R + δ ( t , 0 )} ]}^{2} = {[ \frac{1 + {p}_{V} ( t ) / ( Eh / R )}{1 + p ( t , 0 ) / ( Eh / R )} ]}^{2} ,$$

and substitute in (12) δ(.,0) by δ₀=R²·p_{V}/(Eh) (in accordance with (1)). However, as we have found from our preliminary studies, using Z≡1 can cause at most 8% error in the final result.
3.8. The governing equations binding the Pa→L1→L2→L3→Pv and Ao→B1→B2→B3→Vc flows and wall elasticity. These comprise above equations (1), (5)-(9) (using the corresponding equations for any vessels, as described in sect. 3.4 and 3.5), and equations (16)-(18) as below expressing “the Ohm law” for the volume flows, respectively, between the artery and systemic (or virtual lung) vessels, between two such vessels and, between such the vessel and vein (here, we present these equations for the first of two chains, but they are completely similar for the second one):

$$\begin{matrix}{\dot{Q}}_{Pa , L 1} = \frac{{p}_{Pa} - {p}_{L 1}}{{Res}_{L 1}} , & ( 16 ) \\ {\dot{Q}}_{L 1 , L 2} = \frac{{p}_{L 1} - {p}_{L 2}}{Harmonic mean of {Res}_{L 1} , {Res}_{L 2}} , \\ {\dot{Q}}_{L 2 , L 3} = \frac{{p}_{L 2} - {p}_{L 3}}{Harmonic mean of {Res}_{L 2} , {Res}_{L 3}} , & ( 17 ) \\ {\dot{Q}}_{L 3 , Pv} = \frac{{p}_{L 3} - {p}_{Pv}}{{Res}_{L 3}} . & ( 18 )\end{matrix}$$

See Appendix for a deduction of (17).
(The harmonic mean of two values a and b equals to 2/(a⁻¹+b⁻¹)).
3.9. The governing equations binding the venous-atrial flows and wall elasticity while the (mitral, or, respectively, tricuspid) valve is closed. These comprise above equations (1)-(8) and (10)-(12), and equations (19)-(20) as below:
The equation of conservation of mass,

d(V_{A,1}+V)/dt=\dot{Q}

(“A” is an abbreviation for “LA” or “RA”), using either Q_{L3,Pv} or, respectively, Q_{B3,Vc} for Q, which, with taking into account the expressions

$$d {V}_{A , 1} = d [ \frac{4 π}{3} {( {R}_{A , 1} + {δ}_{A , 1} )}^{3} ] ,$$

dV=d[π(R+δ)²l] for the above differentials (in accordance with assumption 1.1), will take the form as

4[R_{A,1}+δ_{A,1}(t)]²\dot{δ}_{A,1}+2[R+δ(t)]l\dot{δ}=\dot{Q}/π, (19)

similar to (13), and
The equation of conservation of momentum,

p=p_{A} (20)

(i.e. the venous and atrial pressures are equated to each other). While applying this equation, in fact one considers the vein and atrium as parts of the same reservoir so that the flow velocity on the vein-and-atrium junction nearly equals zero: u(t,0)=0 (with setting the origin of the venous axis on that junction). Alternatively, (20) can be substituted by an Euler-type, or a different equation, counting the above flow more accurately, as e.g., the commonly used classic Bernoulli equation for a steady-state Euler flow [Landau et al. 1987]:

p=p_{A}+ρ·u(t,0)²/2. (20′)

One is able to substitute (20) by an equation considering pressure waves, and etc. But however, as we have found from our preliminary studies, with the above substitutions one is able to increase the final computational accuracy at most by 5%.
3.10. The governing equations binding the venous-atrial and ventricular flows and wall elasticity on rapid or reduced ventricular filling. These comprise the above equations (1)-(8), (10)-(12) (repeated for any involved chambers or vessels, respectively) and (20) (or its alternative versions, as discussed in sect. 3.9) and equations (21) and (22) as below:
The equation of conservation of mass,

d(V_{V,1}+V_{A,1}+V)/dt=\dot{Q}

(using either Q_{L3,Pv} or, respectively, Q_{B3,Vc} for Q) which, with taking into account the expressions

$$d {V}_{V , 1} = d [ \frac{4 π}{3} {( {R}_{V , 1} + {δ}_{V , 1} )}^{3} ] , d {V}_{A , 1} = d [ \frac{4 π}{3} {( {R}_{A , 1} + {δ}_{A , 1} )}^{3} ] ,$$

dV=d[π(R+δ)²l] for the above differentials (in accordance with assumption 1.1), can be written in the form as

4[R_{A,1}+δ_{A,1}(t)]²\dot{δ}_{A,1}+4[R_{A,1}+δ_{A,1}(t)]²\dot{δ}_{A,1}+2[R+δ(t)]l\dot{δ}=\dot{Q}/π, (21)

similar to (13) and (19), and
The equation of conservation of momentum, which takes into account a rarefaction pressure wave in the atrium rose by the ventricular relaxation, and is analogous to equation (14):

$${p}_{A} - {p}_{V} = {ρ}_{A} {c}_{A} {U}_{A} = 4 {ρ}_{A} {{c}_{A} ( \frac{{R}_{V , 1} + {δ}_{V , 1}}{{R}_{valve}} )}^{2} {\dot{δ}}_{V , 1} , \qquad ( 22 )$$

where the pressure wave propagation velocity can be determined by the formula

$${c}_{A} = \sqrt{- \frac{{R}_{A , 1} \cdot \{ \frac{\partial {p}_{p}}{\partial {δ}_{A , 1}} + {a}_{21 , A} \cdot [ {E}_{A} + {δ}_{A , 1} ( \frac{\partial {E}_{p , A}}{\partial {δ}_{A , 1}} + \frac{\partial {E}_{p , A}}{\partial {δ}_{A , 2}} \cdot \frac{d {δ}_{A , 2}}{d {δ}_{A , 1}} ) ] \}}{2 {ρ}_{A} ( {a}_{22 , A} {R}_{A , 1} - {a}_{22 , A} {δ}_{A , 1} \cdot \frac{\partial {E}_{p , A}}{\partial {p}_{A}} )}} ; \qquad ( 23 )$$

one has to put to that formula

$$\frac{\partial {p}_{P}}{\partial {δ}_{A , 1}} = \frac{d {p}_{P}}{d {δ}_{P , 1}} \cdot \frac{\partial {δ}_{P , 1}}{\partial {δ}_{A , 2}} \cdot \frac{d {δ}_{A , 2}}{d {δ}_{A , 1}} ,$$

where

$$\frac{d {δ}_{A , 2}}{d {δ}_{A , 1}} = {( \frac{{R}_{A , 1} + {δ}_{A , 1}}{{R}_{A , 2} + {δ}_{A , 2}} )}^{2}$$

(in accordance with equation (4)),

$$\frac{\partial {δ}_{P , 1}}{\partial {δ}_{A , 2}} = {\{ \frac{{R}_{A , 2} + {δ}_{A , 2}}{{[ \begin{matrix}{( {R}_{RA , 2} + {δ}_{RA , 2} )}^{3} + {( {R}_{LA , 2} + {δ}_{LA , 2} )}^{3} + \\ {( {R}_{RV , 2} + {δ}_{RV , 2} )}^{3} + {( {R}_{LV , 2} + {δ}_{LV , 2} )}^{3}\end{matrix} ]}^{1 / 3}} \}}^{2}$$

(because of the equality R[R_{P,1}+δ_{P,1}]³=[R_{RA,2}+δ_{RA,2}]³+[R_{LA,2}+δ_{LA,2}]³+[R_{RV,2}+δ_{RV,2}]³+[R_{LV,2}+δ_{LV,2}]³ that holds by assumption 1.1),

$$\frac{d {p}_{P}}{d {δ}_{P , 1}} = - \frac{{a}_{21 , P} \cdot {E}_{P}}{{a}_{22 , P} \cdot {R}_{P , 1}}$$

(in accordance with equation (3)), and

$$\{ \frac{\partial {E}_{p}}{\partial {δ}_{1}} , \frac{\partial {E}_{p}}{\partial {δ}_{2}} , \frac{\partial {E}_{p}}{\partial p} \} = {A}_{p} {e}^{{ }_{{{C}_{δ} ( 1 + {δ}_{1} / {R}_{1} )}^{3} - {C}_{h} ( {R}_{2} + {δ}_{2} - {R}_{1} - {δ}_{1} ) - {C}_{p} p}} \cdot \{ \frac{3 {C}_{δ}}{{R}_{1}} {( 1 + {δ}_{1} / {R}_{1} )}^{2} + {C}_{h} , - {C}_{h} , - {C}_{p} \}$$

(immediately following from (11)). See Appendix for a deduction of (23).
3.11. The governing equations binding the venous-atrial and ventricular flows and wall elasticity on atrial systole. These comprise the above equations (1)-(8), (10)-(12) (repeated for any involved chambers or vessels, respectively), (20) (or its alternative versions, as discussed in sect. 3.9) and (21), and the following equation (24), for substitution of (22):
The equation of conservation of momentum:

$$\frac{4 ( {R}_{V , 1} + {δ}_{V , 1} )}{{R}_{valve}^{2}} \cdot [ 2 {\dot{δ}}_{V , 1}^{2} + ( {R}_{V , 1} + {δ}_{V , 1} ) {\ddot{δ}}_{V , 1} ] = \frac{{p}_{A} - {p}_{V}}{{ρ}_{A} \cdot ( {R}_{A , 1} + {δ}_{A , 1} + {R}_{V , 1} + {δ}_{V , 1} )} . \qquad ( 24 )$$

See Appendix for a deduction of (24).

### 4. The Solution of the Governing System of Equations

4.1. Cardiac cycle: timing and phases. According to Heart physiology we distinguish among the following phases of a cardiac cycle:
1) Isovolumic (or isometric) ventricular contraction,
2-3) (Rapid and reduced) ejection,
4) Isovolumic (or isometric) ventricular relaxation,
5-6) (Rapid and reduced) ventricular filling,
7) Atrial systole.
Atrial systole is substituted by isovolumic contraction when the (mitral or tricuspid) valve closes which in our model is defined as exceeding the atrial pressure by ventricular. The ejection starts and finishes when the arterial valve opens and closes which in our model is defined as crossings of the ventricular and arterial pressure curves. Isovolumic relaxation is substituted by filling with opening the (mitral or tricuspid) valve which in our model is defined as exceeding the ventricular pressure by atrial. Finally, atrial systole starts with depolarization of atrial cells resulting in changes of the elastic response of the atrial walls, which in our model is determined by parameters of Table 1 (D).
We also model a real-life phenomenon of blood circulation system consisting of existence of definite shifts between the first or last moments of similar phases for the right and left heart. Values of the shifts initially are input and then can be regulated between cardiac cycles.
4.2. The timing and complete model formulas for active Young modules. We use some fixed timing of a cardiac cycle, as e.g. an equally spaced one, tᵢ=i·10⁻² s i=0, 1, . . . . We consider the active modules of any chambers as functions of the timing. For ventricles that function has a form

$${E}_{a} = \{ \begin{matrix}{E}_{a 2} if t = {t}_{es} , & otherwise \\ \begin{matrix}{E}_{a 2} - {A}_{1} {e}^{- {C}_{1} / {( {t}_{es} - t )}^{{n}_{1}}} \\ using {C}_{1} = \frac{{( {t}_{es} - {t}_{ed} )}^{{n}_{1} + 1} {D}_{1}}{{n}_{1} ( {E}_{a 2} - {E}_{a 0} )} ,\end{matrix} & \begin{matrix}{A}_{1} = ( {E}_{a 2} - {E}_{a 0} ) {e}^{{C}_{1} / {( {t}_{es} - {t}_{ed} )}^{{n}_{1}} } \\ on phases 1 - 3 ,\end{matrix} \\ {E}_{a 4} if t = {t}_{ed\_new} , & otherwise \\ \begin{matrix}{E}_{a 4} + {A}_{2} {e}^{- {C}_{2} / {( {t}_{ed\_new} - t )}^{{n}_{2}}} \\ using {C}_{2} = \frac{{( {t}_{ed\_new} - {t}_{es} )}^{{n}_{2} + 1} {D}_{2}}{{n}_{2} ( {E}_{a 4} - {E}_{a 2} )} ,\end{matrix} & \begin{matrix}{A}_{2} = ( {E}_{a 2} - {E}_{a 4} ) {e}^{{C}_{2} / {( {t}_{ed\_new} - {t}_{es} )}^{{n}_{2}} } \\ on phases 4 - 7 ,\end{matrix}\end{matrix}$$

where parameters E_{( . . . )}, D_{( . . . )} and n_{( . . . )} and the moments t_{ed}, tₑₛ and t_{ed}_{_{—}}_{new} (valid for a cardiac cycle) correspond to the ends of diastole, ejection and the next diastole, respectively. For atria we use the function

$${E}_{a} = \{ \begin{matrix}{E}_{a 0} if t = {t}_{ed} , & otherwise \\ \begin{matrix}{E}_{a 0} + {A}_{2} {e}^{- {C}_{2} / {( {t}_{ed} - t )}^{{n}_{2}}} \\ using {C}_{2} = \frac{{( {t}_{ed} - {t}_{es} )}^{{n}_{2} + 1} {D}_{2}}{{n}_{2} ( {E}_{a 0} - {E}_{a 2} )} , \\ const\end{matrix} & \begin{matrix}{A}_{2} = ( {E}_{a 2} - {E}_{a 0} ) {e}^{{C}_{2} / {( {t}_{ed} - {t}_{es} )}^{{n}_{2}} } \\ on phases 1 - 4 , \\ on phases 5 - 6 ,\end{matrix} \\ {E}_{a 4} if t = {t}_{es\_new} , & otherwise \\ \begin{matrix}{E}_{a 4} - {A}_{1} {e}^{- {C}_{1} / {( {t}_{es\_new} - t )}^{{n}_{1}}} \\ using {C}_{1} = \frac{{( {t}_{es\_new} - {t}_{ed\_new} )}^{{n}_{1} + 1} {D}_{1}}{{n}_{1} ( {E}_{a 4} - {E}_{a 0} )} ,\end{matrix} & \begin{matrix}{A}_{1} = ( {E}_{a 4} - {E}_{a 0} ) {e}^{{C}_{1} / {( {t}_{es\_new} - {t}_{ed\_new} )}^{{n}_{1}} } \\ on phase 7\end{matrix}\end{matrix}$$

where parameters E_{( . . . )}, D_{( . . . )} and n_{( . . . )} and the moments tₑₛ, t_{ed}, t_{ed}_{_{—}}_{new} and tₑₛ_{_{—}}_{new} (valid for a cardiac cycle) correspond to the end of systole, start of filling and start and end of the next systole.
4.2. We use a step-by step solution of the governing system of equations. The initial values of the parameters from Table 1 (B) correspond to the moment t₀ of the first cycle. The values obtained for the last moment of the former cycle are transferred to the moment t₀ of the latter one. For a moment tᵢ with i>0 model parameters are updated referring to parameter values obtained for tᵢ₋₁ and sometimes for tᵢ₋₂, but not for earlier steps. For the first cycle and i=1, the values for t₀ are used also as “the values for t₋₁”. As for the other cycles, the values that are used for “the values for t₋₁” in fact correspond to the last but one moment of the former cycle.
4.3. The solutions for the Pa→L1→L2→L3→Pv and Ao→B1→B2→B3→Vc flows and wall elasticity. These can be obtained in completely similar ways for both chains, and below we make a detailed description only for one of them, e.g. the first one.
1) We calculate the volume flow velocity between Pa and L1 from (16):

\dot{Q}_{Pa,L1}(i)=[p_{Pa}(i−1)−p_{L1}(i−1)]/Res_{L1}(i−1).

2) We calculate the deformation-related increment of, and the pressure in, L1 using conservation of mass of an incompressible fluid and equation (1):

$${δ}_{L 1} ( i ) = \sqrt{{[ {R}_{L 1} + {δ}_{L 1} ( i - 1 ) ]}^{2} + {\dot{Q}}_{Pa , L 1} ( i ) dt / ( π {l}_{L 1} )} - {R}_{L 1} , \\ {p}_{L 1} ( i ) = {E}_{L 1} {h}_{L 1} {δ}_{L 1} ( i ) / {R}_{L 1}^{2} .$$

(Here and in what follows, dt=tᵢ−tᵢ₋₁).
3) We calculate the resistance of L1:

$${Res}_{L 1} ( i ) = {Res}_{L 1} ( i - 1 ) \cdot {[ \frac{{R}_{L 1} + {δ}_{L 1} ( i - 1 )}{{R}_{L 1} + {δ}_{L 1} ( i )} ]}^{4} .$$

4) We calculate the volume flow velocity between L1 and L2 from (17):

\dot{Q}_{L1,L2}(i)=[p_{L1}(i)−p_{L2}(i−1)]/[harmonic mean of Res_{L1}(i) and Res_{L2}(i−1)].

5) We calculate the deformation-related increment of, and the pressure in, L2 using conservation of mass of an incompressible fluid and equation (1):

$${δ}_{L 2} ( i ) = \sqrt{{[ {R}_{L 2} + {δ}_{L 2} ( i - 1 ) ]}^{2} + {\dot{Q}}_{L 1 , L 2} ( i ) dt / ( π {l}_{L 2} )} - {R}_{L 2} , \\ {p}_{L 2} ( i ) = {E}_{L 2} {h}_{L 2} {δ}_{L 2} ( i ) / {R}_{L 2}^{2} .$$

6) We calculate the resistance of L2:

$${Res}_{L 2} ( i ) = {Res}_{L 2} ( i - 1 ) \cdot {[ \frac{{R}_{L 2} + {δ}_{L 2} ( i - 1 )}{{R}_{L 2} + {δ}_{L 2} ( i )} ]}^{4} .$$

7) We recalculate the deformation-related increment and resistance of, and the pressure in, L1:

$${δ}_{L 1}^{final} ( i ) = \sqrt{{[ {R}_{L 1} + {δ}_{L 1} ( i ) ]}^{2} + {\dot{Q}}_{L 1 , L 2} ( i ) dt / ( π {l}_{L 1} )} - {R}_{L 1} , \\ {p}_{L 1}^{final} ( i ) = {E}_{L 1} {h}_{L 1} {δ}_{L 1}^{final} ( i ) / {R}_{L 1}^{2} . \\ {Res}_{L 1}^{final} ( i ) = {Res}_{L 1} ( i ) \cdot {[ \frac{{R}_{L 1} + {δ}_{L 1} ( i )}{{R}_{L 1} + {δ}_{L 1}^{final} ( i )} ]}^{4} .$$

8)-11) By proceeding completely similar to as in 4)-7) we calculate the volume flow velocity between L2 and L3, the deformation-related increment and resistance of, the pressure in, L3 and recalculate the similar parameters for L2.
12) We calculate the volume flow velocity between L3 and Pv:

\dot{Q}_{L3,Pv}(i)=[p_{L3}(i)−p_{Pv}(i−1)]/Res_{L3}(i).

13) We recalculate the deformation-related increment and resistance of, and the pressure in, L3:

$${δ}_{L 3}^{final} ( i ) = \sqrt{{[ {R}_{L 3} + {δ}_{L 3} ( i ) ]}^{2} - {\dot{Q}}_{L 3 , Pv} ( i ) dt / ( π {l}_{L 3} )} - {R}_{L 3} , \\ {p}_{L 3}^{final} ( i ) = {E}_{L 3} {h}_{L 3} {δ}_{L 3}^{final} ( i ) / {R}_{L 3}^{2} . \\ {Res}_{L 3}^{final} ( i ) = {Res}_{L 3} ( i ) \cdot {[ \frac{{R}_{L 3} + {δ}_{L 3} ( i )}{{R}_{L 3} + {δ}_{L 3}^{final} ( i )} ]}^{4} .$$

4.4. The exact solution can be obtained considering all of the chambers simultaneously; the unique exclusion can be made for the ventricles on their isovolumic phases (as explained in sect. 4.5 below). This is because for any chambers equations (3) comprise the pericardial pressure p_{P}. Therefore, the solution can be obtained by the following algorithm. At first, we are able to find approximate solution for the separate chambers by solving the linearized governing equations that contain p_{P}(i−1) and not p_{P}(i). The second step consists of sharpening: with considering the above approximate solution as a zero approximation, we find the exact solution of the source nonlinear governing system (involving all the chambers) by the commonly used classic Newton's iteration method (of tangents), which shows super-convergence. (In this connection, refer e.g. [Berezin et al. 1965], [Press et al. 1992], and multiple references therein; also see Appendix for a brief explanation of the method.)
4.5. The solution for the ventricular isovolumic contraction and relaxation. On these phases we have δ_{V,1}=const and δ_{V,2}=const so that the ventricle does not affect the pericardial pressure, which allows an independent determination of p_{P}. Let, for simplicity, Eₚ does not depend on pressure (i.e. Cₚ=0) so that Eₚ=const. Therefore, we are able to determine E_{V}(i) directly by formula (10) and then to calculate the ventricular pressure from equation (3):

$${p}_{V} ( i ) = - \frac{1}{{a}_{22 , V}} [ \frac{{a}_{21 , V} {δ}_{V , 1} ( i ) {E}_{V} ( i )}{{R}_{V , 1}} + {p}_{P} ( i ) ] + const . \qquad ( 25 )$$

If however Cₚ≠0, E_{V} will be a (determinate!) function of p_{V} so that (25) provides us with a (nonlinear) equation for p_{V}(i).
Next, obviously, on this phase there is zero entrance flow in the artery (e.g. Pa) so that we calculate the deformation-related increment of, and the pressure in, the artery as follows:

$${δ}_{Pa} ( i ) = \sqrt{{[ {R}_{Pa} + {δ}_{Pa} ( i - 1 ) ]}^{2} + {\dot{Q}}_{Pa , L 1} ( i ) dt / ( π {l}_{Pa} )} - {R}_{Pa} , \\ {p}_{Pa} ( i ) = {E}_{Pa} ( i - 1 ) {h}_{Pa} {δ}_{Pa} ( i ) / {R}_{Pa}^{2} .$$

Then we calculate the arterial effective Young modulus, blood density and pressure wave propagation velocity by the following formulas:

$$E ( i ) = E ( i - 1 ) , \\ ρ ( i ) = ρ ( i - 1 ) \cdot \frac{c ( i - 1 ) - u ( i - 1 )}{c ( i - 1 ) - u ( i )} , \\ c ( i ) = \frac{u ( i ) + \sqrt{{u}^{2} ( i ) + \frac{2 Eh}{R ρ ( i )}}}{2} . \qquad ( 26 )$$

To derive the above formulas, we used equation (8), the Rankine-Hugoniot-type relation (A8) corresponding to integro-differential equation (5) (see Appendix) and the formula for c that can be deduced by completely similar arguments as used for (A10); and, as said above, on the isovolumic phases we put to (26) u(i)=0.
4.6. The solution for the ventricular and arterial flows and wall elasticity during rapid or reduced ejection. We will describe it only for RV→Pa since for LV→Ao it looks completely similar. The linearized system (sect. 4.4) with respect to unknowns p_{RV}(i) and δ_{RV,1}(i) can be written in the following form:

$$\{ \begin{matrix}{p}_{RV} ( i ) - {p}_{Pa} ( i - 1 ) = - \begin{matrix}\frac{2 {E}_{Pa} ( i - 1 ) {h}_{Pa}}{{R}_{Pa} {c}_{Pa} ( i - 1 ) dt} \cdot {[ \frac{{R}_{RV , 1} + {δ}_{RV , 1} ( i - 1 )}{{R}_{Pa} + {δ}_{Pa} ( i - 1 )} ]}^{2} \\ [ {δ}_{RV , 1} ( i ) - {δ}_{RV , 1} ( i - 1 ) ] ,\end{matrix} \\ \begin{matrix}\begin{matrix}\begin{matrix}\begin{matrix}[ {R}_{RV , 1} {a}_{22 , RV} + {a}_{21 , RV} {δ}_{RV , 1} ( i - 1 ) \cdot \frac{\partial {E}_{p , RV}}{\partial {p}_{RV}} ( i - 1 ) ] \\ [ {p}_{RV} ( i ) - {p}_{RV} ( i - 1 ) ] +\end{matrix} \\ \{ {a}_{21 , RV} [ \begin{matrix}{E}_{RV} ( i - 1 ) + {δ}_{RV , 1} ( i - 1 ) \cdot \\ \frac{\partial {E}_{p , RV}}{\partial {p}_{RV}} ( i - 1 )\end{matrix} ] + \begin{matrix}{R}_{RV , 1} \cdot \frac{\partial {p}_{P}}{\partial {δ}_{RV , 2}} ( i - 1 ) \cdot \\ \frac{d {δ}_{RV , 2}}{d {δ}_{RV , 1}} ( i - 1 )\end{matrix} \}\end{matrix} \\ [ {δ}_{RV , 1} ( i ) - {δ}_{RV , 1} ( i - 1 ) ] + {a}_{21 , RV} {δ}_{RV , 1} ( i - 1 )\end{matrix} \\ [ {E}_{a , RV} ( i ) - {E}_{a , RV} ( i - 1 ) ] = 0 ,\end{matrix}\end{matrix}$$

where the partial derivatives can be computed as described in sect. 3.10, and E_{a,RV}(i) was obtained, as discussed in sect. 4.2. After having solved the above system, found E_{p,RV}(i) and E_{RV}(i) (by formulas (11) and (10)) and accomplished the calculation procedure involving the Newton's method to obtain the exact solution for all chambers together (sect. 4.4) we set,

$${\dot{Q}}_{RV , Pa} dt = - \frac{4 π}{3} \{ {[ {R}_{RV , 1} + {δ}_{RV , 1} ( i ) ]}^{3} - {[ {R}_{RV , 1} + {δ}_{RV , 1} ( i - 1 ) ]}^{3} \} , \\ {u}_{P a} ( i ) = \frac{{\dot{Q}}_{RV , Pa}}{{π [ {R}_{Pa} + {δ}_{Pa} ( i - 1 ) ]}^{2}} .$$

Then we find,

$${δ}_{Pa} ( i ) = \sqrt{\begin{matrix}{[ {R}_{Pa} + {δ}_{Pa} ( i - 1 ) ]}^{2} + \\ [ {\dot{Q}}_{RV , Pa} ( i ) - {\dot{Q}}_{Pa , L 1} ( i ) ] dt / ( π {l}_{Pa} )\end{matrix}} - {R}_{Pa} , \\ {p}_{Pa} ( i ) = {E}_{Pa} ( i - 1 ) {h}_{Pa} {δ}_{Pa} ( i ) / {R}_{Pa}^{2} ,$$

and fulfill the calculations as in (26).
4.7. The solution for the venous-atrial flows and wall elasticity. The linearized system (sect. 4.4) with respect to unknowns p_{A}(i), δ_{A,1}(i), p(i) and δ(i) can be written in the following form:

$$\{ \begin{matrix}\begin{matrix}{4 [ {R}_{A , 1} + {δ}_{A , 1} ( i - 1 ) ]}^{2} [ {δ}_{A , 1} ( i ) - {δ}_{A , 1} ( i - 1 ) ] + \\ 2 l [ R + δ ( i - 1 ) ] [ δ ( i ) - δ ( i - 1 ) ] = \dot{Q} ( i ) dt / π ,\end{matrix} \\ \begin{matrix}\begin{matrix}\begin{matrix}\begin{matrix}[ {R}_{A , 1} {a}_{22 , A} + {a}_{21 , A} {δ}_{A , 1} ( i - 1 ) \cdot \frac{\partial {E}_{p , A}}{\partial {p}_{A}} ( i - 1 ) ] \\ [ {p}_{A} ( i ) - {p}_{A} ( i - 1 ) ] +\end{matrix} \\ \{ {a}_{21 , A} [ \begin{matrix}{E}_{A} ( i - 1 ) + {δ}_{A , 1} ( i - 1 ) \\ ( \begin{matrix}\frac{\partial {E}_{p , A}}{\partial {δ}_{A , 1}} ( i - 1 ) + \\ \frac{\partial {E}_{p , A}}{\partial {δ}_{A , 2}} ( i - 1 ) \cdot \\ \frac{d {δ}_{A , 2}}{d {δ}_{A , 1}} ( i - 1 )\end{matrix} )\end{matrix} ] + \begin{matrix}{R}_{A , 1} \cdot \frac{\partial {p}_{P}}{\partial {δ}_{A , 2}} ( i - 1 ) \cdot \\ \frac{d {δ}_{A , 2}}{d {δ}_{A , 1}} ( i - 1 )\end{matrix} \}\end{matrix} \\ [ {δ}_{A , 1} ( i ) - {δ}_{A , 1} ( i - 1 ) ] + {a}_{21 , A} {δ}_{A , 1} ( i - 1 )\end{matrix} \\ [ {E}_{a , A} ( i ) - {E}_{a , A} ( i - 1 ) ] = 0 ,\end{matrix} \\ p ( i ) = Eh δ ( i ) / {R}^{2} , \\ p ( i ) = {p}_{A} ( i ) ,\end{matrix}$$

where E_{a,A}(i) was obtained, as discussed in sect. 4.2. Having solved the above system we find E_{p,A}(i) and E_{A}(i) (by formulas (11) and (10)) and then accomplish the calculation procedure involving the Newton's method to obtain the exact solution for all chambers together (sect. 4.4).
4.8. The solution for the venous-atrial and ventricular flows and wall elasticity on rapid or reduced ventricular filling. The linearized system (sect. 4.4) with respect to unknowns p_{A}(i), δ_{A,1}(i), p_{V}(i), δ_{V,1}(i), p(i) and δ(i) can be written in the following form:

$$\{ \begin{matrix}\begin{matrix}{4 [ {R}_{A , 1} + {δ}_{A , 1} ( i - 1 ) ]}^{2} [ {δ}_{A , 1} ( i ) - {δ}_{A , 1} ( i - 1 ) ] + \\ {4 [ {R}_{V , 1} + {δ}_{V , 1} ( i - 1 ) ]}^{2} [ {δ}_{V , 1} ( i ) - {δ}_{V , 1} ( i - 1 ) ] + \\ 2 l [ R + δ ( i - 1 ) ] [ δ ( i ) - δ ( i - 1 ) ] = \dot{Q} ( i ) dt / π ,\end{matrix} \\ \begin{matrix}\begin{matrix}\begin{matrix}\begin{matrix}[ {R}_{A , 1} {a}_{22 , A} + {a}_{21 , A} {δ}_{A , 1} ( i - 1 ) \cdot \frac{\partial {E}_{p , A}}{\partial {p}_{A}} ( i - 1 ) ] \\ [ {p}_{A} ( i ) - {p}_{A} ( i - 1 ) ] +\end{matrix} \\ \{ {a}_{21 , A} [ \begin{matrix}{E}_{A} ( i - 1 ) + {δ}_{A , 1} ( i - 1 ) \\ ( \begin{matrix}\frac{\partial {E}_{p , A}}{\partial {δ}_{A , 1}} ( i - 1 ) + \\ \frac{\partial {E}_{p , A}}{\partial {δ}_{A , 2}} ( i - 1 ) \cdot \\ \frac{d {δ}_{A , 2}}{d {δ}_{A , 1}} ( i - 1 )\end{matrix} )\end{matrix} ] + \begin{matrix}{R}_{A , 1} \cdot \frac{\partial {p}_{P}}{\partial {δ}_{A , 2}} ( i - 1 ) \cdot \\ \frac{d {δ}_{A , 2}}{d {δ}_{A , 1}} ( i - 1 )\end{matrix} \}\end{matrix} \\ [ {δ}_{A , 1} ( i ) - {δ}_{A , 1} ( i - 1 ) ] + {a}_{21 , A} {δ}_{A , 1} ( i - 1 )\end{matrix} \\ [ {E}_{a , A} ( i ) - {E}_{a , A} ( i - 1 ) ] = 0 ,\end{matrix} \\ \begin{matrix}\begin{matrix}\begin{matrix}\begin{matrix}[ {R}_{V , 1} {a}_{22 , V} + {a}_{21 , V} {δ}_{V , 1} ( i - 1 ) \cdot \frac{\partial {E}_{p , V}}{\partial {p}_{V}} ( i - 1 ) ] \\ [ {p}_{V} ( i ) - {p}_{V} ( i - 1 ) ] +\end{matrix} \\ \{ {a}_{21 , R} [ \begin{matrix}{E}_{V} ( i - 1 ) + {δ}_{V , 1} ( i - 1 ) \\ ( \begin{matrix}\frac{\partial {E}_{p , V}}{\partial {δ}_{V , 1}} ( i - 1 ) + \\ \frac{\partial {E}_{p , V}}{\partial {δ}_{V , 2}} ( i - 1 ) \cdot \\ \frac{d {δ}_{V , 2}}{d {δ}_{V , 1}} ( i - 1 )\end{matrix} )\end{matrix} ] + \begin{matrix}{R}_{V , 1} \cdot \frac{\partial {p}_{P}}{\partial {δ}_{V , 2}} ( i - 1 ) \cdot \\ \frac{d {δ}_{V , 2}}{d {δ}_{V , 1}} ( i - 1 )\end{matrix} \}\end{matrix} \\ [ {δ}_{V , 1} ( i ) - {δ}_{V , 1} ( i - 1 ) ] + {a}_{21 , V} {δ}_{V , 1} ( i - 1 )\end{matrix} \\ [ {E}_{a , V} ( i ) - {E}_{a , V} ( i - 1 ) ] = 0 ,\end{matrix} \\ {p}_{A} ( i - 1 ) - {p}_{V} ( i ) = 4 {ρ}_{A} {c}_{A} ( i - 1 ) {( \frac{{R}_{V , 1} + {δ}_{V , 1} ( i - 1 )}{{R}_{valve}} )}^{2} [ \begin{matrix}{δ}_{V , 1} ( i ) - \\ {δ}_{V , 1} ( i - 1 )\end{matrix} ] , \\ p ( i ) = Eh δ ( i ) / {R}^{2} , \\ p ( i ) = {p}_{A} ( i ) ,\end{matrix}$$

where E_{a,A}(i) was obtained, as discussed in sect. 4.2. Having solved the above system we find E_{p,A}(i), E_{A}(i), E_{p,V}(i) and E_{V}(i) (by formulas (11) and (10)) and then accomplish the calculation procedure involving the Newton's method to obtain the exact solution for all chambers together (sect. 4.4).
4.9. The solution for the venous-atrial and ventricular flows and wall elasticity on atrial systole. The only difference of this section from the former one, is as follows: the fourth equation of the linearized system is substituted by equation

$$\{ 2 [ {δ}_{V , 1} ( i - 1 ) - {δ}_{V , 1} ( i - 2 ) ] + [ {R}_{V , 1} + {δ}_{V , 1} ( i - 1 ) ] \} [ {δ}_{V , 1} ( i ) - {δ}_{V , 1} ( i - 1 ) ] = \frac{{dt}^{2} {R}_{valve}^{2} [ {p}_{A} ( i - 1 ) - {p}_{V} ( i - 1 ) ]}{4 {ρ}_{A} \cdot [ {R}_{V , 1} + {δ}_{V , 1} ( i - 1 ) ] [ \begin{matrix}{R}_{A , 1} + {δ}_{A , 1} ( i - 1 ) + \\ {R}_{V , 1} + {δ}_{V , 1} ( i - 1 )\end{matrix} ]} + [ {R}_{V , 1} + {δ}_{V , 1} ( i - 1 ) ] [ {δ}_{V , 1} ( i - 1 ) - {δ}_{V , 1} ( i - 2 ) ] ; \qquad ( 27 )$$

see Appendix for its deduction.
4.10. An example of usage of the calculation procedure from sect. 4.4 involving the Newton's method to obtain the exact solution for all chambers together: the solution for the Vc→Ra and Pv→LA flows and wall elasticity while both Atrioventricular and both arterial valves are closed. The system of equations with respect to a six-element unknown vector x= [symbol] p_{LA}(i), δ_{LA,1}(i), δ_{Pv}(i), p_{RA}(i), δ_{RA,1}(i), δ_{Vc}(i) [symbol] can be written in the form ƒ(x)=0, using the following six-element column vector-function ƒ:

$$( \begin{matrix}\frac{4}{3} \{ \begin{matrix}{[ {R}_{LA , 1} + {δ}_{LA , 1} ( i ) ]}^{3} - \\ {[ {R}_{LA , 1} + {δ}_{LA , 1} ( i - 1 ) ]}^{3}\end{matrix} \} + {l}_{Pv} \{ \begin{matrix}{[ {R}_{Pv} + {δ}_{Pv} ( i ) ]}^{2} - \\ {[ {R}_{Pv} + {δ}_{Pv} ( i - 1 ) ]}^{2}\end{matrix} \} - {\dot{Q}}_{L 3 , Pv} ( i ) dt / π \\ {a}_{21 , LA} {δ}_{LA , 1} ( i ) {E}_{LA} ( i ) + {R}_{LA , 1} [ {a}_{22 , LA} {p}_{LA} ( i ) + {p}_{P} ( i ) + const ] \\ {p}_{LA} ( i ) - {E}_{Pv} {h}_{Pv} {δ}_{Pv} ( i ) / {R}_{Pv}^{2} \\ \begin{matrix}\frac{4}{3} \{ \begin{matrix}{[ {R}_{RA , 1} + {δ}_{RA , 1} ( i ) ]}^{3} - \\ {[ {R}_{RA , 1} + {δ}_{RA , 1} ( i - 1 ) ]}^{3}\end{matrix} \} + {l}_{Vc} \{ \begin{matrix}{[ {R}_{Vc} + {δ}_{Vc} ( i ) ]}^{2} - \\ {[ {R}_{Vc} + {δ}_{Vc} ( i - 1 ) ]}^{2}\end{matrix} \} - {\dot{Q}}_{B3 , Vc} ( i ) dt / π \\ {a}_{21 , RA} {δ}_{RA , 1} ( i ) {E}_{RA} ( i ) + {R}_{RA , 1} [ {a}_{22 , RA} {p}_{RA} ( i ) + {p}_{P} ( i ) + const ] \\ {p}_{RA} ( i ) - {E}_{Vc} {h}_{Vc} {δ}_{Vc} ( i ) / {R}_{Vc}^{2}\end{matrix}\end{matrix} ) .$$

Therefore, the Jacobi matrix ƒ′=∂f/∂x will look as follows:
(For computational simplicity we will restrict ourselves to the most practically important case when Eₚ depends only on δ₁).

$$( \begin{matrix}0 & {4 [ \begin{matrix}{R}_{LA , 1} + \\ {δ}_{LA , 1} ( i )\end{matrix} ]}^{2} & 2 {l}_{Pv} [ \begin{matrix}{R}_{Pv} + \\ {δ}_{Pv} ( i )\end{matrix} ] & 0 & 0 & 0 \\ {R}_{RA , 1} {a}_{22 , LA} & \begin{matrix}{a}_{21 , LA} [ \begin{matrix}{E}_{LA} ( i ) + \\ {δ}_{LA} ( i ) \\ \frac{\partial {E}_{p , LA}}{\partial {δ}_{LA , 1}} ( i )\end{matrix} ] + \\ \begin{matrix}{R}_{LA , 1} \cdot \\ \frac{\partial {p}_{P}}{\partial {δ}_{LA , 1}} ( i )\end{matrix}\end{matrix} & 0 & 0 & 0 & 0 \\ 1 & 0 & \begin{matrix}- {E}_{Pv} {h}_{Pv} / \\ {R}_{Pv}^{2}\end{matrix} & 0 & 0 & 0 \\ 0 & 0 & 0 & 0 & {4 [ \begin{matrix}{R}_{RA , 1} + \\ {δ}_{RA , 1} ( i )\end{matrix} ]}^{2} & 2 {l}_{Vc} [ \begin{matrix}{R}_{Vc} + \\ {δ}_{Vc} ( i )\end{matrix} ] \\ 0 & 0 & 0 & {R}_{RA , 1} {a}_{22 , RA} & \begin{matrix}{a}_{21 , RA} [ \begin{matrix}{E}_{RA} ( i ) + \\ {δ}_{RA} ( i ) \\ \frac{\partial {E}_{p , RA}}{\partial {δ}_{RA , 1}} ( i )\end{matrix} ] + \\ \begin{matrix}{R}_{RA , 1} \cdot \\ \frac{\partial {p}_{P}}{\partial {δ}_{RA , 1}} ( i )\end{matrix}\end{matrix} & 0 \\ 0 & 0 & 0 & 1 & 0 & \begin{matrix}- {E}_{Vc} {h}_{Vc} / \\ {R}_{Vc}^{2}\end{matrix}\end{matrix} )$$

where the derivatives can be computed by the formulas in sect. 3.10. Now, we perform the Newton's iterations in the standard way using ƒ and ƒ′. See Appendix for the definition and basic property of the method.
4.11. The regulation. We make the following regulation based on the determination of dynamic parameters (sect. 4.1-4.10) for a whole cardiac cycle:

According to Frank-Starling law of the heart, for ventricles we can increase (decrease) parameter ampl and decrease (respectively, increase) parameter D₁ while EDV (the End Diastolic Volumes) abnormally increase (respectively, decrease) as ampl=β_ampl·ampl₀, D₁=β_D₁·D_{1,0};

The similar thing can be made with atria basing on values of their pre-systolic volumes (internal volumes just before start of atrial systole);

We are able to increase (decrease) Res_{L3} via decreasing (respectively, increasing) R_{L3} while p_{Pa} (respectively, p_{Ao}) abnormally increases, and decrease (increase) Res_{L3} via a gradual increasing (respectively, decreasing) R_{L3} while p_{Pa} (respectively, p_{Ao}) abnormally decreases:

R_{L3}(i)={1+[β_{—}R(L3)−1]·a·i}·R_{L3}(0).

The normalizing coefficient a is picked so that a·i will equal to 1 only after several cycles; however, on any cycle we perform the similar regulation (starting with the currently obtained value of R_{L3}). In fact, the coefficient β_R(L3) is a product of two coefficients reflecting the impacts of Ao and Pa, respectively. Thus, R_{L3} becomes updatable per point within a cycle so that the formulas in sect. 4.3 containing R_{L3} should be changed in the following way:

$${δ}_{L 3} ( i ) = \sqrt{{[ {R}_{L 3} ( i - 1 ) + {δ}_{L 3} ( i - 1 ) ]}^{2} + {\dot{Q}}_{L 2 , L 3} ( i ) dt / ( π {l}_{L 3} )} - {R}_{L 3} ( i ) , \\ {p}_{L 3} ( i ) = {E}_{L 3} {h}_{L 3} {δ}_{L 3} ( i ) / {[ {R}_{L 3} ( i ) ]}^{2} , \\ {Res}_{L 3} ( i ) = {Res}_{L 3} ( i - 1 ) \cdot {[ \frac{{R}_{L 3} ( i ) + {δ}_{L 3} ( i - 1 )}{{R}_{L 3} ( i - 1 ) + {δ}_{L 3} ( i )} ]}^{4} , \\ {δ}_{L 3}^{final} ( i ) = \sqrt{{[ {R}_{L 3} ( i ) + {δ}_{L 3} ( i ) ]}^{2} - {\dot{Q}}_{L 3 , Pv} ( i ) dt / ( π {l}_{L 3} )} - {R}_{L 3} ( i ) , \\ {p}_{L 3}^{final} ( i ) = {E}_{L 3} {h}_{L 3} {δ}_{L 3}^{final} ( i ) / {[ {R}_{L 3} ( i ) ]}^{2} . \\ {Res}_{L 3}^{final} ( i ) = {Res}_{L 3} ( i ) \cdot {[ \frac{{R}_{L 3} ( i ) + {δ}_{L 3} ( i )}{{R}_{L 3} ( i ) + {δ}_{L 3}^{final} ( i )} ]}^{4} .$$

Similarly, we are able to increase (decrease) Res_{B3} via decreasing (respectively, increasing) R_{B3} while p_{Ao} (respectively, p_{Pa}) abnormally increases, and decrease (increase) Res_{B3} via a gradual increasing (respectively, decreasing) R_{B3} while p_{Ao} (respectively, p_{Pa}) abnormally decreases. The above action is extended for several cycles, but on any cycle we perform the similar regulation (starting with the currently obtained value of R_{B3}).

Thus, R_{B3} becomes updatable per point within a cycle so that the formulas containing R_{L3} should correspondingly be changed;

We are able to increase (decrease) Res_{L1} via increasing (respectively, decreasing) E_{L1} while p_{L2} abnormally increases (respectively, decreases). Similarly to above, this action is extended for several cycles, but on any cycle we perform the similar regulation (starting with the currently obtained value of E_{L1}). We make this regulation using the coefficient β_E(L1).

Thus, E_{L1} becomes updatable per point within a cycle so that the formulas containing E_{L1} should correspondingly be changed;

Similarly, we are able to increase (decrease) Res_{B1} via increasing (respectively, decreasing) E_{B1} while p_{B2} abnormally increases (respectively, decreases). Similarly to above, this action is extended for several cycles, but on any cycle we perform the similar regulation (starting with the currently obtained value of E_{B1}). We make this regulation using the coefficient β_E(B1).

Thus, E_{B1} becomes updatable per point within a cycle so that the formulas containing E_{B1} should correspondingly be changed;

We are able to increase (decrease) the Diastolic duration of LV while p_{L2} abnormally increases (respectively, decreases). For this, we move the starting point of repolarization of ventricular cells which results in changes of the elastic response of the ventricular walls. (Initially that point was determined by parameters of Table 1 (D).) We do it using the coefficient β_dt(LV);

Similarly, we are able to increase (decrease) the Diastolic duration of RV while p_{B2} abnormally increases (respectively, decreases). For this, we move the starting point of repolarization of ventricular cells which results in changes of the elastic response of the ventricular walls. (Initially that point was determined by parameters of Table 1 (D).) We do it using the coefficient β_dt(RV);

Finally, we are able to regulate HR and other parameters of Table 1 (D) determining the cardiac cycle using a known relation from Heart physiology as Stroke Volume·HR≈const.

Any above coefficients of the type β_ . . . depending on a variable x (it may be EDV, p, etc.) can be found by a common algorithm as follows. We fix four characteristic values x₁<x₂<x₃<x₄ (picked in accordance with literature sources or our own preliminary studies). Using the constant parameter h_{β}_{_{—}} _{. . .} (lying between 0 and 1) we built the function β=β_ . . . (x) by the formula

$$β ( x ) = \{ \begin{matrix}1 - {h}_{β} {e}^{- 1 / {( x - {x}_{2} )}^{2}} & if x < {x}_{2} , \\ 1 & if {x}_{2} \leq x \leq {x}_{3} , \\ 1 - \frac{{x}_{4} - {x}_{3}}{{x}_{2} - {x}_{1}} {h}_{β} {e}^{- 1 / {( x - {x}_{3} )}^{2}} & if x > {x}_{3} ,\end{matrix}$$

if it is a monotone nondecreasing function, or by the formula

$$β ( x ) = \{ \begin{matrix}1 + \frac{{x}_{2} - {x}_{1}}{{x}_{4} - {x}_{3}} {h}_{β} {e}^{- 1 / {( x - {x}_{2} )}^{2}} & if x < {x}_{2} , \\ 1 & if {x}_{2} \leq x \leq {x}_{3} , \\ 1 - {h}_{β} {e}^{- 1 / {( x - {x}_{3} )}^{2}} & if x > {x}_{3} ,\end{matrix}$$

if it is monotone non-increasing function. (The interval between x₂ and x₃ corresponds to the values of x which are “normal” and do not need the regulation.)

TABLE 1
The list of parameters used in the model.
(The second column contains the abridged notations as used in the text)

| | |
|---|---|
| Parameter | Description |

A1. The basic model parameters of validity for a cardiac cycle

| | | |
|---|---|---|
| R_{LV,1} | R_{V,1}, R₁ | The internal radius of the nondeformed (empty) left ventricle |
| R_{LV,2} | R_{V,2}, R₂ | The external radius of the nondeformed (empty) left ventricle |
| R_{RV,1} | R_{V,1}, R₁ | The internal radius of the nondeformed (empty) right ventricle |
| R_{RV,2} | R_{V,2}, R₂ | The external radius of the nondeformed (empty) right ventricle |
| ρ_{LA} | ρ_{A}, ρ | The left-atrial-and-pulmonary-vein blood density |
| R_{LA,1} | R_{A,1}, R₁ | The internal radius of the nondeformed (empty) left atrium |
| R_{LA,2} | R_{A,2}, R₂ | The external radius of the nondeformed (empty) left atrium |
| ρ_{RA} | ρ_{A}, ρ | The right-atrial-and-vena-cava blood density |
| R_{RA,1} | R_{A,1}, R₁ | The internal radius of the nondeformed (empty) right atrium |
| R_{RA,2} | R_{A,2}, R₂ | The external radius of the nondeformed (empty) right atrium |
| R_{Ao} | R | The (internal) radius of the nondeformed (empty) aorta |
| h_{Ao} | h | The thickness of the nondeformed (empty) aorta |
| l_{Ao} | l | The length of aorta |
| α_{Ao} | α | The factor determining the pressure-effective Young modulus relationship for aorta |
| R_{Vc} | R | The (internal) radius of the nondeformed (empty) vena cava |
| h_{Vc} | h | The thickness of the nondeformed (empty) vena cava |
| l_{Vc} | l | The length of vena cava |
| R_{Pa} | R | The (internal) radius of the nondeformed (empty) pulmonary artery |
| h_{Pa} | h | The thickness of the nondeformed (empty) pulmonary artery |
| l_{Pa} | l | The length of pulmonary artery |
| α_{Pa} | α | The factor determining the pressure-effective Young modulus relationship for Pa |
| R_{Pv} | R | The (internal) radius of the nondeformed (empty) pulmonary vein |
| h_{Pv} | h | The thickness of the nondeformed (empty) pulmonary vein |
| l_{Pv} | l | The length of pulmonary vein |
| R_{L1} | R | The (internal) radius of the nondeformed (empty) L1 |
| R_{L2} | R | The (internal) radius of the nondeformed (empty) L2 |
| h_{L1} | h | The thickness of the nondeformed (empty) L1 |
| h_{L2} | h | The thickness of the nondeformed (empty) L2 |
| h_{L3} | h | The thickness of the nondeformed (empty) L3 |
| l_{L1} | l | The length of L1 |
| l_{L2} | l | The length of L2 |
| l_{L3} | l | The length of L3 |
| ρ_{L1} | ρ | The density of blood in L1 |
| ρ_{L2} | ρ | The density of blood in L2 |
| ρ_{L3} | ρ | The density of blood in L3 |
| μ_{L1} | μ | The viscosity-related resistance coefficient of the blood flow in L1 |
| μ_{L2} | μ | The viscosity-related resistance coefficient of the blood flow in L2 |
| μ_{L3} | μ | The viscosity-related resistance coefficient of the blood flow in L3 |
| R_{B1} | R | The average radius of the nondeformed (empty) system arteries |
| h_{B1} | h | The average thickness of the nondeformed (empty) system arteries |
| l_{B1} | l | The average length of system arteries |
| ρ_{B1} | ρ | The density of blood in system arteries |
| μ_{B1} | μ | The viscosity-related resistance coefficient of the blood flow in system arteries |
| R_{B2} | R | The average radius of the nondeformed (empty) system capillaries |
| h_{B2} | h | The average thickness of the nondeformed (empty) system capillaries |
| l_{B2} | l | The average length of system capillaries |
| ρ_{B2} | ρ | The density of blood in system capillaries |
| μ_{B2} | μ | The viscosity-related resistance coefficient of the blood flow in system capillaries |
| h_{B3} | h | The average thickness of the nondeformed (empty) system veins |
| l_{B3} | l | The average length of system veins |
| ρ_{B3} | ρ | The density of blood in system veins |
| μ_{B3} | μ | The viscosity-related resistance coefficient of the blood flow in system veins |
| Eₐ₀(LA) | Eₐ₀, ampl₀ | The minimal possible value and amplitude of the left atrial active Young |
| ampl₀ (LA) | | modulus |
| Eₐ₀(RA) | Eₐ₀, ampl₀ | The minimal possible value and amplitude of the right atrial active Young |
| ampl₀ (RA) | | modulus |
| Eₐ₀(LV) | Ea₀, ampl₀ | The minimal possible value and amplitude of the left ventricular active Young |
| ampl₀ (LV) | | modulus |
| Eₐ₀(RV) | Ea₀, ampl₀ | The minimal possible value and amplitude of the right ventricular active Young |
| ampl₀ (RV) | | modulus |
| Eₚ₀(LA), | Eₚ₀, Aₚ, C_{δ}, | The minimal possible value, amplitude and exponential growth coefficients of the |
| Aₚ(LA), | Cₕ, Cₚ | left-atrial passive Young modulus with respect to internal volume, wall thickness |
| C_{δ}(LA), | | and pressure |
| Cₕ(LA), | | |
| Cₚ(LA) | | |
| Eₚ₀(RA), | Eₚ₀, Aₚ, C_{δ}, | The minimal possible value, amplitude and exponential growth coefficients of the |
| Aₚ(RA), | Cₕ, Cₚ | right-atrial passive Young modulus with respect to internal volume, wall thickness |
| C_{δ}(RA), | | and pressure |
| Cₕ(RA), | | |
| Cₚ(RA) | | |
| Eₚ₀(LV), | Eₚ₀, Aₚ, C_{δ}, | The minimal possible value, amplitude and exponential growth coefficients of the |
| Aₚ(LV), | Cₕ, Cₚ | left-ventricular passive Young modulus with respect to internal volume, wall |
| C_{δ}(LV), | | thickness and pressure |
| Cₕ(LV), | | |
| Cₚ(LV) | | |
| Eₚ₀(RV), | Eₚ₀, Aₚ, C_{δ}, | The minimal possible value, amplitude and exponential growth coefficients of the |
| Aₚ(RV), | Cₕ, Cₚ | right-ventricular passive Young modulus with respect to internal volume, wall |
| C_{δ}(RV), | | thickness and pressure |
| Cₕ(RV), | | |
| Cₚ(RV) | | |
| σ(RA) | σ | The Poisson coefficient of the right atrial wall material |
| σ(LA) | σ | The Poisson coefficient of the left atrial wall material |
| σ(RV) | σ | The Poisson coefficient of the right ventricular wall material |
| σ(LV) | σ | The Poisson coefficient of the left ventricular wall material |
| R_{valve,LA} | Rᵥₐₗᵥₑ | The mitral valve radius |
| R_{valve,RA} | Rᵥₐₗᵥₑ | The tricuspid valve radius |
| n₁(RA) | n₁ | The systolic peak-shift related coefficient of the right-atrial Eₐ |
| n₁(LA) | n₁ | The systolic peak-shift related coefficient of the left-atrial Eₐ |
| n₁(RV) | n₁ | The systolic peak-shift related coefficient of the right-ventricular Eₐ |
| n₁(LV) | n₁ | The systolic peak-shift related coefficient of the left-ventricular Eₐ |
| n₂(RA) | n₂ | The diastolic hollow-shift related coefficient of the right-atrial Eₐ |
| n₂(LA) | n₂ | The diastolic hollow-shift related coefficient of the left-atrial Eₐ |
| n₂(RV) | n₂ | The diastolic hollow-shift related coefficient of the right-ventricular Eₐ |
| n₂(LV) | n₂ | The diastolic hollow-shift related coefficient of the left-ventricular Eₐ |
| D_{1,0}(RA) | D_{1,0} | The systolic rise-related coefficient of the right-atrial Eₐ |
| D_{1,0}(LA) | D_{1,0} | The systolic rise-related coefficient of the left-atrial Eₐ |
| D_{1,0}(RV) | D_{1,0} | The systolic rise-related coefficient of the right-ventricular Eₐ |
| D_{1,0}(LV) | D_{1,0} | The systolic rise-related coefficient of the left-ventricular Eₐ |
| D₂(RA) | D₂ | The diastolic descent-related coefficient of the right-atrial Eₐ |
| D₂(LA) | D₂ | The diastolic descent-related coefficient of the left-atrial Eₐ |
| D₂(RV) | D₂ | The diastolic descent-related coefficient of the right-ventricular Eₐ |
| D₂(LV) | D₂ | The diastolic descent-related coefficient of the left-ventricular Eₐ |
| R_{P,1} | R₁ | The internal radius of the nondeformed (empty) pericardial chamber |
| h_{P} | h | The wall thickness of the nondeformed (empty) pericardial chamber |
| E_{P} | E | The Young modulus of the pericardial wall material |

A2. The derived model parameters of validity for a whole cardiac cycle

| k_{LV} | k | The ratio of external to internal radius of the nondeformed (empty) left ventricle: | |
|---|---|---|---|
| | | k = R₂/R₁ | |
| a₁₁,_{LV} | a₁₁ | The connected elasticity matrix elements (functions of k): | |
| a₁₂,_{LV} a₂₁,_{LV} a₂₂,_{LV} | a₁₂ a₂₁ a₂₂ | ${a}_{11} = \frac{( 1 + σ ) ( 2 k + {k}^{- 2} - 4 σ k )}{3 ( 1 - σ )} ,$ ${a}_{21} = \frac{2 ( 1 - {k}^{- 3} )}{3 ( 1 - σ )} ,$ | ${a}_{12} = \frac{( 1 + σ ) ( {k}^{- 2} - k + 2 σ k )}{3 ( 1 - σ )} ,$ ${a}_{22} = - \frac{1 + 2 {k}^{- 3} + σ ( 1 - 4 {k}^{- 3} )}{3 ( 1 - σ )}$ |
| k_{RV} | k | The ratio of external to internal radius of the nondeformed (empty) right ventricle: | |
| | | k = R₂/R₁ | |
| a₁₁,_{RV} | a₁₁ | The connected elasticity matrix elements (functions of k): | |
| a₁₂,_{RV} a₂₁,_{RV} a₂₂,_{RV} | a₁₂ a₂₁ a₂₂ | ${a}_{11} = \frac{( 1 + σ ) ( 2 k + {k}^{- 2} - 4 σ k )}{3 ( 1 - σ )} ,$ ${a}_{21} = \frac{2 ( 1 - {k}^{- 3} )}{3 ( 1 - σ )} ,$ | ${a}_{12} = \frac{( 1 + σ ) ( {k}^{- 2} - k + 2 σ k )}{3 ( 1 - σ )} ,$ ${a}_{22} = - \frac{1 + 2 {k}^{- 3} + σ ( 1 - 4 {k}^{- 3} )}{3 ( 1 - σ )}$ |
| k_{LA} | k | The ratio of external to internal radius of the nondeformed (empty) left atrium: | |
| | | k = R₂/R₁ | |
| a₁₁,_{LA} | a₁₁ | The connected elasticity matrix elements (functions of k): | |
| a₁₂,_{LA} a₂₁,_{LA} a₂₂,_{LA} | a₁₂ a₂₁ a₂₂ | ${a}_{11} = \frac{( 1 + σ ) ( 2 k + {k}^{- 2} - 4 σ k )}{3 ( 1 - σ )} ,$ ${a}_{21} = \frac{2 ( 1 - {k}^{- 3} )}{3 ( 1 - σ )} ,$ | ${a}_{12} = \frac{( 1 + σ ) ( {k}^{- 2} - k + 2 σ k )}{3 ( 1 - σ )} ,$ ${a}_{22} = - \frac{1 + 2 {k}^{- 3} + σ ( 1 - 4 {k}^{- 3} )}{3 ( 1 - σ )}$ |
| k_{RA} | k | The ratio of external to internal radius of the nondeformed (empty) right atrium: | |
| | | k = R₂/R₁ | |
| a₁₁,_{RA} | a₁₁ | The connected elasticity matrix elements (functions of k): | |
| a₁₂,_{RA} a₂₁,_{RA} a₂₂,_{RA} | a₁₂ a₂₁ a₂₂ | ${a}_{11} = \frac{( 1 + σ ) ( 2 k + {k}^{- 2} - 4 σ k )}{3 ( 1 - σ )} ,$ ${a}_{21} = \frac{2 ( 1 - {k}^{- 3} )}{3 ( 1 - σ )} ,$ | ${a}_{12} = \frac{( 1 + σ ) ( {k}^{- 2} - k + 2 σ k )}{3 ( 1 - σ )} ,$ ${a}_{22} = - \frac{1 + 2 {k}^{- 3} + σ ( 1 - 4 {k}^{- 3} )}{3 ( 1 - σ )}$ |
| R_{P,2} | R₂ | The external radius of the nondeformed (empty) pericardial chamber: R₂ = R₁ + h | |
| k_{P} | k | The ratio of external to internal radius of the nondeformed (empty) pericardial | |
| | | chamber: k = R₂/R₁ | |
| a_{11,P} | a₁₁ | The connected elasticity matrix elements (functions of k): | |
| a_{12,P} a_{21,P} a_{22,P} | a₁₂ a₂₁ a₂₂ | ${a}_{11} = \frac{( 1 + σ ) ( 2 k + {k}^{- 2} - 4 σ k )}{3 ( 1 - σ )} ,$ ${a}_{21} = \frac{2 ( 1 - {k}^{- 3} )}{3 ( 1 - σ )} ,$ | ${a}_{12} = \frac{( 1 + σ ) ( {k}^{- 2} - k + 2 σ k )}{3 ( 1 - σ )} ,$ ${a}_{22} = - \frac{1 + 2 {k}^{- 3} + σ ( 1 - 4 {k}^{- 3} )}{3 ( 1 - σ )}$ |

| | | |
|---|---|---|
| ampl(LA) | ampl | ampl = β_ampl · ampl₀ |
| ampl(RA) | ampl | ampl = β_ampl · ampl₀ |
| ampl(LV) | ampl | ampl = β_ampl· ampl₀ |
| ampl(RV) | ampl | ampl = β_ampl · ampl₀ |
| D₁(RA) | D₁ | D₁ = β_D1 · D_{1,0} |
| D₁(LA) | D₁ | D₁ = β_D1 · D_{1,0} |
| D₁(RV) | D₁ | D₁ = β_D1 · D_{1,0} |
| D₁(LV) | D₁ | D₁ = β_D1 · D_{1,0} |
| Eₐ₂(LA) | Eₐ₂ | Eₐ₄ = Eₐ₀ + ampl, Eₐ₂ = Eₐ₄ |
| Eₐ₄(LA) | Eₐ₄ | |
| Eₐ₂(RA) | Eₐ₂ | Eₐ₄ = Eₐ₀ + ampl, Eₐ₂ = Eₐ₄ |
| Eₐ₄(RA) | Eₐ₄ | |
| Eₐ₂(LV) | Eₐ₂ | Eₐ₂ = Eₐ₀ + ampl, Eₐ₄ = Eₐ₀ |
| Eₐ₄(LV) | Eₐ₄ | |
| Eₐ₂(RV) | Eₐ₂ | Eₐ₂ = Eₐ₀ + ampl, Eₐ₄ = Eₐ₀ |
| Eₐ₄(RV) | Eₐ₄ | |
| E_{0,Ao} | E₀ | The Young modulus of the aortic wall referred to zero pressure |
| E_{Vc} | E | $The effective Young modulus of the vena cava wall \text{:} E = \frac{{pR}^{2}}{h δ}$ |
| c_{Vc} | c | $The vena cava absolute pressure wave propagation velocity \text{:} c = \sqrt{\frac{Eh}{2 R ρ}}$ |
| E_{0,Pa} | E₀ | The Young modulus of the pulmonary-arterial wall referred to zero pressure |
| E_{Pv} | E | $The effective Young modulus of the pulmonary vein wall \text{:} E = \frac{{pR}^{2}}{h δ}$ |
| c_{Pv} | c | $The pulmonary vein absolute pressure wave propagation velocity \text{:} c = \sqrt{\frac{Eh}{2 R ρ}}$ |
| E_{B2} | E | $The average effective Young modulus of the system capillaries ' walls \text{:} E = \frac{{pR}^{2}}{h δ}$ |
| E_{B3} | E | $The average effective Young modulus of the system veins ' walls \text{:} E = \frac{{pR}^{2}}{h δ}$ |
| E_{L2} | E | $The average effective Young modulus of L 2 walls \text{:} E = \frac{{pR}^{2}}{h δ}$ |
| E_{L3} | E | $The average effective Young modulus of L 3 walls \text{:} E = \frac{{pR}^{2}}{h δ}$ |
| const_{RA} | const | The constant term, having dimension of stress, additional to p₂ in elasticity |
| | | equation (3) |
| p_{0,RA} | p₀ | The compensating term, having dimension of stress, in elasticity equation (2) |
| const_{LA} | const | The constant term, having dimension of stress, additional to p₂ in elasticity |
| | | equation (3) |
| p_{0,LA} | P₀ | The compensating term, having dimension of stress, in elasticity equation (2) |
| const_{RV} | const | The constant term, having dimension of stress, additional to p₂ in elasticity |
| | | equation (3) |
| p_{0,RV} | p₀ | The compensating term, having dimension of stress, in elasticity equation (2) |
| const_{LV} | const | The constant term, having dimension of stress, additional to p₂ in elasticity |
| | | equation (3) |
| p_{0,LV} | p₀ | The compensating term, having dimension of stress, in elasticity equation (2) |
| tₑₛ(LV) | tₑₛ | The moment of the end of left-ventricular systole |
| t_{ed}(LV) | t_{ed} | The moment of the end of left-ventricular diastole |
| t_{ed}_new(LV) | t_{ed}_new | The moment of the end of left-ventricular next diastole |
| tₑₛ(RV) | tₑₛ | The moment of the end of right-ventricular systole |
| t_{ed}(RV) | t_{ed} | The moment of the end of right-ventricular diastole |
| t_{ed}_new(RV) | t_{ed}_new | The moment of the end of right-ventricular next diastole |
| tₑₛ(LA) | tₑₛ | The moment of the end of left-atrial systole |
| t_{ed}(LA) | t_{ed} | The moment of the start of left-ventricular filling |
| t_{ed}_new(LA) | t_{ed}_new | The moment of the start of left-atrial next systole |
| tₑₛ_new(LA) | tₑₛ_new | The moment of the end of left-atrial next systole |
| tₑₛ(RA) | tₑₛ | The moment of the end of right-atrial systole |
| t_{ed}(RA) | t_{ed} | The moment of the start of right-ventricular filling |
| t_{ed}_new(RA) | t_{ed}_new | The moment of the start of right-atrial next systole |
| tₑₛ_new(RA) | tₑₛ_new | The moment of the end of right-atrial next systole |

B. The Model Parameters Updated Every 10⁻² s, Per Point within a Cycle
(The parameters whose initial values need to be input (either directly or indirectly, as e.g. via extracting them from results of medical examinations or using other information sources) are marked with stars; the parameters that are not marked completely are derived including their initial values)

| Parameter | | | Description |
|---|---|---|---|
| p_{LV} | p_{V}, p | * | The left-ventricular blood pressure |
| E_{a,LV} | E_{a,V}, Eₐ | | The active Young modulus of the left-ventricular wall |
| E_{p,LV} | E_{p,V}, Eₚ | | The passive Young modulus of the left-ventricular wall |
| E_{LV} | E_{V}, E | | The effective Young modulus of the left-ventricular wall: E = Eₐ + Eₚ |
| δ_{LV,1} | δ_{V,1}, δ₁ | * | The absolute deformation-related increment of internal left-ventricular radius |
| δ_{LV,2} | δ_{V,2}, δ₂ | * | The absolute deformation-related increments of external left-ventricular radius |
| p_{RV} | p_{V}, p | * | The right-ventricular blood pressure |
| E_{a,RV} | E_{a,V}, Eₐ | | The active Young modulus of the right-ventricular wall |
| E_{p,RV} | E_{p,V}, Eₚ | | The passive Young modulus of the right-ventricular wall |
| E_{RV} | E_{V}, E | | The effective Young modulus of the right-ventricular wall: E = Eₐ + Eₚ |
| δ_{RV,1} | δ_{V,1}, δ₁ | * | The absolute deformation-related increment of internal right-ventricular radius |
| δ_{RV,2} | δ_{V,2}, δ₂ | * | The absolute deformation-related increment of external right-ventricular radius |
| p_{LA} | p_{A}, p | * | The left-atrial blood pressure |
| E_{a,LA} | E_{a,A}, Eₐ | | The active Young modulus of the left-atrial wall |
| E_{p,LA} | E_{p,A}, Eₚ | | The passive Young modulus of the left-atrial wall |
| E_{LA} | E_{A}, E | | The effective Young modulus of the left-atrial wall: E = Eₐ + Eₚ |
| δ_{LA,1} | δ_{A,1}, δ₁ | * | The absolute deformation-related increment of internal left-atrial radius |
| δ_{LA,2} | δ_{A,2}, δ₂ | * | The absolute deformation-related increment of external left-atrial radius |
| U_{LA} | U_{A} | * | The flow velocity on mitral valve |
| c_{LA} | c_{A} | | The absolute left-atrial pressure wave propagation velocity |
| p_{RA} | p_{A}, p | * | The right-atrial blood pressure |
| E_{a,RA} | E_{a,A}, Eₐ | | The active Young modulus of the right-atrial wall |
| E_{p,RA} | E_{p,A}, Eₚ | | The passive Young modulus of the right-atrial wall |
| E_{RA} | E_{A}, E | | The effective Young modulus of the right-atrial wall: E = Eₐ + Eₚ |
| δ_{RA,1} | δ_{A,1}, δ₁ | * | The absolute deformation-related increment of internal right-atrial radius |
| δ_{RA,2} | δ_{A,2}, δ₂ | * | The absolute deformation-related increment of external right-atrial radius |
| U_{RA} | U_{A} | * | The flow velocity on tricuspid valve |
| c_{RA} | c_{A} | | The absolute right-atrial pressure wave propagation velocity |
| p_{Ao} | p | * | The aortic blood pressure |
| ρ_{Ao} | ρ | * | The density of blood fluid in aorta |
| u_{Ao} | u | * | The axial blood flow velocity in aorta |
| Q_{Ao,B1} | Q | | The volume flow from aorta to SV |
| c_{Ao} | c | | The aortic absolute pressure wave propagation velocity |
| E_{Ao} | E | | The effective Young modulus of the aortic wall |
| δ_{Ao} | δ | * | The absolute deformation-related increment of the aortic radius |
| p_{Vc} | p | * | The vena cava blood pressure |
| u_{Vc} | u | * | The axial blood flow velocity in vena cava |
| δ_{Vc} | δ | * | The absolute deformation-related increment of the vena cava radius |
| Q_{B3,Vc} | Q | | The volume flow from SV to vena cava |
| p_{Pa} | p | * | The pulmonary artery blood pressure |
| ρ_{Pa} | ρ | * | The density of blood fluid in pulmonary artery |
| u_{Pa} | u | * | The axial blood flow velocity in pulmonary artery |
| u_{Pv} | u | * | The axial blood flow velocity in pulmonary vein |
| Q_{RV,Pa} | Q | | The volume flow from RV to Pa |
| Q_{Pa,L1} | Q | | The volume flow from Pa to L1 |
| Q_{L1,L2} | Q | | The volume flow from L1 to L2 |
| Q_{L2,L3} | Q | | The volume flow from L2 to L3 |
| Q_{L3,Pv} | Q | | The volume flow from L3 to Pv |
| Q_{Pv,LA} | Q | | The volume flow from Pv to LA |
| c_{Pa} | c | | The pulmonary artery absolute pressure wave propagation velocity |
| E_{Pa} | E | | The effective Young modulus of the pulmonary artery wall |
| δ_{Pa} | δ | * | The absolute deformation-related increment of the pulmonary artery radius |
| p_{Pv} | p | * | The pulmonary vein blood pressure |
| δ_{Pv} | δ | * | The absolute deformation-related increment of the pulmonary vein radius |
| p_{L1} | p | * | The blood pressure in L1 |
| E_{L1} | E | | The average effective Young modulus of L1 walls |
| δ_{L1} | δ | * | The absolute deformation-related increment of the L1 radius |
| Res_{L1} | Res | | The L1 resistance |
| p_{L2} | p | * | The blood pressure in L2 |
| δ_{L2} | δ | * | The absolute deformation-related increment of the L2 radius |
| Res_{L2} | Res | | The L2 resistance |
| p_{L3} | p | * | The blood pressure in L3 |
| R_{L3} | R | * | The (internal) radius of the nondeformed (empty) L3 |
| δ_{L3} | δ | * | The absolute deformation-related increment of the L3 radius |
| Res_{L3} | Res | | The L3 resistance |
| Q_{LV,Ao} | Q | | The volume flow from LV to Ao |
| Q_{Ao,B1} | Q | | The volume flow from Ao to B1 |
| p_{B1} | p | * | The average system arterial blood pressure |
| E_{B1} | E | | The average effective Young modulus of the system arteries' walls |
| δ_{B1} | δ | * | The average absolute deformation-related increment of system arteries |
| Res_{B1} | Res | | The average resistance of system arteries |
| Q_{B1,B2} | Q | | The volume flow from system arteries to capillaries |
| p_{B2} | p | * | The average system capillary blood pressure |
| δ_{B2} | δ | * | The average absolute deformation-related increment of system capillaries |
| Res_{B2} | Res | | The average resistance of system arteries |
| Q_{B2,B3} | Q | | The volume flow from system capillaries to veins |
| p_{B3} | p | * | The average system venous blood pressure |
| R_{B3} | R | * | The average radius of the nondeformed (empty) system veins |
| δ_{B3} | δ | * | The average absolute deformation-related increment of system veins |
| Res_{B3} | Res | | The average resistance of system veins |
| Q_{B3,Vc} | Q | | The volume flow from B3 to Vc |
| Q_{Vc,RA} | Q | | The volume flow from Vc to RA |
| p_{P} | p | | The intro-pericardial pressure |
| δ_{1,P} | δ₁ | | The absolute deformation-related increment of internal pericardial radius |
| δ_{2,P} | δ₂ | | The absolute deformation-related increments of external pericardial radius |
| ζ_{LV,1} | ζ_{V,1}, ζ₁ | | The internal volume of (deformed) left-ventricular |
| ζ_{RV,1} | ζ_{V,1}, ζ₁ | | The internal volume of (deformed) right ventricle |
| ζ_{LA,1} | ζ_{A,1}, ζ₁ | | The internal volume of (deformed) left atrium |
| ζ_{RA,1} | ζ_{A,1}, ζ₁ | | The internal volume of (deformed) right atrium |
| ζ_{Ao} | ζ | | The internal volume of (deformed) aorta |
| ζ_{Vc} | ζ | | The internal volume of (deformed) vena cava |
| ζ_{Pa} | ζ | | The internal volume of (deformed) pulmonary artery |
| ζ_{Pv} | ζ | | The internal volume of (deformed) pulmonary vein |

### C1. The Basic Constant Regulation Parameters

| Parameter | | Description |
|---|---|---|
| h_{β}_{_{—}}ₐₘₚₗ (LV) | h_{β}_{_{—}}ₐₘₚₗ | The parameter of the function determining β_ampl (LV) via the left-ventricular EDV |
| h_{β}_{_{—}}ₐₘₚₗ (RV) | h_{β}_{_{—}}ₐₘₚₗ | The parameter of the function determining β_ampl (RV) via the right-ventricular EDV |
| h_{β}_{_{—}}ₐₘₚₗ (LA) | h_{β}_{_{—}}ₐₘₚₗ | The parameter of the function determining β_ampl (LA) via the left-atrial pre-systolic |
| | | volume |
| h_{β}_{_{—}}ₐₘₚₗ (RA) | h_{β}_{_{—}}ₐₘₚₗ | The parameter of the function determining β_ampl (RA) via the right-atrial pre-systolic |
| | | volume |
| h_{β}_{_{—}}_{D1} (LV) | h_{β}_{_{—}}_{D1} | The parameter of the function determining β_D1 (LV) via the left-ventricular EDV |
| h_{β}_{_{—}}_{D1} (RV) | h_{β}_{_{—}}_{D1} | The parameter of the function determining β_D1 (RV) via the right-ventricular EDV |
| h_{β}_{_{—}}_{D1} (LA) | h_{β}_{_{—}}_{D1} | The parameter of the function determining β_D1 (LA) via the left-atrial EDV |
| h_{β}_{_{—}}_{D1} (RA) | h_{β}_{_{—}}_{D1} | The parameter of the function determining β_D1 (RA) via the right-atrial EDV |
| h_{β}_{_{—}}_{R} (B3) | h_{β}_{_{—}}_{R} | The parameter of the function determining β_R (B3) via the blood pressure in Ao or Pa |
| h_{β}_{_{—}}_{R} (L3) | h_{β}_{_{—}}_{R} | The parameter of the function determining β_R (L3) via the blood pressure in Ao or Pa |
| h_{β}_{_{—}}_{E} (B1) | h_{β}_{_{—}}_{E} | The parameter of the function determining β_E (B1) via the blood pressure in B2 |
| h_{β}_{_{—}}_{E} (L1) | h_{β}_{_{—}}_{E} | The parameter of the function determining β_E (L1) via the blood pressure in L2 |
| h_{β}_{_{—}}_{dt} (LV) | h_{β}_{_{—}}_{dt} | The parameter of the function determining β_dt (LV) via the blood pressure in L2 |
| h_{β}_{_{—}}_{dt} (RV) | h_{β}_{_{—}}_{dt} | The parameter of the function determining β_dt (RV) via the blood pressure in B2 |

### C2. The Derived Regulation Parameters of Validity for the Cycle

| Parameter | | Description |
|---|---|---|
| β_ampl (LV) | β_ampl | The coefficient regulating ampl (LV) via the left-ventricular EDV |
| β_ampl (RV) | β_ampl | The coefficient regulating ampl (RV) via the right-ventricular EDV |
| β_ampl (LA) | β_ampl | The coefficient regulating ampl (LA) via the left-atrial pre-systolic volume |
| β_ampl (RA) | β_ampl | The coefficient regulating ampl (RA) via the right-atrial pre-systolic volume |
| β_D1 (LV) | β_D1 | The coefficient regulating D₁ (LV) via the left-ventricular EDV |
| β_D1 (RV) | β_D1 | The coefficient regulating D₁ (RV) via the right-ventricular EDV |
| β_D1 (LA) | β_D1 | The coefficient regulating D₁ (LA) via the left-atrial EDV |
| β_D1 (RA) | β_D1 | The coefficient regulating D₁ (RA) via the right-atrial EDV |
| β_R (B3) | β_R | The coefficient regulating R_{B3} via the blood pressure in Ao or Pa |
| β_R (L3) | β_R | The coefficient regulating R_{L3} via the blood pressure in Ao or Pa |
| β_E (B1) | β_E | The coefficient regulating E_{B1} via the blood pressure in B2 |
| β_E (L1) | β_E | The coefficient regulating E_{L1} via the blood pressure in L2 |
| β_dt (LV) | β_dt | The coefficient regulating LV diastolic duration via the blood pressure in L2 |
| β_dt (RV) | β_dt | The coefficient regulating RV diastolic duration via the blood pressure in B2 |

D. The Parameters from Heart Physiology Determining the Cycle

| Parameter | Description |
|---|---|
| HR | Heart Rate |
| dur_PQ | PQ duration |
| dur_QRS | QRS duration |
| dur_ST | ST duration |
| dur_Twave | T wave duration |
| dur_Pwave | P wave duration |

### APPENDIX

A1. The deduction of equation (1). [Landau et al. 1986]. Under assumption 1.5 and 1.6, at any fixed moment of time, an infinitesimal deformation field on the vessel's wall will have the form

$$\vec{δ} = δ ( r ) \frac{\partial }{\partial r}$$

(r is the radial variable). This field must satisfy an equation as ∇ div \vec{δ}=0, and so,

δ=αrβ+β/r, (A1)

with constant α, β which will be determined in what follows. For the nonzero matrix components of the strain tensor (U) in cylindrical coordinates, we will have

$${U}_{rr} = \frac{d δ}{d r} = α - β / {r}^{2} , \\ {U}_{θθ} = \frac{δ}{r} = α + β / {r}^{2}$$

Expressing the stress tensor (σ) via (U) by Hooke's law gives, in particular,

$${σ}_{rr} = \frac{E}{( 1 + σ ) ( 1 - 2 σ )} α - \frac{E}{1 + σ} \cdot \frac{β}{{r}^{2}} .$$

Comprising the boundary conditions as a σᵣᵣ|_{r=R}_{₁}=−p, σᵣᵣ|_{r=R}_{₂}=0 (where the second one is due to assumption 1.11) brings the following values for α and β:

$$α = \frac{{pR}_{1}^{2}}{{R}_{2}^{2} - {R}_{1}^{2}} \cdot \frac{( 1 + σ ) ( 1 - 2 σ )}{E} , \\ β = \frac{{pR}_{1}^{2} {R}_{2}^{2}}{{R}_{2}^{2} - {R}_{1}^{2}} \cdot \frac{1 + σ}{E} , \qquad ( A2 )$$

where σ is the Poisson elasticity coefficient of the vessel's walls. For thin walls (R₂−R₁=h=R=R₁, the terms of order o(h/R) in any equations are neglected—assumption 1.3), putting α, β from (A2) in (A1), and assuming that σ=0, lead to equation (1).
A2. The deduction of equations (2), (3) for a homogeneous and isotropic material. The similar arguments as in sect. A1 bring,

δᵣ=αr+β/r², (A3)

with constant α, β, and, for the nonzero matrix components of the strain tensor (U) in spherical coordinates,

$${U}_{rr} = \frac{d {δ}_{r}}{d r} = α - 2 β / {r}^{3} , \\ {U}_{θθ} = {U}_{ϕϕ} = \frac{{δ}_{r}}{r} = α + β / {r}^{3} . \qquad ( A4 )$$

Expressing the stress tensor (σ) via (U) by Hooke's law gives,

$${σ}_{rr} = \frac{E}{1 - 2 σ} α - \frac{E}{1 + σ} \cdot \frac{2 β}{{r}^{3}} , \\ {σ}_{θθ} = {σ}_{ϕϕ} = \frac{E}{1 - 2 σ} α + \frac{E}{1 + σ} \cdot \frac{β}{{r}^{3}} , \qquad ( A5 )$$

where σ is the Poisson elasticity coefficient of the chamber's walls [Landau et al. 1986]. Comprising now the boundary conditions as σᵣᵣ|_{r=R}_{₁}=−p, δᵣ|_{r=R}_{₁}=δ₁, and setting σ=0, brings the following values for α and β:

$$α = \frac{1}{3} ( \frac{2 {δ}_{1}}{{R}_{1}} - \frac{p}{E} ) , \\ β = \frac{{R}_{1}^{3}}{3} ( \frac{{δ}_{1}}{{R}_{1}} + \frac{p}{E} ) . \qquad ( A6 )$$

Finally, putting α, β from (A6) in (A3) and (A5) leads to equations (2) and (3), respectively, for p₂=−σᵣᵣ(R₂) and δ₂=δᵣ(R₂). (In sect. A2, formula (A5) was used for σ_{V,rr} only. Similar formulas for σ_{V,φφ} and σ_{V,θθ} are used in sect. A8 in what follows, for the deduction of equation (12)).
A3. The deduction of equation (5) in a relevant special case. With absence of origins or sinks of mass, the total mass of the blood fluid, which at the moment t is contained in a cylindrical domain D bounded by two cross-sections S₁, S₂ (having the same area S) and walls of a vessel (either artery or vein) and having no intersections with the edges of a pressure wave, is changed for infinitesimal time dt by

$$\begin{matrix}\int {\int }_{D}^{ } \int ρ {d}^{3} x {\vert}_{t}^{t + d t} = [ ( ρ d x ) ( t ) {\vert}_{{S}_{1}} - ( ρ d x ) ( t ) {\vert}_{{S}_{2}} ] \cdot S \\ = [ ( ρ u ) ( t ) {\vert}_{{S}_{1}} - ( ρ u ) ( t ) {\vert}_{{S}_{2}} ] \cdot S d t \\ = - ρ 〈 \vec{v} , \vec{n} 〉 d S \cdot d t ,\end{matrix}$$

since the rest of the integral on the left-hand side, which is the same at the moments t and t+dt, is cancelled in the difference, and [symbol] equals zero on the cylindrical wall (as there is no radial flow on it), −u and +u on S₁ and S₂, respectively. (In the above deduction, assumptions 1.1, 1.8 and continuity of parameters of the flow out of the edges of a shock pressure wave were taken into account were taken into account.) Finally, dividing by dt gives equation (5) for D.
A4. The deduction of equation (6) in a relevant special case. According to Newton's second law, the total axial momentum of the blood fluid, which at the moment t is contained in a cylindrical domain D bounded by two cross-sections S₁, S₂ (having the same area S) and walls of a vessel (either artery or vein) and having no intersections with the edges of a pressure wave, is changed for infinitesimal time dt by

$$\begin{matrix}{\int \int \int }_{D} ρ u {d}^{3} x {\vert}_{t}^{t + dt} = [ ( p d t + ρ u d x ) ( t ) {\vert}_{{S}_{1}} - ( p d t + ρ u d x ) ( t ) {\vert}_{{S}_{2}} ] \cdot S \\ = [ ( p + ρ {u}^{2} ) ( t ) {\vert}_{{S}_{1}} - ( p + ρ {u}^{2} ) ( t ) {\vert}_{{S}_{2}} ] \cdot S d t \\ = - [ {pn}_{x} + ρ u 〈 \vec{v} , \vec{n} 〉 ] d S \cdot d t ,\end{matrix}$$

since the rest of the integral on the left-hand side, which is the same at the moments t and t+dt, is cancelled in the difference, [symbol] equals zero on the cylindrical wall (as there is no radial flow on it), −u and +u on S₁ and S₂, and nₓ equals −1 and +1 on S₁ and S₂, respectively. (In the above deduction, assumptions 1.1, 1.8 and continuity of parameters of the flow out of the edges of a shock pressure wave were taken into account were taken into account.) Finally, dividing by dt brings equation (6) for D.
A5. The deduction of equation (7). Following sources as e.g. [Dinnar 1981], we will introduce the average instantaneous axial flow velocity over a radial cross-section,

$$\overline{u} = \frac{1}{S} \int {\int }_{S}^{ } u d S .$$

Averaging the incompressibility equation

$$\frac{\partial u}{\partial x} + \frac{1}{r} \frac{\partial }{\partial r} ( rw ) = 0$$

over S, where w is the radial flow velocity (the angular velocity equals zero by assumption 1.1), with using the facts that w equals \dot{δ} on the wall (because of boundary condition #2, sect. 3.1) and zero at the center of the cross-section (due to the circular symmetry), and using δ expressed from the elasticity equation (1) leads to the Moens equation in the form (7).
A6. The deduction of equation (14). The first method. Equation (14) may be considered as a case of the following well-known Rankine-Hugoniot-type relation [Landau et al. 1987, and references therein], binding parameters of the flow on both sides of an edge of the (pressure) wave in the fluid,

p₁+ρ₁c₁²=p₂+ρ₂c₂². (A7)

(This equation follows from continuity of the axial momentum flow, taking place by assumption 1.11, and an additional assumption that S₁=S₂.) Namely, with using ρ₂ expressed from another Rankine-Hugoniot-type relation,

ρ₁c₁=ρ₂c₂ (A8)

(that follows from continuity of the mass flow, taking place by assumption 1.11, and an additional assumption that S₁=S₂), equation (A7) will be written as

p₂−p₁=ρ₁c₁(c₁−c₂)=ρ₁c₁(u₂−u₁)

(since always c₁−c₂=u₂−u₁), which will coincide with equation (14) for p₁=p(t,0), p₂=p_{V}(t), ρ₁=ρ(t,0), c₁=c(t,0), u₁=u(t,0) and u₂=\dot{x}(t,0).
The second method uses quite elementary arguments as follows. The total axial momentum per a unit orthogonal area transferred from a ventricle to an artery for infinitesimal time dt equals [p_{V}(t)−p(t,0)]·dt, and the same momentum can be calculated multiplying an elementary momentum increment, ρ(t,0)·[\dot{x}(t,0)−u(t,0)], by the length of an infinitesimal cylinder having the above area as the base and consisting of “involved” particles, which acquired the increment, i.e. by c(t,0)·dt. Finally, dividing the obtained equality by dt leads to equation (14).
A7. The deduction of equation (17). Having started from a natural assumption of equality of the volume flow velocity between connected vessels 1 and 2 to the arithmetic mean of the similar velocities for these vessels we will have,

$$\begin{matrix}\frac{{p}_{1} - {p}_{2}}{Res} = \dot{Q} \\ = \frac{{\dot{Q}}_{1} + {\dot{Q}}_{2}}{2} \\ = \frac{1}{2} ( \frac{{p}_{1} - {P}_{2}}{{Res}_{1}} + \frac{{p}_{1} - {p}_{2}}{{Res}_{2}} ) \\ = \frac{{p}_{1} - {p}_{2}}{2} \cdot ( \frac{1}{{Res}_{1}} + \frac{1}{{Res}_{2}} ) ,\end{matrix}$$

which determines the wanted resistance Res as the harmonic mean of Res₁ and Res₂.
A8. The deduction of formula (23). For simplicity we will assume the blood in the chamber to be immovable at the considered moment of time. Let us consider the valve region as a round hole S in the spherical atrial chamber. Let the diameter of the valve will be seen at an angle 2θ from the center of the chamber. Averaging the incompressibility equation over S (as in sect. A5) with using polar coordinates brings,

$$\begin{matrix}\frac{\partial \overline{u}}{\partial x} = \frac{1}{π {R}_{valve}^{2}} \int {\int }_{S} \frac{\partial \overline{u}}{\partial x} r d r d ϕ \\ = \frac{2}{{R}_{valve}^{2}} {\int }_{0}^{{R}_{valve}} \frac{\partial \overline{u}}{\partial x} r d r \\ = - \frac{2}{{R}_{valve}^{2}} ( rw ) {\vert}_{0}^{{R}_{valve}} \\ = - \frac{2}{{R}_{valve}} w {\vert}_{r = {R}_{valve}} \\ = - \frac{2}{{R}_{valve}} {\dot{δ}}_{1} sin θ \\ = - \frac{2 {\dot{δ}}_{1}}{{R}_{1}} .\end{matrix} \qquad ( A9 )$$

(In particular,

$$\frac{\partial \overline{u}}{\partial x}$$

does not depend on the value of Rᵥₐₗᵥₑ.) Now, while being interested in the wave only in the considered chamber, say RA, we may assume that at the considered moment of time flows in the other chambers have no impact on it, so we have to differentiate the pericardial pressure with respect to the deformation increment of RA only. So, partial differentiation of equation (3) for RA with respect to t with taking into account (A9) brings an equation

$$\frac{\partial p}{\partial t} = - K \frac{\partial u}{\partial x} , \\ where K = \frac{{R}_{A , 1} \cdot \{ \frac{\partial {p}_{P}}{\partial {δ}_{A , 1}} + {a}_{21 , A} \cdot [ {E}_{A} + {δ}_{A , 1} ( \frac{\partial {E}_{p , A}}{\partial {δ}_{A , 1}} + \frac{\partial {E}_{p , A}}{\partial {δ}_{A , 2}} \cdot \frac{d {δ}_{A , 2}}{d {δ}_{A , 1}} ) ] \}}{2 ( {a}_{22 , A} {R}_{A , 1} - {a}_{22 , A} {δ}_{A , 1} \cdot \frac{\partial {E}_{p , A}}{\partial {p}_{A}} )} .$$

The further partial differentiation of this equation with respect to x with taking into account the linearized axial Euler equation brings,

$$\frac{{\partial }^{2} p}{\partial {t}^{2}} = \frac{K}{{ρ}_{A}} \frac{{\partial }^{2} u}{\partial {x}^{2}} ,$$

and thus, c_{A}²=K/ρ_{A}.
Remark. A more accurate consideration, with usage of characteristics of the governing system of partial differential equations including the original (nonlinear) Euler equation, enables one to obtain a more general formula for the pressure wave propagation velocity in the fluid itself moving with the velocity U_{A}: the answer is,

$${c}_{A} = \frac{{U}_{A} + \sqrt{{U}_{A}^{2} + 4 K / {ρ}_{A}}}{2} . \qquad ( A10 )$$

However, as we have found from our preliminary studies, using this formula enables one to increase the final computational accuracy at most by 5%.
A9. The deduction of equation (24). Under assumption about a uniform pressure change, one can see on the right-hand side of (24) the pressure gradient between the atrial and ventricular centers, divided by the fluid density. Therefore, we have to show that what is standing on the left-hand side in fact is the acceleration \dot{U}_{A}. Let us start from the fact that the flow via the valve equals to the internal ventricular volume increment (by conservation of mass):

$$\begin{matrix}π {R}_{valve}^{2} {U}_{A} = \frac{d}{d t} {V}_{V , 1} \\ = \frac{d}{d t} [ \frac{4 π}{3} {( {R}_{V , 1} + {δ}_{v , 1} )}^{3} ] \\ = 4 {π ( {R}_{V , 1} + {δ}_{v , 1} )}^{2} {\dot{δ}}_{v , 1} .\end{matrix} \qquad ( A11 )$$

A straightforward differentiation of U_{A} as expressed from (A11) brings the expression as on the left-hand side of (24); QED.
A10. The deduction of equation (27) from sect. 4.9. We have,

$$\begin{matrix} {\ddot{δ}}_{V , 1} ( i ) \approx \frac{{δ}_{V , 1} ( i ) - 2 {δ}_{V , 1} ( i - 1 ) + {δ}_{V , 1} ( i - 2 )}{d {t}^{2}} \\ and , & ( A12 ) \\ {\dot{δ}}_{V , 1}^{2} \approx {[ \frac{{δ}_{V , 1} ( i ) - {δ}_{V , 1} ( i - 1 )}{d t} ]}^{2} \approx \frac{[ {δ}_{V , 1} ( i ) - {δ}_{V , 1} ( i - 1 ) ] [ {δ}_{V , 1} ( i - 1 ) - {δ}_{V , 1} ( i - 2 ) ]}{d {t}^{2}} , & ( A13 )\end{matrix}$$

as the last of these approximate equalities holds with an infinitesimal error as

$$\begin{matrix}ɛ = \frac{{δ}_{V , 1} ( i ) - {δ}_{V , 1} ( i - 1 )}{d {t}^{2}} \{ \begin{matrix}[ {δ}_{V , 1} ( i ) - {δ}_{V , 1} ( i - 1 ) ] - \\ [ {δ}_{V , 1} ( i - 1 ) - {δ}_{V , 1} ( i - 2 ) ]\end{matrix} \} \\ = d t \cdot \frac{{δ}_{V , 1} ( i ) - {δ}_{V , 1} ( i - 1 )}{d t} \cdot \frac{{δ}_{V , 1} ( i ) - 2 {δ}_{V , 1} ( i - 1 ) + {δ}_{V , 1} ( i - 2 )}{d {t}^{2}} \approx \\ d t \cdot {\dot{δ}}_{V , 1} \cdot {\ddot{δ}}_{V , 2} .\end{matrix}$$

Putting (A12) and (A13) to equations (24), with coefficients computed for tᵢ₋₁, brings (27).
A11. About the Newton's method. This is destined for solving equations ƒ(x)=0 (dim x=dim ƒ) with continuously differentiable ƒ such that the Jacobi matrix ƒ′(x₀) is non-degenerate for the solution x₀. Having found an approximation xₙ for x₀, one defines the next approximation xₙ₊₁ as xₙ₊₁=xₙ−[ƒ′(xₙ)]⁻¹ƒ(xₙ). (If dim x=1, geometrically xₙ₊₁ is abscissa of the intersection of the axis x with the tangent to the graph of the function ƒ at the point (xₙ, ƒ(xₙ)).) If ƒ is sufficiently smooth (so that having a bounded second differential in a neighborhood of xₙ₊₁), the super-convergence of the method (the approximation residual is of order ε²^{ⁿ} where ε is an initial residual) can be proved as follows: using the Taylor-expansion formula and Intermediate value theorem from Differential calculus we will have,

$$\begin{matrix}\vert f ( {x}_{n + 1} ) \vert = \vert f ( {x}_{n + 1} ) - [ f ( {x}_{n} ) + {f}^{′} ( {x}_{n} ) ( {x}_{n + 1} - {x}_{n} ) ] \vert \leq \\ \frac{1}{2} sup \vert {f}^{″} \vert \cdot {\vert {x}_{n + 1} - {x}_{n} \vert}^{2} \\ = \frac{1}{2} sup \vert {f}^{″} \vert \cdot {\vert {[ {f}^{′} ( {x}_{n} ) ]}^{- 1} \vert}^{2} {\vert f ( {x}_{n} ) \vert}^{2} < \\ C {\vert f ( {x}_{n} ) \vert}^{2} ,\end{matrix}$$

### REFERENCES

Berezin, I. S., & Zhidkov, N. P. (1965). Computing methods. Franklin Book Comp. Inc.
Caro, C. G., Pedley, T. J., Schroter, R. C., & Seed, W. A. (1978). The mechanics of circulation. Oxford, N.Y., Toronto: Oxford Univ. Press.
Dinnar, U. (1981). Cardiovascular Fluid Dynamics. Boca Raton, Fla.: CRC Press.
Fermi, E. (1937). Thermodynamics. NY: Prentice Hall, Inc.
Fung, Y. C. (1997). Biomechanics: Circulation. NY: Springer, 2^{nd} ed.
Herman, G. T., Tuy, H. K., Langenberg, K. J., & Sabatier, P. C. ((1987). Basic methods of tomography and inverse problems. Adam Gilger, Bristol, Philadelphia.
Kaczmarz, S. ((1937). Angenaehrte Aufloesung von Systemen linearer Gleichungen. Bull. Int. Acad. Pol. Sci. Lett. A, 355-357.
Kantorovich, L. V., & Akilov, G. P. (1982). Functional analysis. Pergamon Press, Oxford, XIV.
Kapel'ko, V. I. ((1996). Hydrodynamic basis of circulation. Soros Educational J., 2, 44-50.
Landau, L. D., & Lifshitz, E. M. (1979). Statistical physics. Oxford, N.Y.: Pergamon Press, 3^{rd} ed.
Landau, L. D., & Lifshitz, E. M. (1986). Theory of elasticity. Oxford, N.Y.: Pergamon Press, 3^{rd} ed.
Landau, L. D., & Lifshitz, E. M. (1987). Fluid mechanics. Oxford, N.Y.: Pergamon Press, 2^{nd} ed.
Levich, V. G. ((1962). Physicochemical hydrodynamics. Prentice Hall.
Press, W. H., Teukolsky, S. A., Vetterling, W. T., & Flannery, B. P. (1992). Numerical recipes in Fortran 77. The art of scientific computing. Cambridge Univ. Press, 2^{nd} ed., Cambridge, N.Y., Melbourne.
Timoshenko, S. P., & Goodier, J. N. ((1970). Theory of elasticity. NY: McGraw-Hill, 3^{rd} ed.

While the invention has been described with respect to a limited number of embodiments, it will be appreciated that many variations, modifications and other applications of the invention may be made.

What is claimed is:

1. A method for modeling physiological events of the heart, comprising constructing a comprehensive model of the entire heart based on at least one physiological parameter related to physiological functioning of one or more of the cardiac chambers and large vessels, with the proviso that said at least one parameter is not solely ejection fraction; and optionally outputting said comprehensive model to a user by displaying said comprehensive model to the user, for example through a user computer display.

2. The method of claim 1, wherein said constructing said comprehensive model is performed for a subject, the method further comprising measuring said at least one physiological parameter in said subject; and analyzing said measurement of said at least one physiological parameter in said comprehensive model of the heart.

3. The method of claim 2, wherein said measuring said at least one physiological parameter comprises obtaining a measurement from an implanted sensor.

4. The method of claim 3, wherein said implanted sensor comprises one or more of a pacemaker, monitoring system and/or standalone sensor.

5. The method of claim 3, wherein said measuring said at least one physiological parameter comprises obtaining a measurement from one or more of an imaging device, blood work, ultrasound, echo, CT, MRI, PET scan or the like.

6. The method of claim 2, wherein said constructing said comprehensive model further comprises combining hemodynamic, physiological and anatomical aspects of the heart.

7. The method of claim 2, wherein said constructing said comprehensive model further comprises solving a plurality of wave equations for filling the ventricles of the heart.

8. The method of claim 5, wherein said at least one physiological parameter comprises a combination of pressure, volume, wall thickness, elasticity of walls, and systemic resistance or pulmonary resistance.

9. The method of claim 8, wherein said wall thickness and elasticity of walls is determined for a plurality of chambers of the heart.

10. The method of claim 9, wherein said wall thickness and elasticity of walls is determined for large blood vessels.

11. The method of claim 8, wherein said pressure comprises one or more of the left ventricle blood pressure; the right ventricle blood pressure; the left atrium blood pressure; the right atrium blood pressure; the pulmonary vein blood pressure; the aortic blood pressure; the vena cava blood pressure; the pulmonary artery blood pressure; the blood pressure in systemic arteries; the blood pressure in systemic capillaries; the blood pressure in systemic veins; the blood pressure in pulmonary arteries; the blood pressure in pulmonary capillaries; the blood pressure in pulmonary veins.

12. The method of claim 8, wherein said at least one physiological parameter further comprises blood flow velocity in at least one chamber of the heart or at least one large vessel, or a combination thereof.

13. The method of claim 12, wherein said blood flow velocity parameter further comprises one or more of the axial blood flow velocity in vena cava; the axial blood flow velocity just after the exit from vena cava; the axial blood flow velocity in aorta; the axial blood flow velocity just before the entrance to aorta; the aortic pressure wave propagation velocity relative to the flow; the axial blood flow velocity in pulmonary artery; the axial blood flow velocity just before the entrance to pulmonary artery; the pulmonary artery pressure wave propagation velocity relative to the flow; the volume blood flow velocity in pulmonary vein; the axial blood flow velocity just after the exit from pulmonary vein; the volume blood flow velocity in vena cava; the axial blood flow velocity just after the exit from vena cava; the volume blood flow velocity in a systemic arteries; the volume blood flow velocity in a systemic capillaries; the volume blood flow velocity in a systemic veins; the volume blood flow velocity in a pulmonary arteries; the volume blood flow velocity in a pulmonary capillaries; the volume blood flow velocity in a pulmonary veins;

14. The method of claim 13, wherein said comprehensive model comprises at least one of the following sets of equations: the hydrodynamic equation of continuity (the conservation of mass) and conservation of the axial component of momentum) for the set {blood flow in artery & arterial walls}; equations for hydrodynamic equation of continuity (the conservation of mass), conservation of the axial component of momentum for the set {blood flow in vein & venous walls}; or a combination thereof.

15. The method of claim 8, wherein said at least one physiological parameter further comprises an anatomical characteristic of the heart and/or of a large vessel of the subject.

16. The method of claim 15, wherein said anatomical characteristic comprises one or more of arterial shape; the internal radius of the nondeformed (empty) left ventricle; the external radius of the nondeformed (empty) left ventricle; the internal radius of the nondeformed (empty) right ventricle; the external radius of the nondeformed (empty) right ventricle; the internal radius of the nondeformed (empty) left atrium; the external radius of the nondeformed (empty) left atrium; the internal radius of the nondeformed (empty) right atrium; the external radius of the nondeformed (empty) right atrium; the (internal) radius of the nondeformed (empty) aorta; the thickness of the nondeformed (empty) aorta; the (internal) radius of the nondeformed (empty) lung blood vessel; the thickness of the nondeformed (empty) lung blood vessel; the (internal) radius of the nondeformed (empty) vena cava; the thickness of the nondeformed (empty) vena cava; the (internal) radius of the nondeformed (empty) pulmonary artery; the thickness of the nondeformed (empty) pulmonary artery; the (internal) radius of the nondeformed (empty) pulmonary vein; the thickness of the nondeformed (empty) pulmonary vein; the average radius of the nondeformed (empty) pulmonary arteries; the average thickness of the nondeformed (empty) pulmonary arteries; the average length of pulmonary arteries; the average radius of the nondeformed (empty) pulmonary capillaries; the average thickness of the nondeformed (empty) pulmonary capillaries; the average length of pulmonary capillaries; the average radius of the nondeformed (empty) pulmonary veins; the average thickness of the nondeformed (empty) pulmonary veins; the average length of pulmonary veins; the average radius of the nondeformed (empty) systemic arteries; the average thickness of the nondeformed (empty) systemic arteries; the average length of systemic arteries; the average radius of the nondeformed (empty) systemic capillaries; the average thickness of the nondeformed (empty) systemic capillaries; the average length of systemic capillaries; the average radius of the nondeformed (empty) systemic veins; the average thickness of the nondeformed (empty) systemic veins; the average length of systemic veins; the external radius of the nondeformed (empty) pericardium.

17. The method of claim 8, wherein said at least one physiological parameter further comprises a characteristic of blood of the subject.

18. The method of claim 16, wherein said characteristic of said blood of the subject comprises the density of blood fluid in aorta; the density of blood fluid in vena cava; the density of blood fluid in pulmonary artery; the density of blood fluid in pulmonary vein; the density of blood fluid in a lung vessel; the Poisson isentropic exponent of the blood fluid; the density of blood in pulmonary arteries; the density of blood in pulmonary capillaries; the density of blood in pulmonary veins; the viscosity-related resistance coefficient of the blood flow in pulmonary arteries; the viscosity-related resistance coefficient of the blood flow in pulmonary capillaries; the viscosity-related resistance coefficient of the blood flow in pulmonary veins; the density of blood in systemic arteries; the viscosity-related resistance coefficient of the blood flow in systemic arteries; the density of blood in systemic capillaries; the viscosity-related resistance coefficient of the blood flow in systemic capillaries; the density of blood in systemic veins; the viscosity-related resistance coefficient of the blood flow in systemic veins.

19. The method of claim 8, wherein said elasticity of walls comprises one or more of the effective Young modulus of the left ventricle wall; the deformation-related increments of internal left ventricle radius; the deformation-related increments of external left ventricle radius; the stress of the external left ventricle wall; the effective Young modulus of the right ventricle wall; the deformation-related increments of internal right ventricle radius; the deformation-related increments of external 1 right ventricle radius; the stress of the external right ventricle wall; the effective Young modulus of the left atrium wall; the deformation-related increments of internal left atrium radius; the deformation-related increments of external left atrium radius; the stress of the external left atrium wall; the effective Young modulus of the right atrium wall; the deformation-related increments of internal right atrium radius; the deformation-related increments of external right atrium radius; the stress of the external right atrium wall; the effective Young modulus of the aortic wall; the deformation-related increments of the aortic radius; the deformation-related increments of the vena cava radius; the effective Young modulus of the pulmonary artery wall; the deformation-related increments of the pulmonary artery radius; the deformation-related increments of the pulmonary vein radius; the effective Young modulus of the vena cava wall; the effective Young modulus of the pulmonary vein wall; the average effective Young modulus of systemic arteries walls; the average effective Young modulus of systemic capillaries walls; the average effective Young modulus of systemic veins walls; the average effective Young modulus of pulmonary arteries walls; the average effective Young modulus of pulmonary capillaries walls; the average effective Young modulus of pulmonary veins walls; the absolute deformation-related increment of the pulmonary arteries radius; the absolute deformation-related increment of the pulmonary capillaries radius; the absolute deformation-related increment of the pulmonary veins radius; the average effective Young modulus of system arteries walls; the average effective Young modulus of capillaries walls; the average effective Young modulus of veins walls; the absolute deformation-related increment of the systemic arteries radius; the absolute deformation-related increment of the systemic capillaries radius; the absolute deformation-related increment of the systemic veins radius; the Young modulus of the pericardial wall material.

20. The method of claim 19, wherein said comprehensive model of the heart comprises one or more of the following equations: the elasticity equation for the set {blood flow in artery & arterial walls} only; the elasticity equation for the set {blood flow in vein & venous walls} only; the elasticity equations for the set {blood flow in ventricle & ventricle walls} only; the elasticity equations for the set {blood flow in atrium & atrial walls} only.

21. The method of claim 8, wherein said systemic resistance or pulmonary resistance is pulmonary resistance.

22. The method of claim 8, wherein said systemic resistance or pulmonary resistance comprises one or more of the pulmonary arterial resistance; the pulmonary capillary resistance; the pulmonary venous resistance; the systemic arterial resistance; the systemic capillary resistance; the systemic venous resistance.

23. The method of claim 8, wherein said at least one physiological parameter comprises one or more regulation coefficients related to: left-ventricular EDV; right-ventricular EDV; left-atrial presystolic volume; right-atrial presystolic volume; blood pressure in Aorta; blood pressure in Pulmonary artery; blood pressure in pulmonary circulation cycle; blood pressure in systemic circulation cycle; or a combination thereof.

24. The method of claim 8, wherein said comprehensive model of the heart comprises at least one equation set of the following: the equations binding the ventricular and arterial flows and wall elasticity on systole (Conservation of mass, Conservation of myocardial volume, Conservation of momentum, Moens-type equation, Conservation of energy); the equations binding the arterial flow and wall elasticity on diastole (hydrodynamic equation of continuity (the conservation of mass), conservation of the axial component of momentum, Conservation of energy); the equations binding the venous-atrial and ventricular flows and wall elasticity on rapid and reduced ventricular filling and atrial systole (Conservation of mass, Conservation of myocardial volume, Conservation of momentum, Moens-type equation, Conservation of energy); the equations binding the venous-atrial flow and wall elasticity when the (mitral or tricuspid, respectively) valve is closed (hydrodynamic equation of continuity (the conservation of mass), conservation of the axial component of momentum, Conservation of energy, Moens-type equation); the equations binding the blood flows in pulmonary artery, lung blood vessel and pulmonary vein and wall elasticity; Hagen-Poiseuille equation; Newton non-linear calculation method; or a combination thereof.

25. The method of claim 8, wherein said comprehensive model of the heart comprises at least the empirical equations binding relation between the physiological parameters and describing the regulatory and compensatory mechanisms of heart functionality.

26. The method of claim 8, further comprising predicting heart failure according to said analyzing said measurement of said at least one physiological parameter in said comprehensive model of the heart.

27. The method of claim 26, further comprising providing feedback to the patient or to medical personnel.

28. The method of claim 27, wherein said feedback comprises issuing an alarm, optionally an audible or visible alarm.

29. The method of claim 27, wherein said feedback comprises determining a suitable treatment for the subject according to said predicting said heart failure.

30. The method of claim 27, wherein providing feedback to the patient comprises providing a suitable treatment to the patient.

31. The method of claim 29 or 30, wherein said suitable treatment comprises one or more of pharmaceutical treatment, treatment with a medical device, or surgery, or a combination thereof.

32. The method of claim 31, wherein said treatment with said medical device comprises implanting a stent, a valve replacement or a pacemaker, or a combination thereof.

33. The method of claim 8, further comprising monitoring the subject by measuring at least one physiological parameter in the subject for a period of time.

34. The method of claim 33, wherein said at least one physiological parameter comprises pressure in right or left atrium, or left/right ventricle, and/or pulmonary artery, or a combination thereof.

35. The method of claim 34, wherein said period of time comprises at least one hour.

36. The method of claim 35, wherein said period of time comprises at least one week.

37. The method of claim 36, wherein said period of time comprises at least two weeks.

38. The method of claim 37, wherein said period of time comprises at least three weeks or at least one month.

39. The method of claim 38, wherein said period of time comprises at least any week selected from the group consisting of 4 weeks, 5 weeks, 6 weeks, 7 weeks, 8 weeks, 9 weeks, 10 weeks, 11 weeks, 12 weeks, 13 weeks, 14 weeks, or 15 weeks or more.

40. The method of claim 35, further comprising providing feedback to the patient or to medical personnel.

41. The method of claim 40, wherein said feedback comprises issuing an alarm, optionally an audible or visible alarm.

42. The method of claim 41, wherein said feedback comprises determining a suitable treatment for the subject according to said monitoring.

43. The method of claim 42, wherein said providing feedback to the patient comprises providing a suitable treatment to the patient.

44. The method of claim 42 or 43, wherein said suitable treatment comprises one or more of pharmaceutical treatment, treatment with a medical device, or surgery, or a combination thereof.

45. The method of claim 44, wherein said treatment with said medical device comprises implanting a stent, a valve replacement or a pacemaker, or a combination thereof.

46. The method of claim 8, further comprising determining a personalized regimen for the subject.

47. The method of claim 46, wherein said personalized regimen comprises one or more of a personalized pharmaceutical treatment, personalized treatment with medical device, personalized surgery and follow-up care, personalized exercise regimen and personalized diet regimen.

48. The method of claim 8, further comprising enrolling a plurality of subjects in a clinical trial; and monitoring said subjects with said comprehensive heart model.

49. A system for performing the method according to any of claims 1-48.

50. A system for modeling physiological events of the heart, comprising a comprehensive model of the entire heart based on at least one physiological parameter related to physiological functioning of one or more of the cardiac chambers and large vessels, with the proviso that said at least one parameter is not solely ejection fraction, related to a subject; an imaging device for measuring at least one physiological parameter in said subject; an analysis module for analyzing said measurement of said at least one physiological parameter in said comprehensive model of the heart; and optionally a computer display for outputting said comprehensive model to a user.

51. The system of claim 50, further comprising an implanted sensor for measuring at least one physiological parameter.

52. The system of claim 51, wherein said implanted sensor comprises one or more of a pacemaker, monitoring system and/or standalone sensor.

53. The system of claim 51, wherein said imaging device comprises one or more of ultrasound, echo, CT, MRI or PET scan.

54. The system of claim 51 further comprising at least one non-implanted sensor.
